(19) United States
(12) Patent Application Publication
(10) Pub. No.: US 2026/0276398 A1
(43) Pub. Date: Sep. 17, 2026

(54) SYSTEMS AND METHODS OF GENERATING A ROUTE

(71) Applicant: Apple Inc., Cupertino, CA (US)

(72) Inventors: Srichand PENDYALA, Los Altos, CA (US); Craig M. HILLER, La Honda, CA (US); Lukas Michael MARTI, San Jose, CA (US)

(21) Appl. No.: 19/546,145

(22) Filed: Feb. 20, 2026

Related U.S. Application Data
(60) Provisional application No. 63/772,343, filed on Mar. 14, 2025.

(51) Int. Cl. G01C 21/36; G06F 3/01; G06F 3/0354; G06F 3/0488; G06T 11/65

(52) U.S. Cl. CPC G01C 21/3614; G01C 21/3626; G06F 3/017; G06F 3/03545; G06F 3/0488; G06T 11/65; G06T 2200/24

(57) ABSTRACT

In some embodiments, an electronic device receives a gesture starting from a first location of a map area to a second location of the map area and in response, the electronic device generates a route from a first respective location to a second respective location. In some embodiments, generating the route is based on one or more attributes of a movement portion of the gesture from the first location to the second location and map data.

### CROSS-REFERENCE TO RELATED APPLICATIONS

This application claims the benefit of U.S. Provisional Application No. 63/772,343, filed Mar. 14, 2025, the content of which is herein incorporated by reference in its entirety for all purposes.

### FIELD

The present disclosure relates generally to computer user interfaces, and more specifically to techniques for generating a route.

### BACKGROUND

User interaction with electronic devices has increased significantly in recent years. These devices can be devices such as computers, tablet computers, televisions, multimedia devices, or mobile devices. Electronic devices present maps of physical areas in some embodiments. The user may wish to view a route from one physical location to another.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

Accordingly, the present technique provides electronic devices with faster, more efficient methods and interfaces for generating a route. Such methods and interfaces optionally complement or replace other methods for generating routes. Such methods and interfaces reduce the cognitive burden on a user and produce a more efficient human-machine interface. For battery-operated computing devices, such methods and interfaces conserve power and increase the time between battery charges.

Some embodiments described in this disclosure are directed to an electronic device configured to generate a route from a first respective location to a second respective location in response to receiving a gesture starting from a first location of a map area to a second location of a map area. By generating the route efficiently via a quick sketch, the electronic device reduces the need for subsequent inputs from a user to precisely select particular roadways and/or waypoints which is particularly important when immediate routing guidance is desired. The full descriptions of the embodiments are provided in the Drawings and the Detailed Description, and it is understood that the Summary provided above does not limit the scope of the disclosure in any way.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for generating routes, thereby increasing the effectiveness, efficiency, and user satisfaction with such devices. Such methods and interfaces may complement or replace other methods for generating routes.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations.

FIG. 4 is a block diagram illustrating a hand tracking unit of a computer system that is configured to capture gesture inputs of the user in accordance with some embodiments.

FIG. 5A is a block diagram illustrating an eye tracking unit of a computer system that is configured to capture gaze inputs of the user in accordance with some embodiments.

FIG. 5B is a flow diagram illustrating a glint-assisted gaze tracking pipeline in accordance with some embodiments.

FIG. 5C is a block diagram illustrating a system with various components in accordance with some embodiments.

FIGS. 6A-6C illustrate exemplary user interfaces for detecting a gesture performed by a user of the electronic device and generating a route that is based on the gesture and map data in accordance with some embodiments.

FIGS. 7A-7M illustrate exemplary user interfaces for generating a route that is based on the gesture and map data in accordance with some embodiments.

FIGS. 8A-8C illustrate schematic block diagrams of circuitry that can be included in the electronic device in accordance with some embodiments.

FIGS. 9-11 are flow diagrams illustrating methods for generating a route that is based on the gesture and map data in accordance with some embodiments.

### DETAILED DESCRIPTION

The present disclosure relates to user interfaces for providing an extended reality (XR) experience to a user, in accordance with some embodiments.

The systems, methods, and GUIs described herein improve user interface interactions with virtual/augmented reality environments in multiple ways.

The following description sets forth exemplary techniques for detecting a gesture performed by a user of the electronic device and generating a route that is based, at least in part, on one or more attributes of a movement portion of the gesture and map data. This description is not intended to limit the scope of this disclosure but is instead provided as a description of example implementations.

Users need electronic devices that provide effective techniques for generating routes. For example, a route can be generated via a quick sketch. Efficient techniques can reduce a user's mental load when generating a route. This reduction in mental load can enhance user productivity and make the device easier to use. In some embodiments, the techniques described herein can reduce battery usage and processing time (e.g., by providing user interfaces that require fewer user inputs to operate).

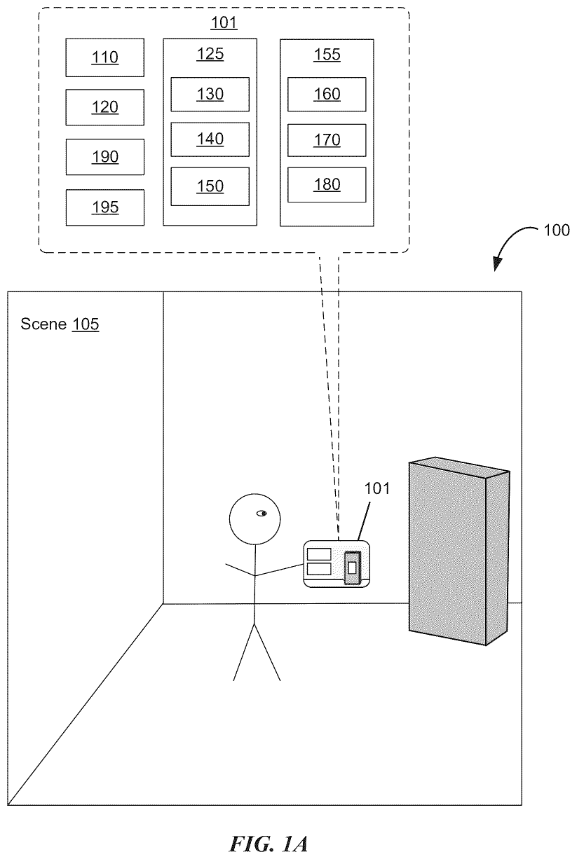

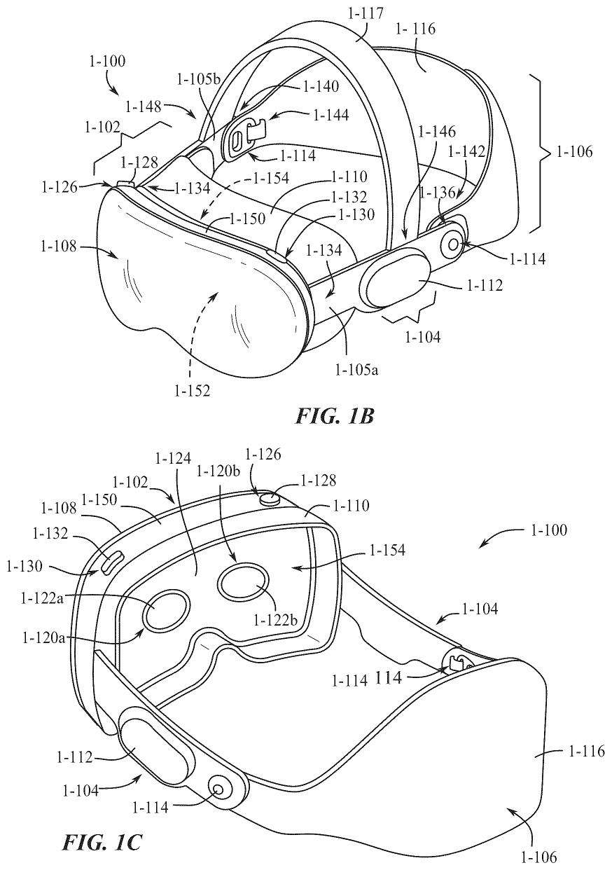

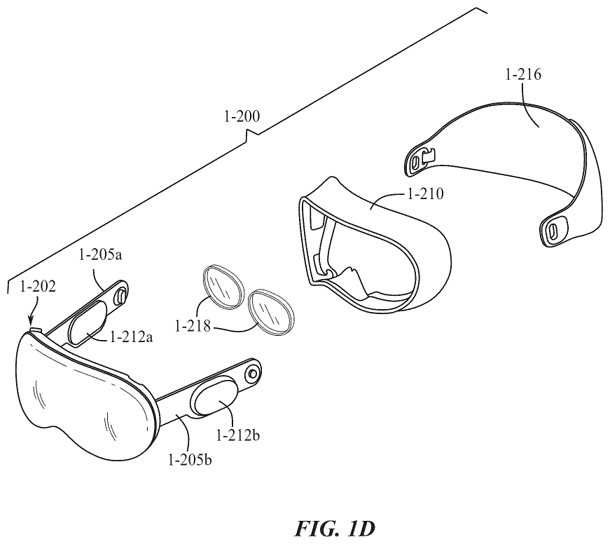

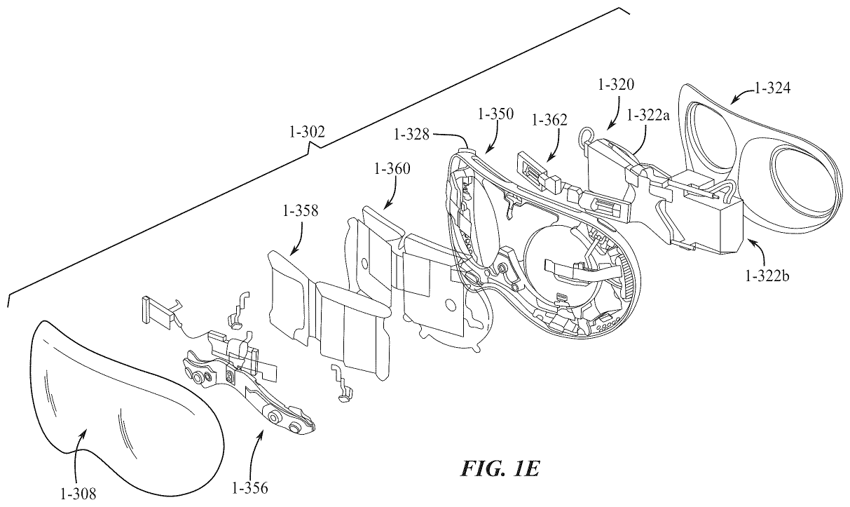

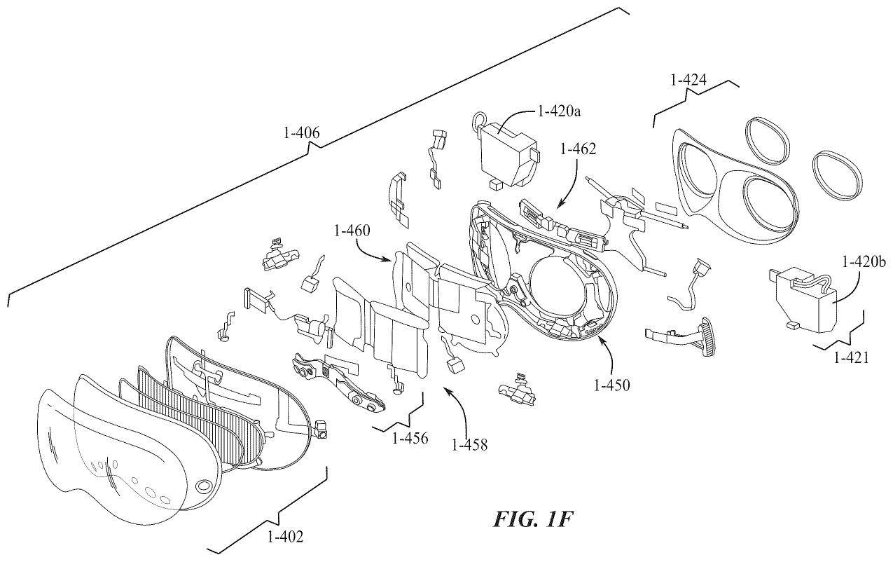

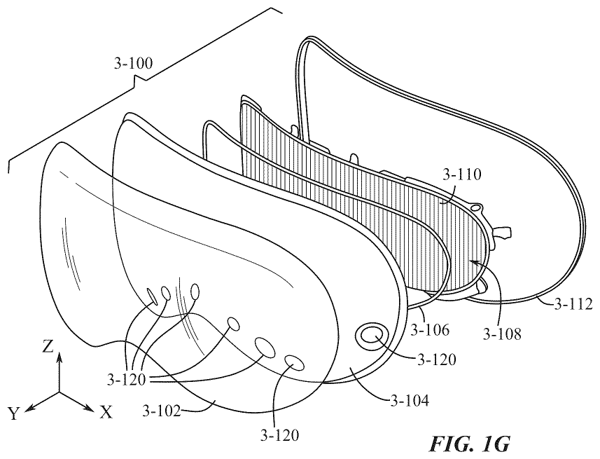

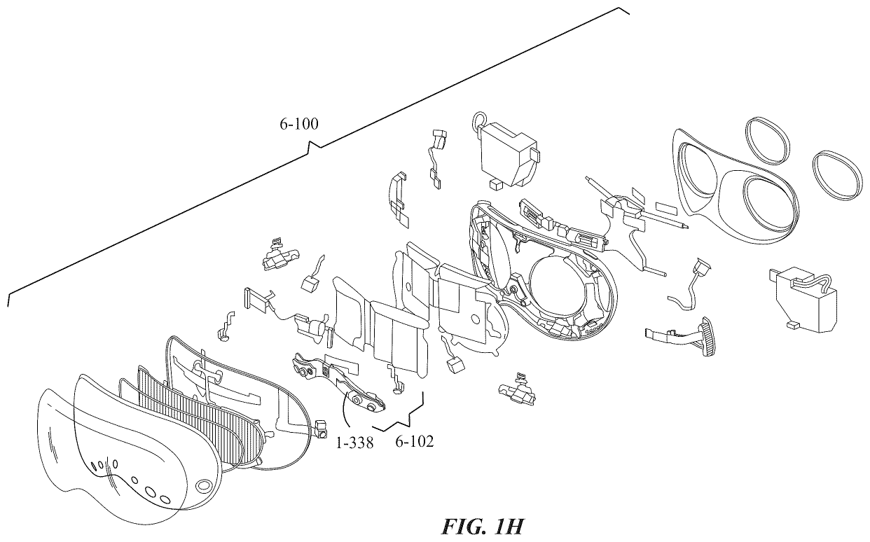

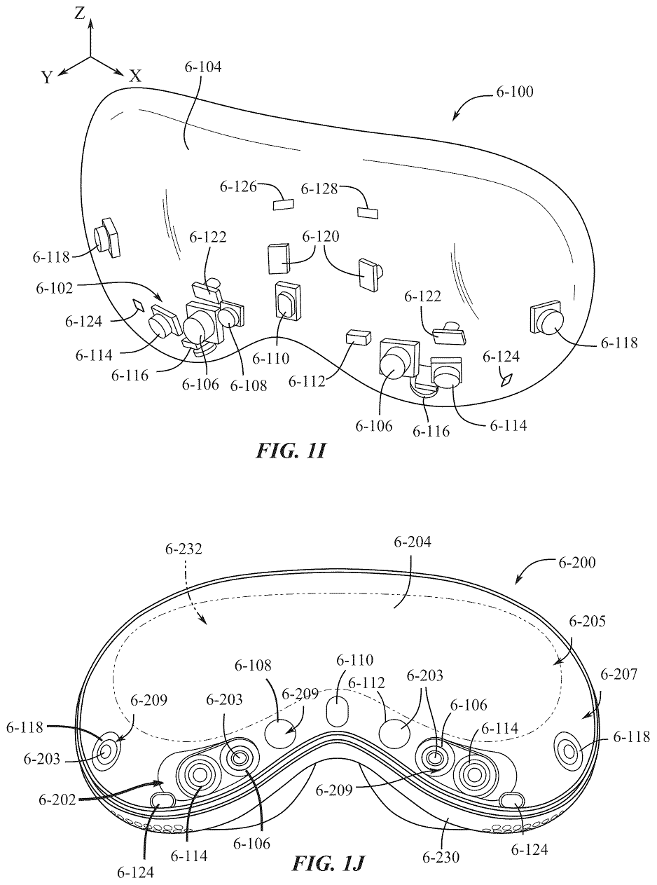

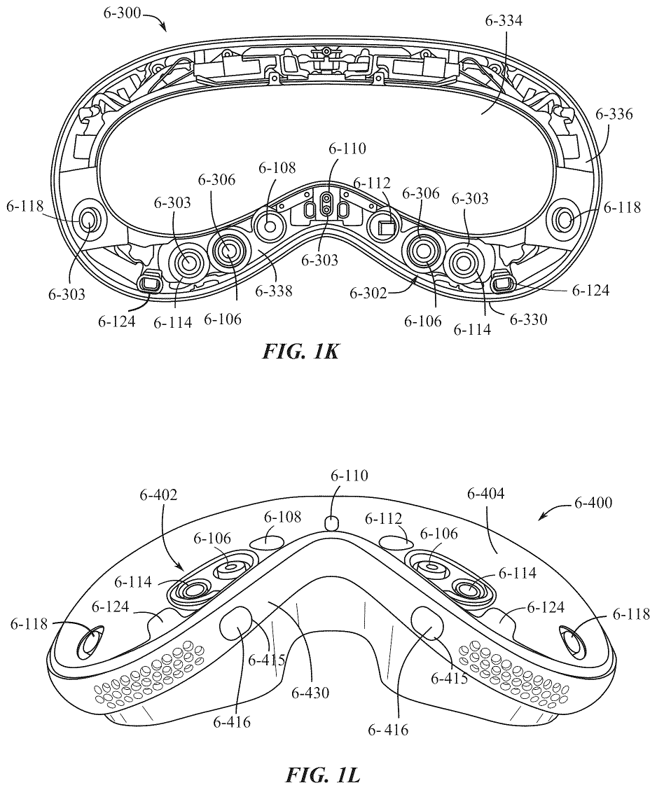

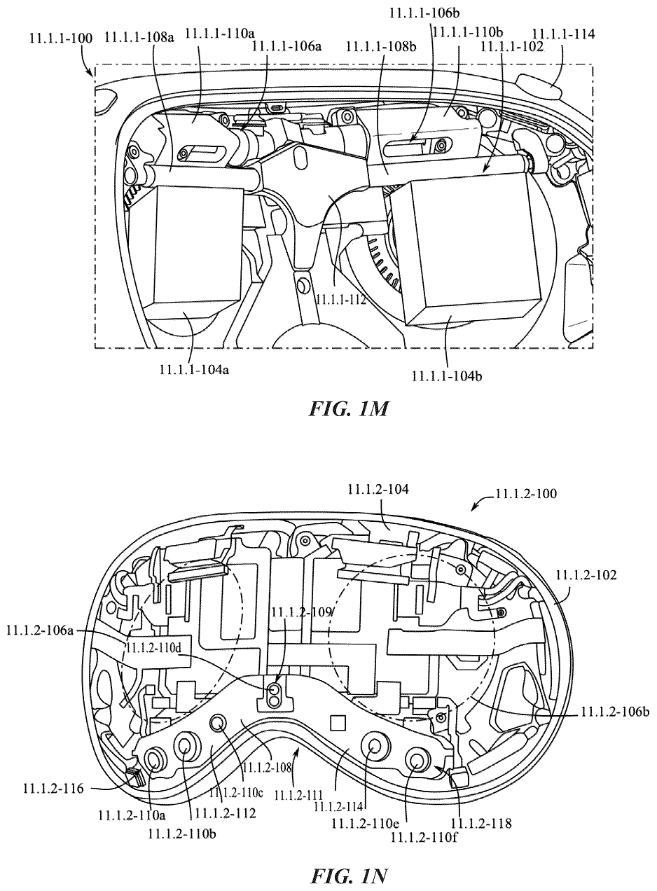

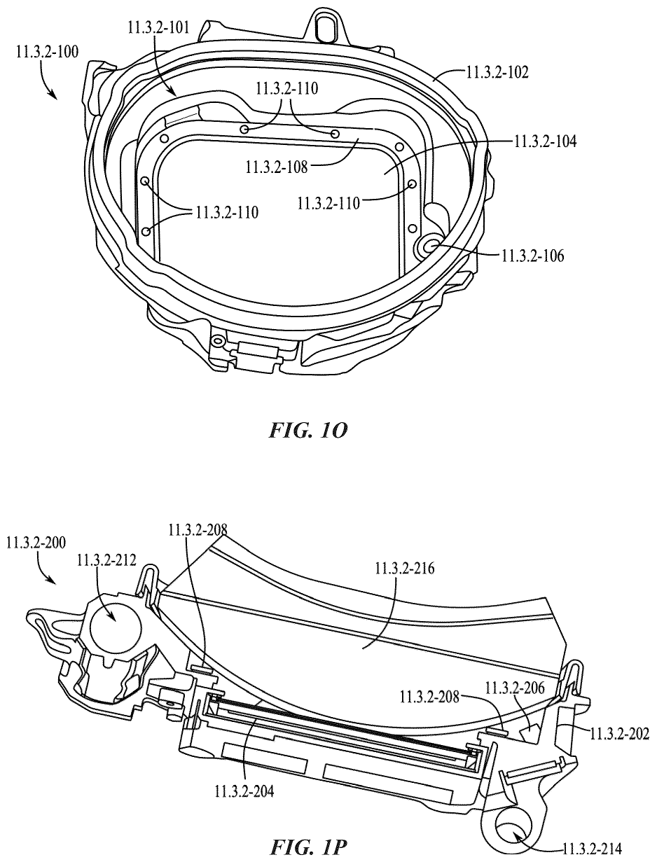

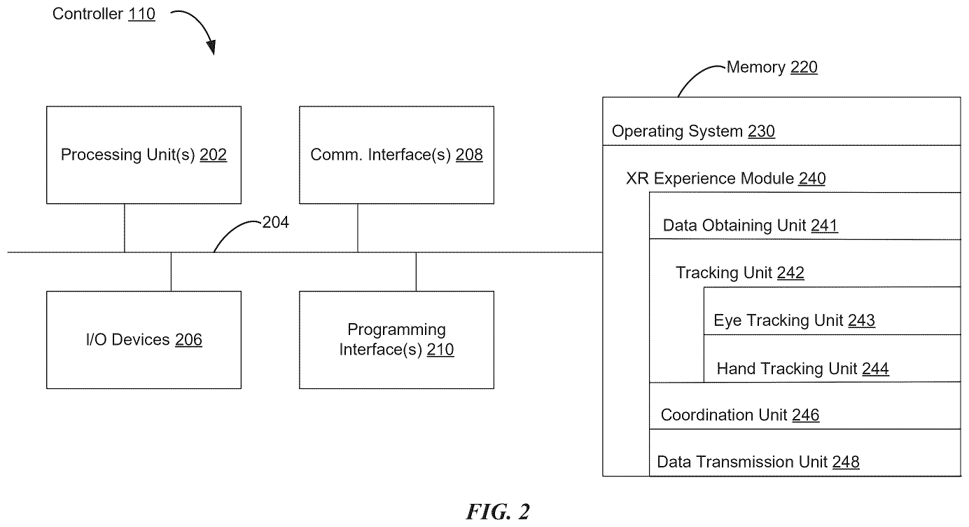

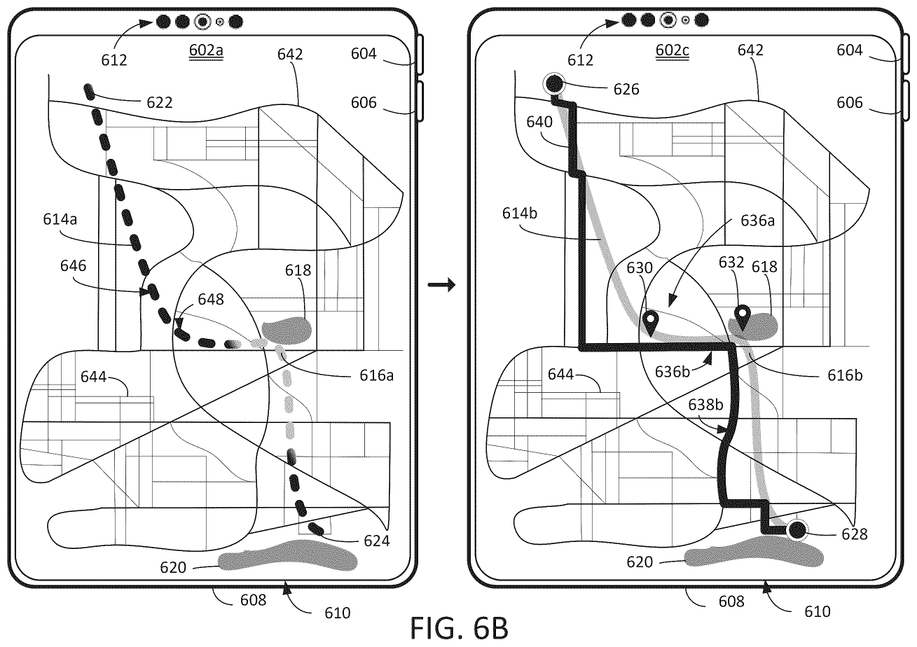

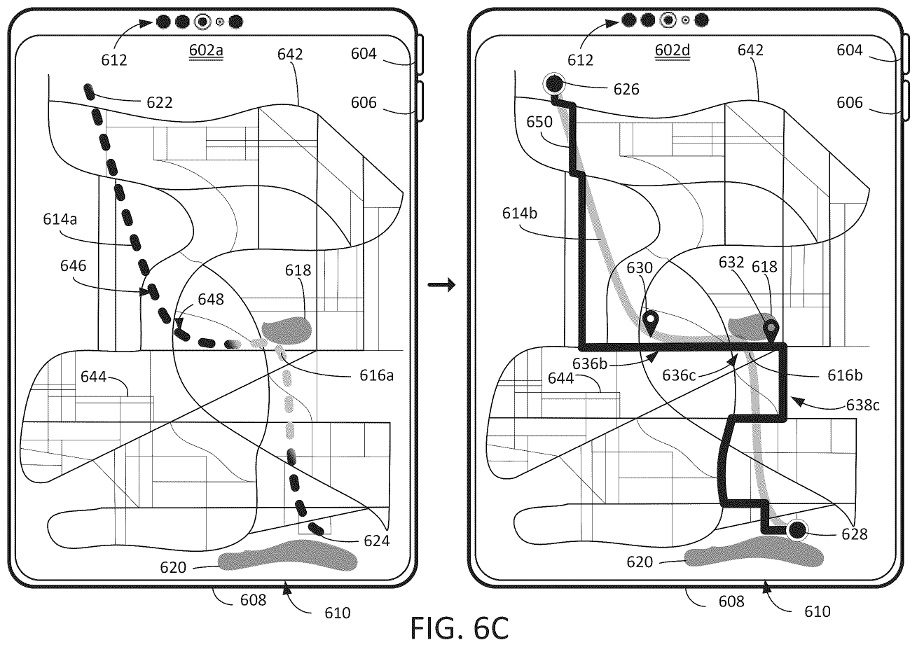

FIGS. 1A-6 provide a description of example computer systems for providing XR experiences to users (such as described below with respect to methods 800 and/or 1000). FIGS. 6A-6P illustrate adjusting the output of light in an interior of a platform and displaying a visual indication of one or more environmental factors of an environment external to the interior of the platform.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers or output devices 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality. Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specfies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typcially move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objets such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environement or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

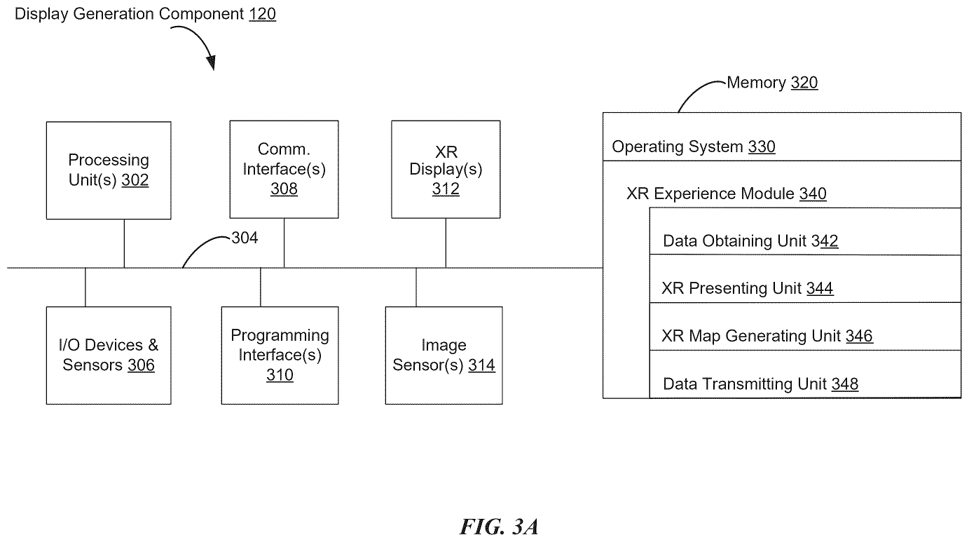

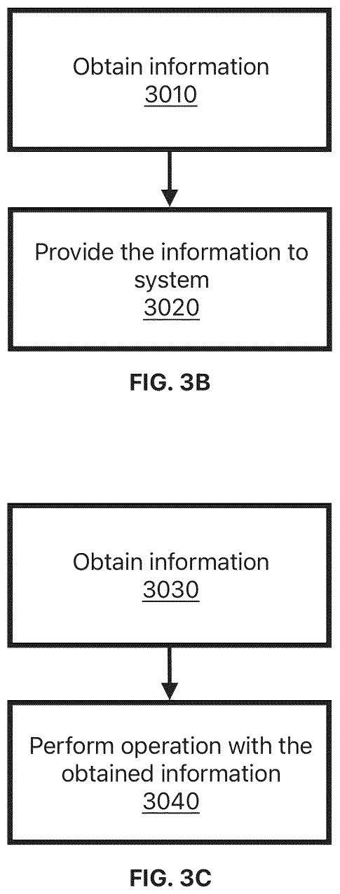

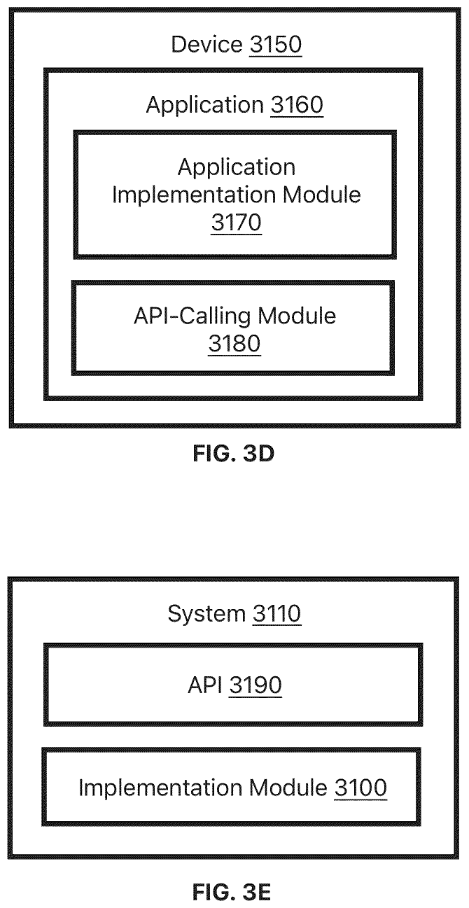

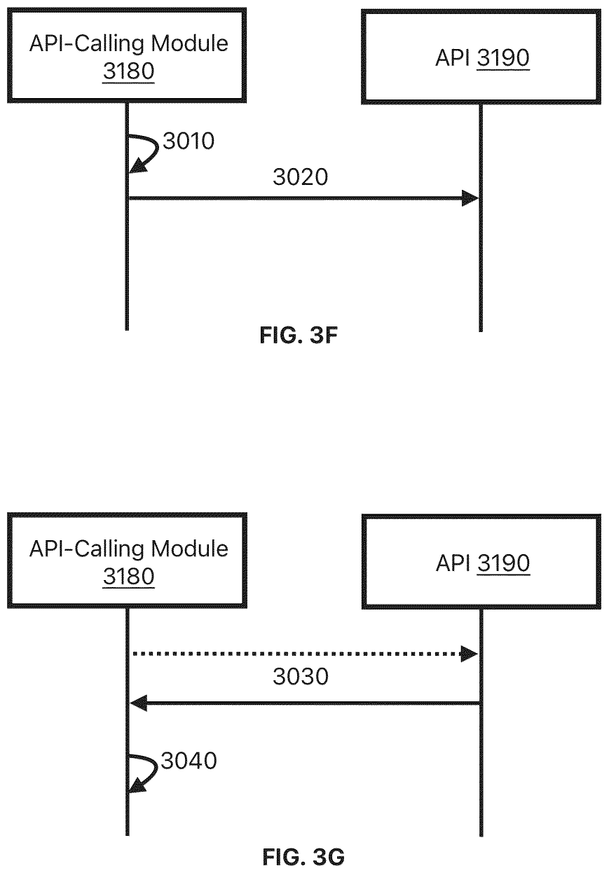

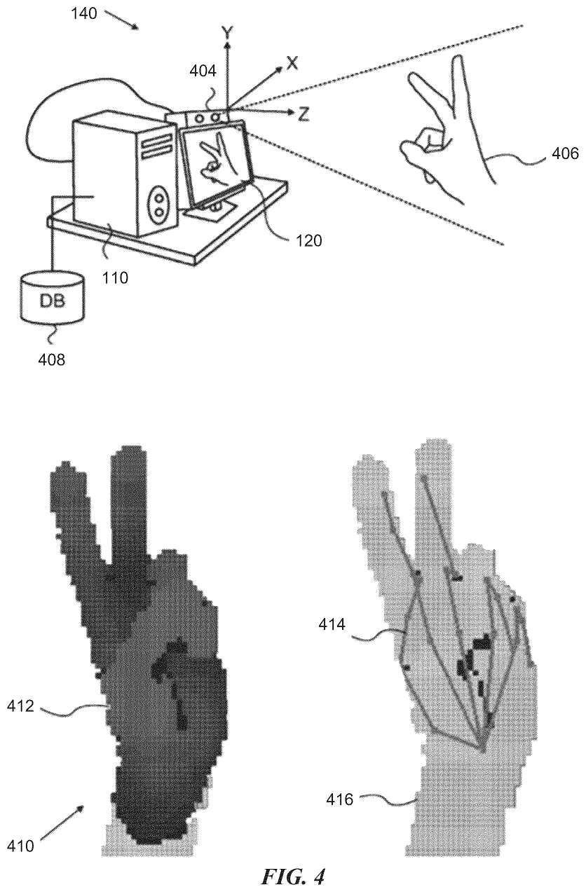

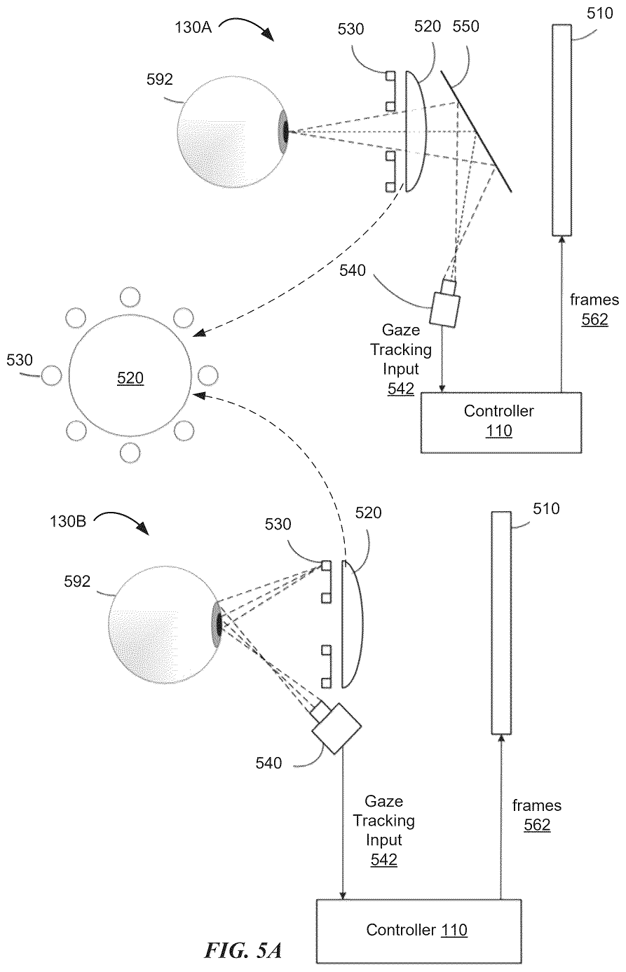

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3A. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

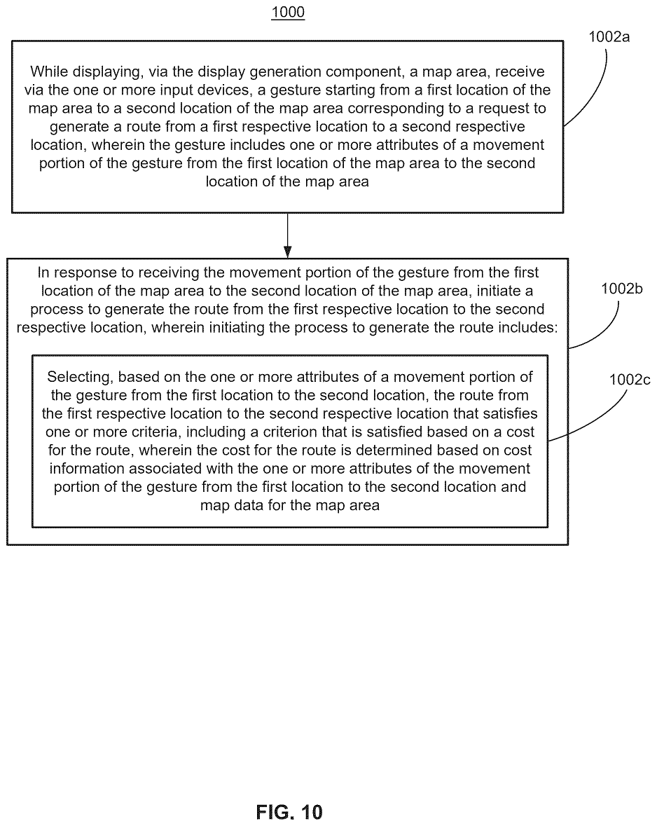

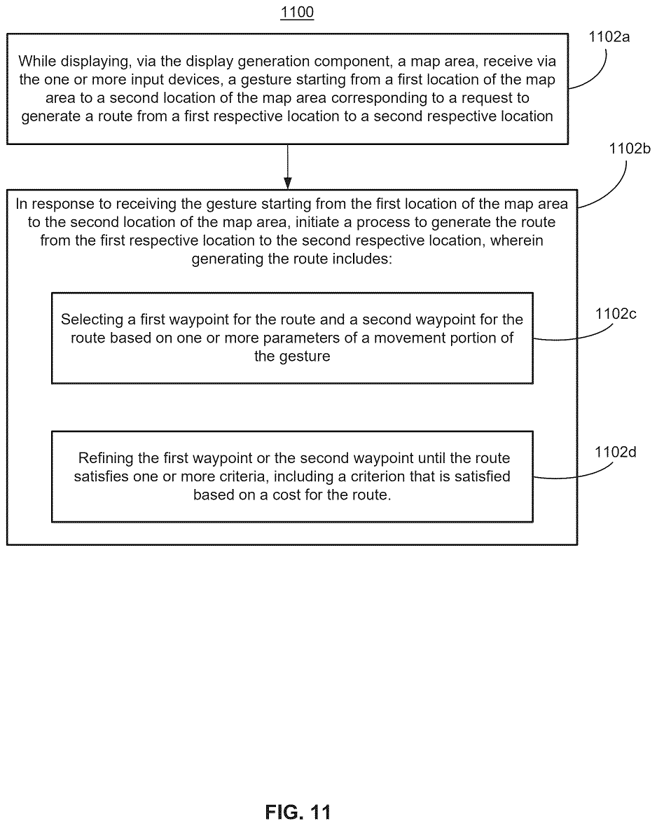

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 11) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 11) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 10) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user′ head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin, for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K 1L and described herein. Likewise, any of the features, components, and/or parts, including the arrangements and configurations thereof shown and described with reference to FIGS. 1I and 1K 1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 11-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 11-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 10 illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 10 can be replicated in another (e.g., second) optical module disposed with the HMD to interact (e.g., project light and capture images) of another eye of the user.

Any of the features, components, and/or parts, including the arrangements and configurations thereof shown in FIG. 10 can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 10.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

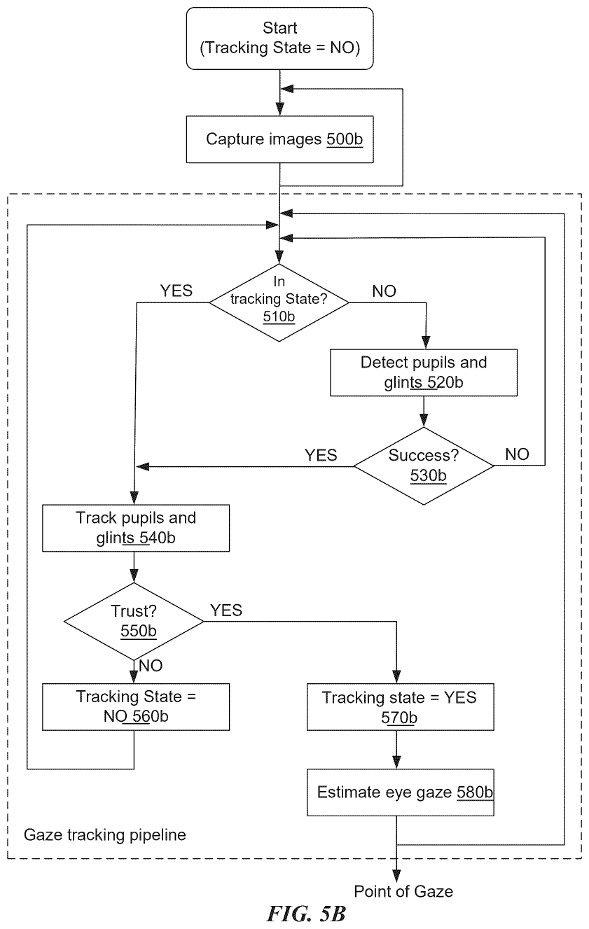

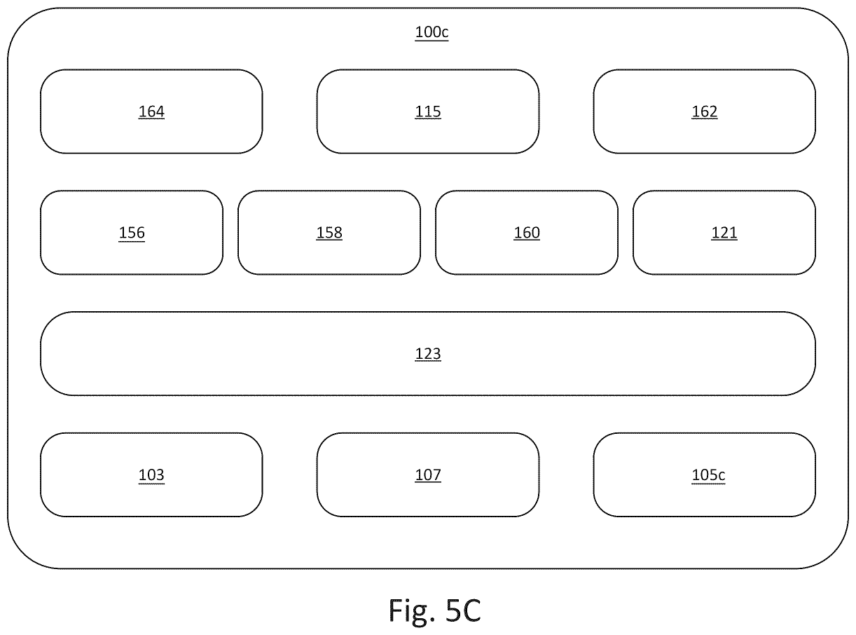

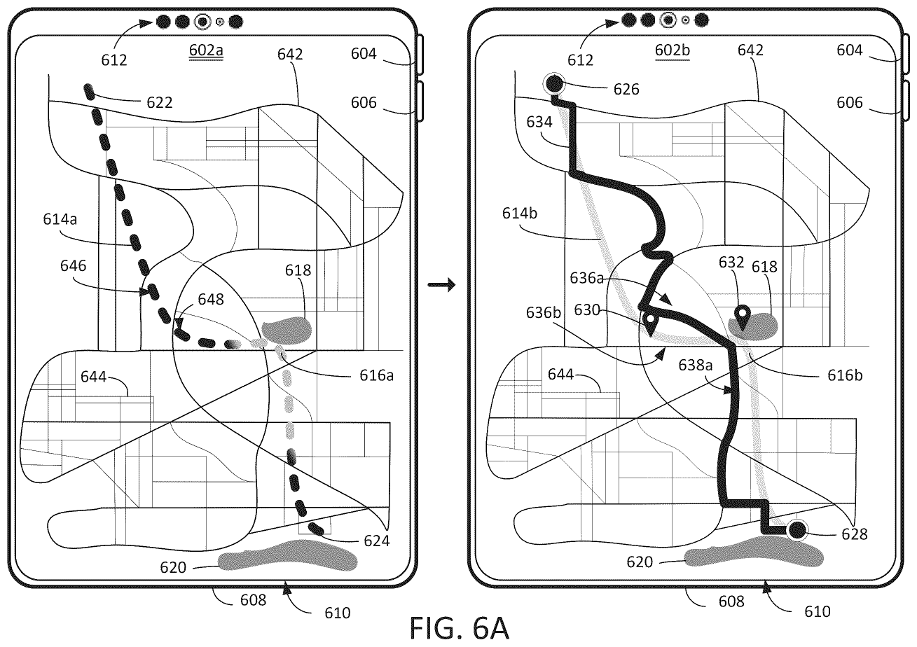

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5A.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3A is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 1100 (FIG. 11) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application. FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5A illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5A, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5A, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5A), or alternatively may be pointed towards the user's eye(s) 592 to receive reflected IR or NIR light from the eye(s) 592 (e.g., as shown in the bottom portion of FIG. 5A).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5A. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5A may, for example, be used in computer-generated reality, virtual reality, and/or mixed reality applications to provide computer-generated reality, virtual reality, augmented reality, and/or augmented virtuality experiences to the user.

FIG. 5B illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 5B, the gaze tracking cameras may capture left and right images of the user's left and right eyes. The captured images are then input to a gaze tracking pipeline for processing beginning at 510b. As indicated by the arrow returning to element 500b, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 510b, for the current captured images, if the tracking state is YES, then the method proceeds to element 540b. At 510b, if the tracking state is NO, then as indicated at 520b the images are analyzed to detect the user's pupils and glints in the images. At 530b, if the pupils and glints are successfully detected, then the method proceeds to element 540b. Otherwise, the method returns to element 510b to process next images of the user's eyes.

At 540b, if proceeding from element 510b, the current frames are analyzed to track the pupils and glints based in part on prior information from the previous frames. At 540b, if proceeding from element 530b, the tracking state is initialized based on the detected pupils and glints in the current frames. Results of processing at element 540b are checked to verify that the results of tracking or detection can be trusted. For example, results may be checked to determine if the pupil and a sufficient number of glints to perform gaze estimation are successfully tracked or detected in the current frames. At 550b, if the results cannot be trusted, then the tracking state is set to NO at element 560b, and the method returns to element 510b to process next images of the user's eyes. At 550b, if the results are trusted, then the method proceeds to element 570b. At 570b, the tracking state is set to YES (if not already YES), and the pupil and glint information is passed to element 580b to estimate the user's point of gaze.

FIG. 5B is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment are used to provide a XR experience to the user, for example, a mixed reality environment in which one or more virtual objects are superimposed over representations of real world environment.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

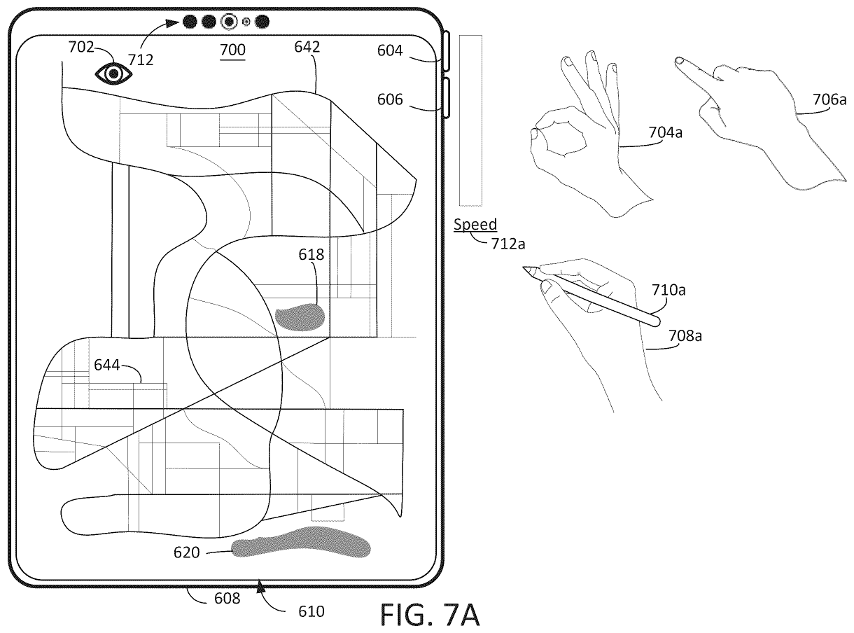

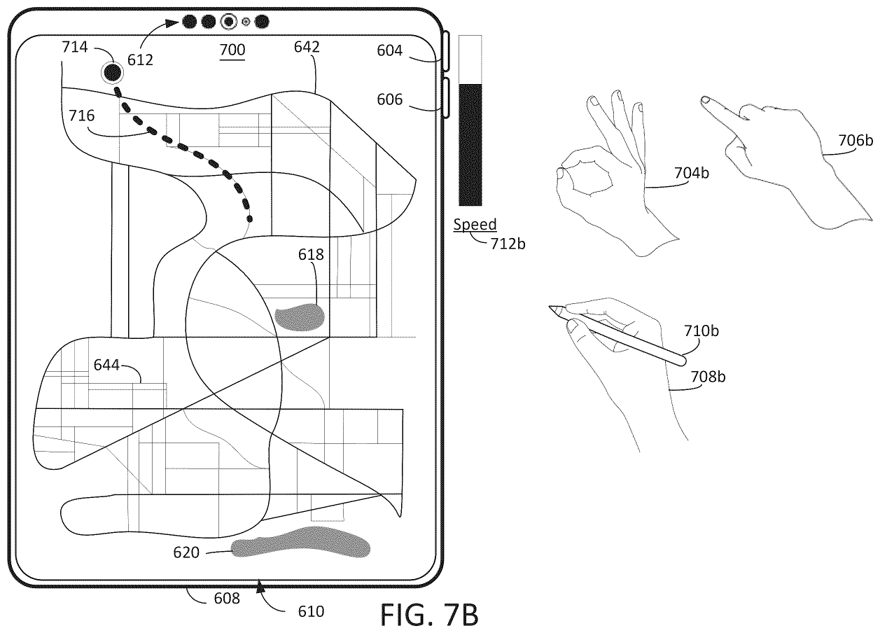

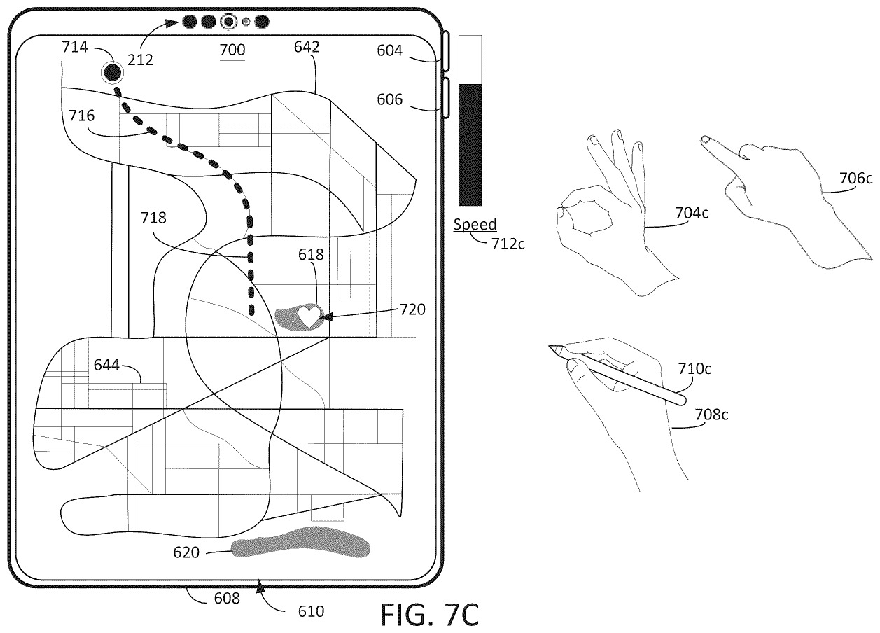

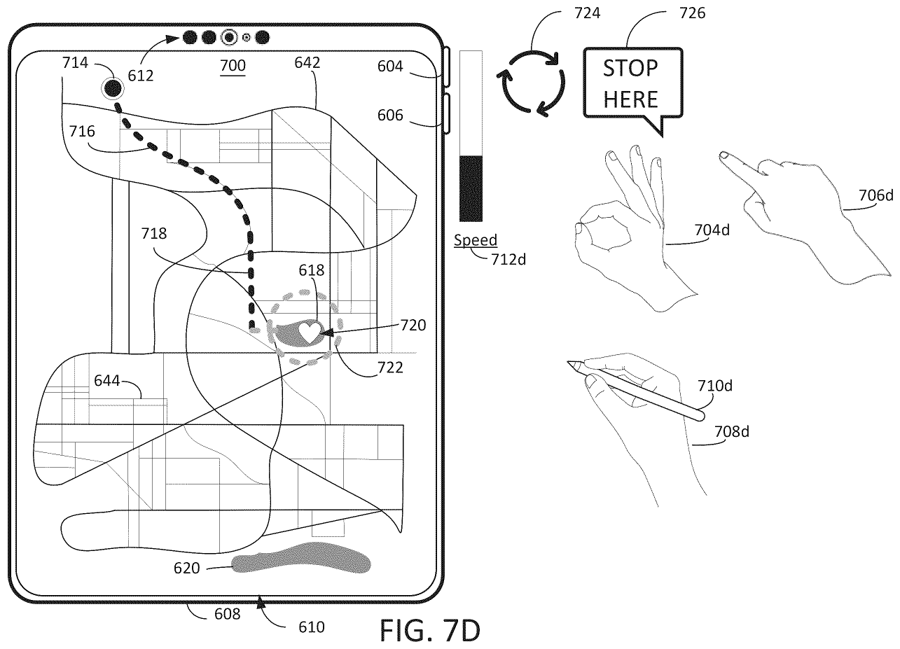

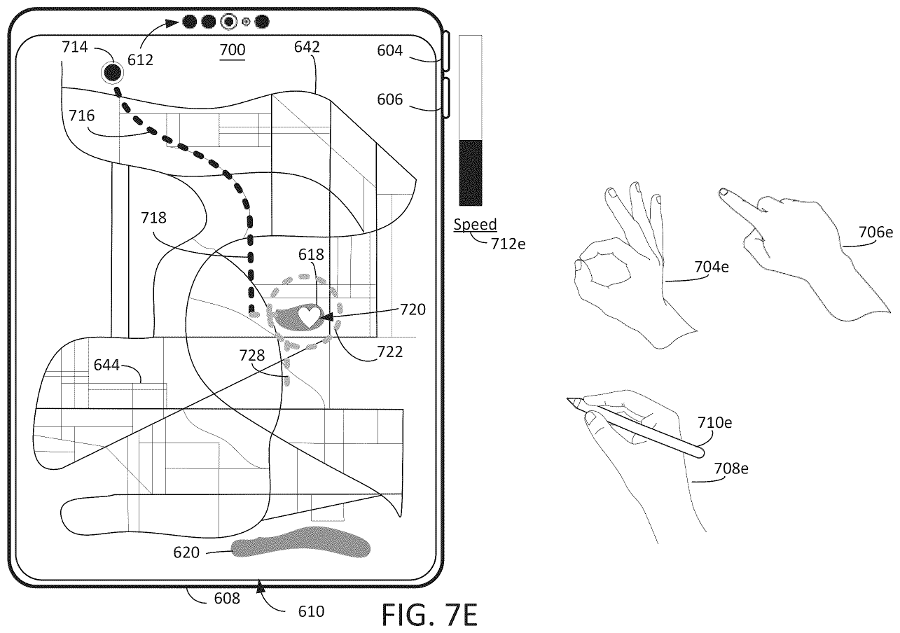

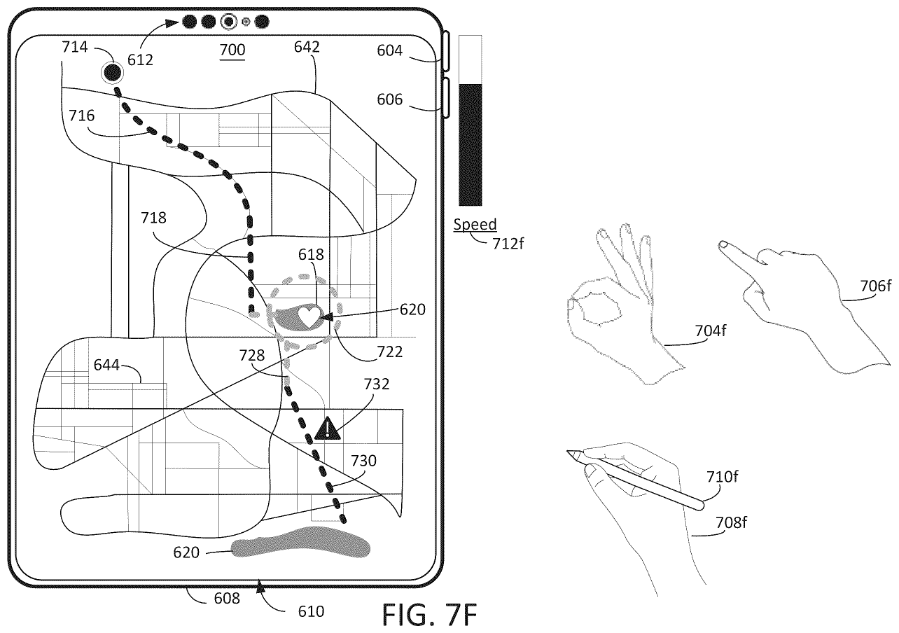

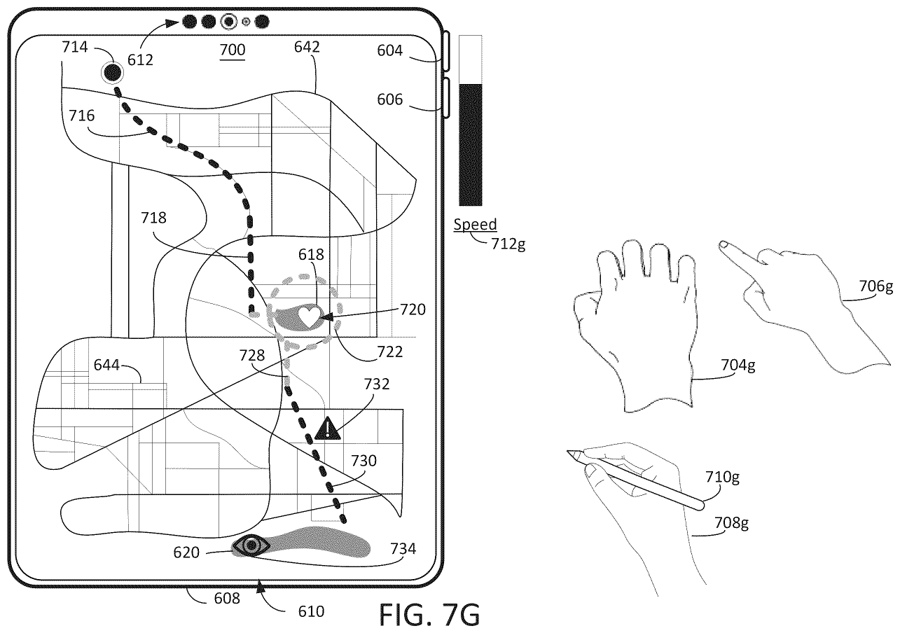

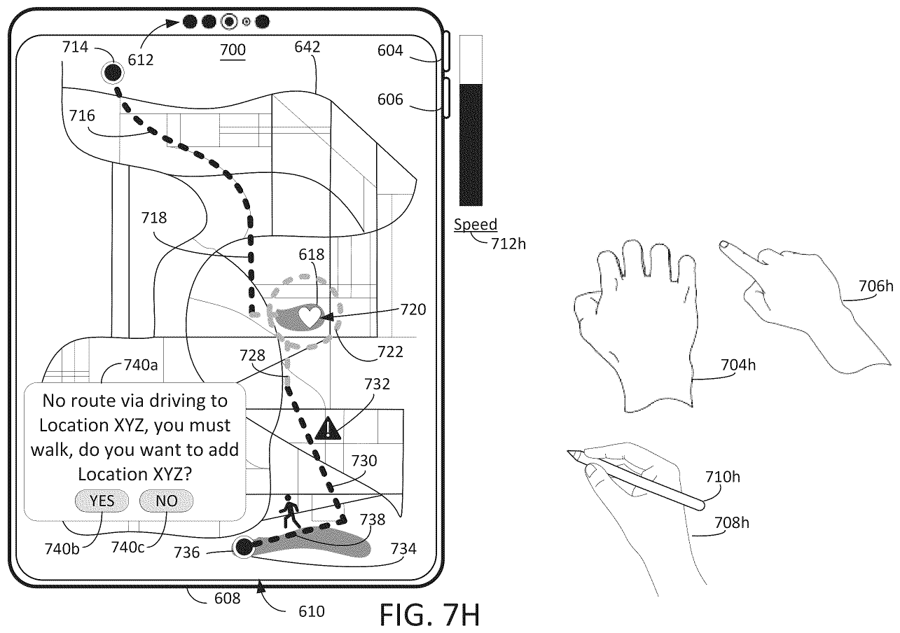

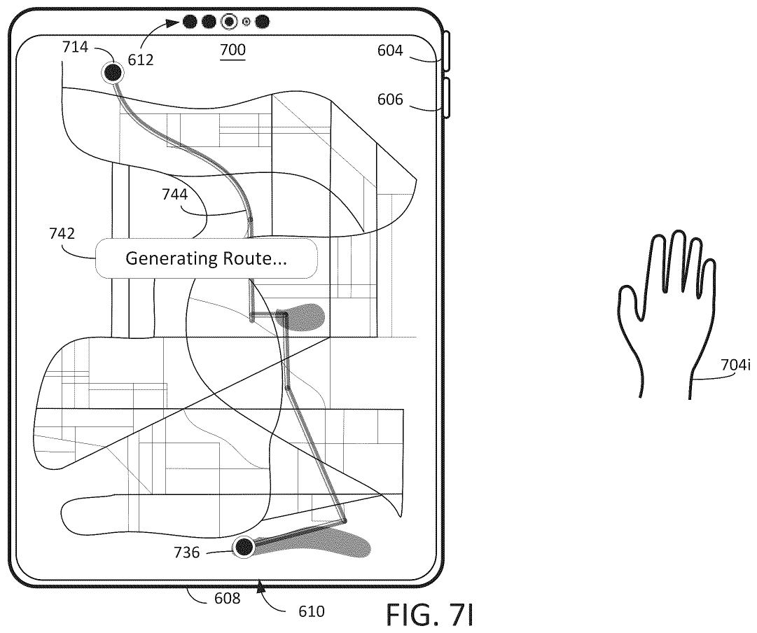

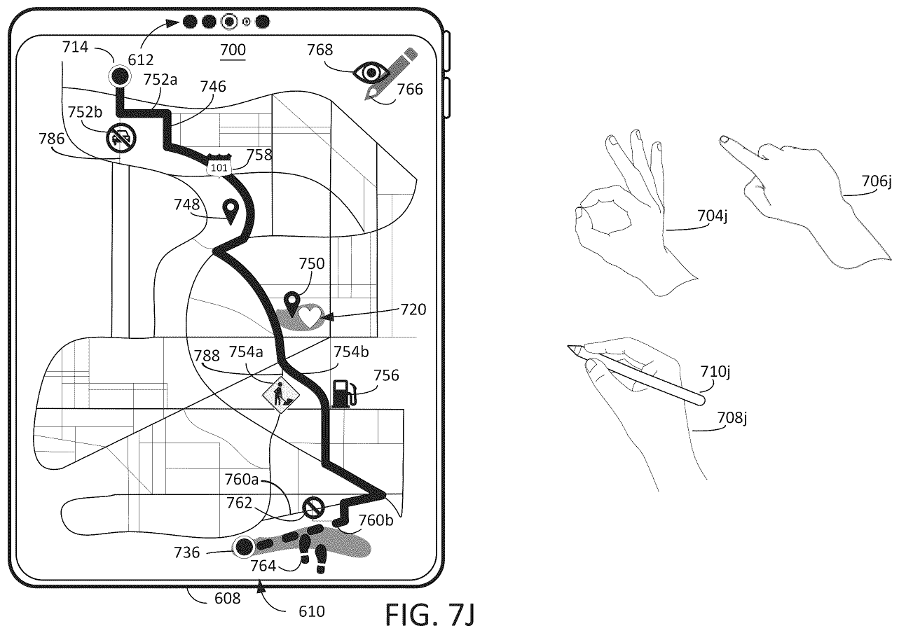

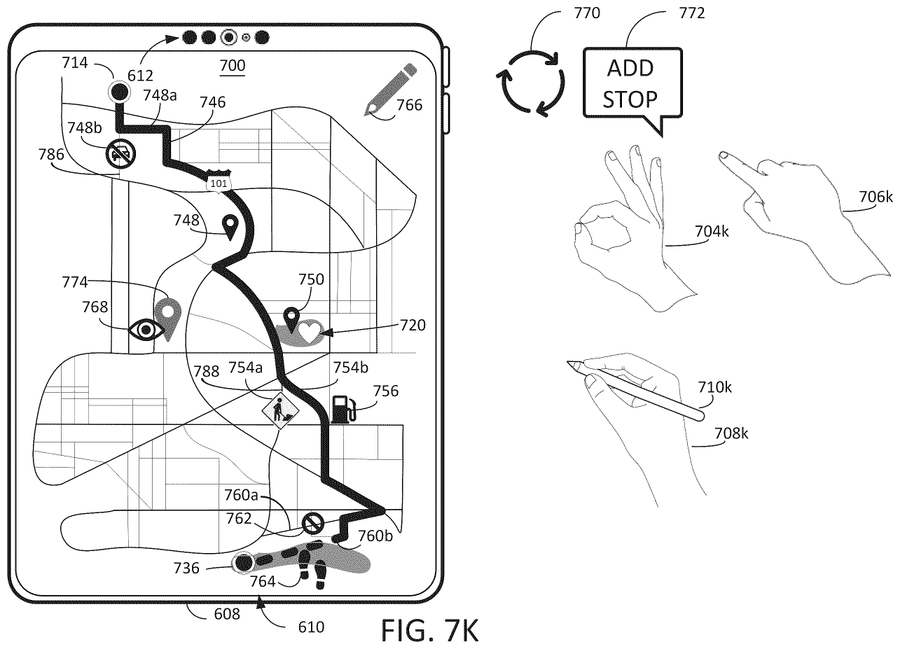

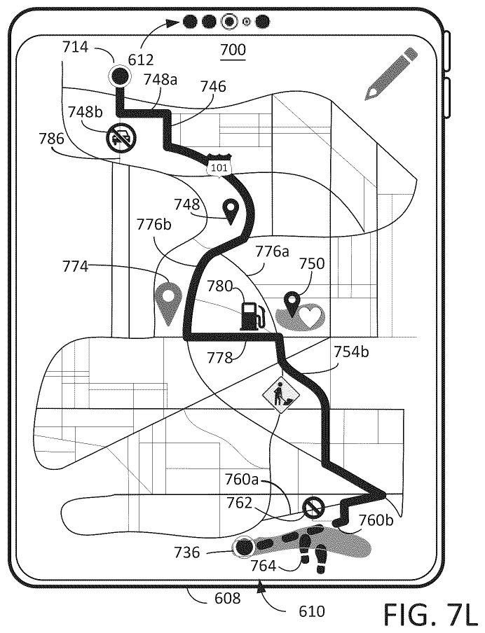

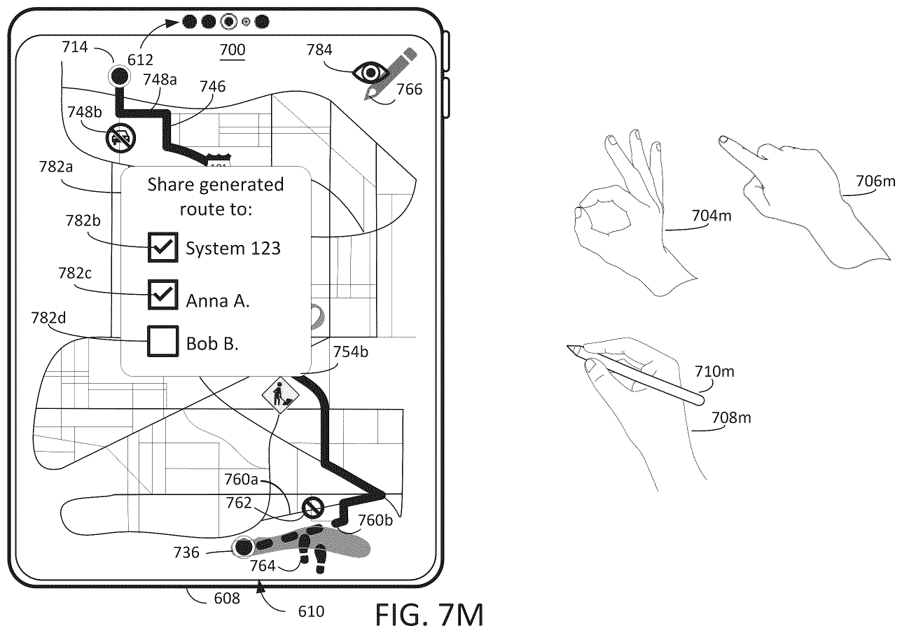

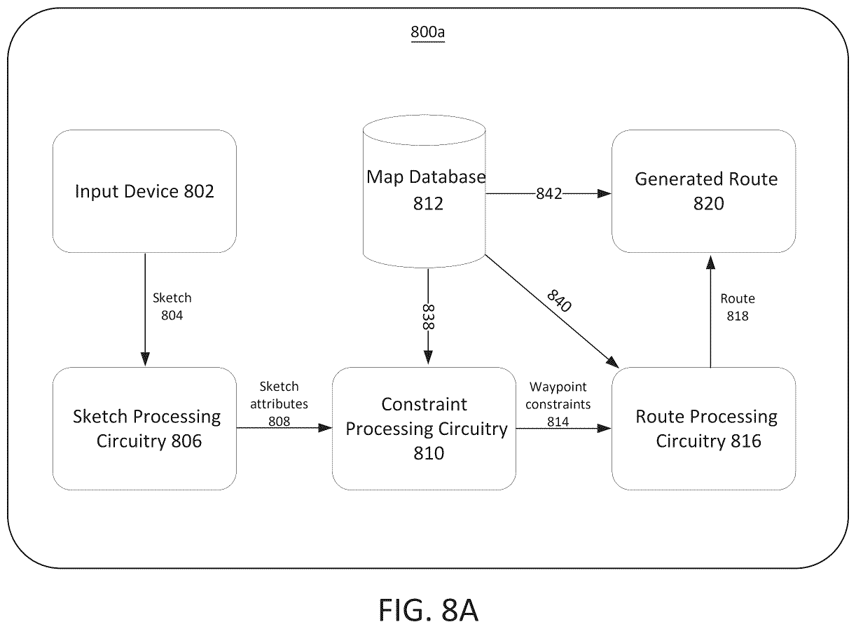

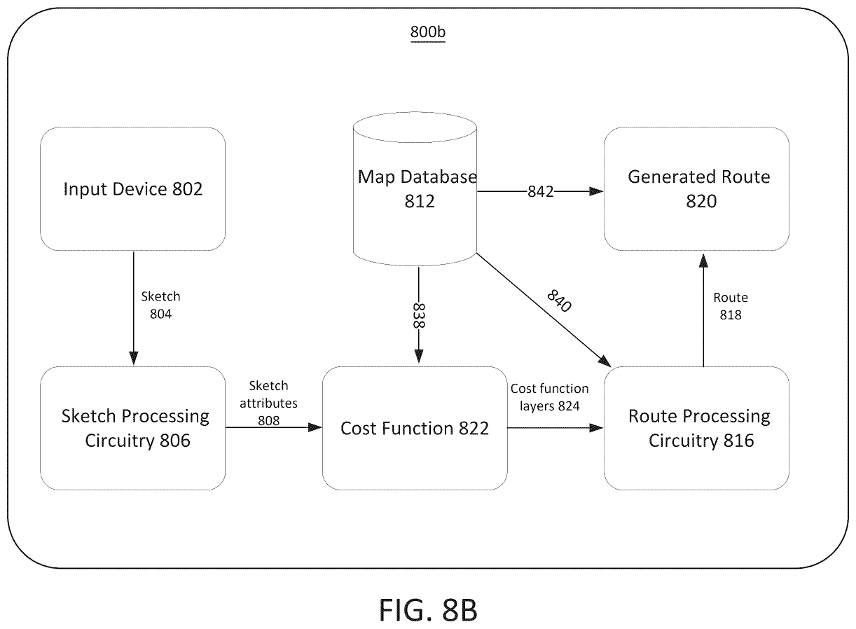

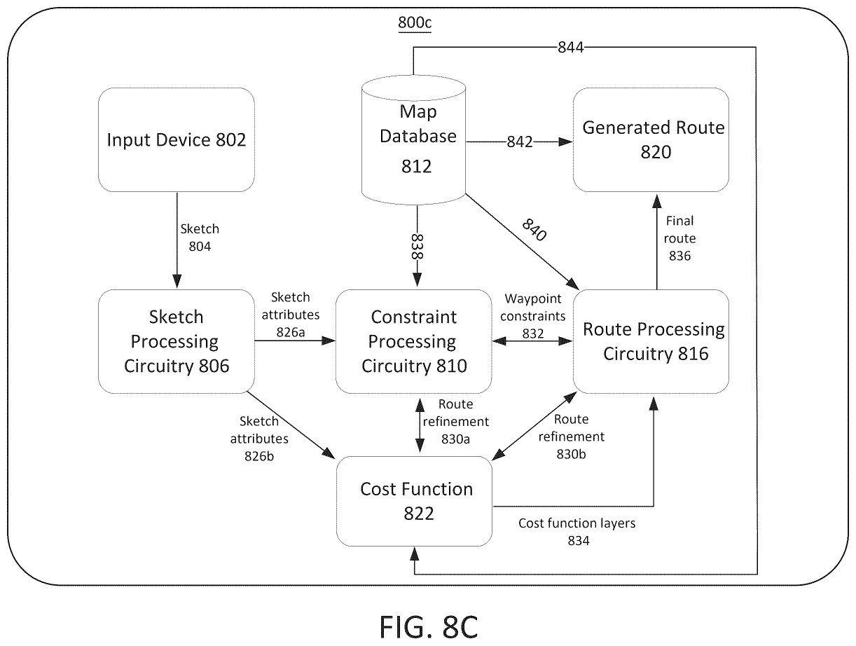

FIG. 5C provides illustrations of exemplary devices for performing techniques for controlling one or more objects within and/or integrated with a platform in response to a change in the environment external to the interior of the platform and/or a change in the interior of the platform. FIGS. 6A-6P illustrate examples of an electronic device controlling one or more objects within and/or integrated with a platform in response to a change in the environment external to the interior of the platform and/or a change in the interior of the platform in accordance with some embodiments. The user interfaces in FIGS. 6A-6G are used to illustrate the processes described below, including the processes in FIGS. 7-8.

The processes below describe various techniques for making user interfaces and/or human-computer interactions more efficient (e.g., by helping the user to quickly and easily provide inputs and preventing user mistakes when operating a device). These techniques sometimes reduce the number of inputs needed for a user (e.g., a person and/or a user) to perform an operation, provide clear and/or meaningful feedback (e.g., visual, acoustic, and/or haptic feedback) to the user so that the user knows what has happened or what to expect, provide additional information and controls without cluttering the user interface, and/or perform certain operations without requiring further input from the user. Since the user can use a device more quickly and easily, these techniques sometimes improve battery life and/or reduce power usage of the device.

In methods described where one or more steps are contingent on one or more conditions having been satisfied, it should be understood that the described method can be repeated in multiple repetitions so that over the course of the repetitions all of the conditions upon which steps in the method are contingent have been satisfied in different repetitions of the method. For example, if a method requires performing a first step if a condition is satisfied, and a second step if the condition is not satisfied, it should be appreciated that the steps are repeated until the condition has been both satisfied and not satisfied, in no particular order. Thus, a method described with one or more steps that are contingent upon one or more conditions having been satisfied could be rewritten as a method that is repeated until each of the conditions described in the method has been satisfied. This multiple repetition, however, is not required of system or computer readable medium claims where the system or computer readable medium contains instructions for performing conditional operations that require that one or more conditions be satisfied before the operations occur. A person having ordinary skill in the art would also understand that, similar to a method with conditional steps, a system or computer readable storage medium can repeat the steps of a method as many times as are needed to ensure that all of the conditional steps have been performed.

The terminology used in the description of the various embodiments is for the purpose of describing particular embodiments only and is not intended to be limiting.

User interfaces for electronic devices, and associated processes for using these devices, are described below. In some embodiments, the device is a desktop computer with a touch-sensitive surface (e.g., a touch screen display and/or a touchpad). In other embodiments, the device is a portable, movable, and/or mobile electronic device (e.g., a processor, a smart phone, a smart watch, a tablet, a fitness tracking device, a laptop, a head-mounted display (HMD) device, a communal device, a vehicle, a media device, a smart speaker, a smart display, a robot, a television and/or a personal computing device).

In some embodiments, the electronic device is a computer system that is in communication with a display component (e.g., by wireless or wired communication). The display component may be integrated into the computer system or may be separate from the computer system. Additionally, the display component may be configured to provide visual output to a display (e.g., a liquid crystal display, an OLED display, or CRT display). As used herein, “displaying” content includes causing to display the content (e.g., video data rendered or decoded by a display controller) by transmitting, via a wired or wireless connection, data (e.g., image data or video data) to an integrated or external display component to visually produce the content. In some embodiments, visual output is any output that is capable of being perceived by the human eye, including, and not limited to images, videos, graphs, charts, and other graphical representations of data.

In some embodiments, the electronic device is a computer system that is in communication with an audio generation component (e.g., by wireless or wired communication). The audio generation component may be integrated into the computer system or may be separate from the computer system. Additionally, the audio generation component may be configured to provide audio output. Examples of an audio generation component include a speaker, a home theater system, a soundbar, a headphone, an earphone, an earbud, a television speaker, an augmented reality headset speaker, an audio jack, an optical audio output, a Bluetooth audio output, and/or an HDMI audio output). In some embodiments, audio output is any output that is capable of being perceived by the human ear, including, and not limited to sound waves, music, speech, and/or other audible representations of data.

In the discussion that follows, an electronic device that includes particular input and output devices is described. It should be understood, however, that the electronic device optionally includes one or more other input and/or output devices, such as physical user-interface devices (e.g., a physical keyboard, a mouse, and/or a joystick).

FIG. 5C illustrates an example system 100c for implementing techniques described herein. System 100c can perform any of the methods described in FIGS. 7 and/or 8 (e.g., methods 1100 and/800) and/or portions of these methods.

In FIG. 1, system 100c includes various components, such as processor(s) 103, RF circuitry(ies) 105c, memory(ies) 107, sensors 156 (e.g., image sensor(s), orientation sensor(s), location sensor(s), heart rate monitor(s), temperature sensor(s)), input component(s) 158 (e.g., camera(s) (e.g., a periscope camera, a telephoto camera, a wide-angle camera, and/or an ultra-wide-angle camera), depth sensor(s), microphone(s), touch sensitive surface(s), hardware input mechanism(s), and/or rotatable input mechanism(s)), mobility components (e.g., actuator(s) (e.g., pneumatic actuator(s), hydraulic actuator(s), and/or electric actuator(s)), motor(s), wheel(s), movable base(s), rotatable component(s), translation component(s), and/or rotatable base(s)) and output component(s) 160 (e.g., speaker(s), display component(s), audio generation component(s), haptic output device(s), display screen(s), projector(s), and/or touch-sensitive display(s)). These components optionally communicate over communication bus(es) 123 of the system. Although shown as separate components, in some implementations, various components can be combined and function as a single component, such as a sensor can be an input component.

In some embodiments, system 100c is a mobile and/or movable device (e.g., a tablet, a smart phone, a laptop, head-mounted display (HMD) device, and or a smartwatch). In other embodiments, system 100c is a desktop computer, an embedded computer, and/or a server.

In some embodiments, processor(s) 103 includes one or more general processors, one or more graphics processors, and/or one or more digital signal processors. In some embodiments, memory(ies) 107 is one or more non-transitory computer-readable storage mediums (e.g., flash memory and/or random-access memory) that store computer-readable instructions configured to be executed by processor(s) 103 to perform techniques described herein.

In some embodiments, RF circuitry(ies) 105c includes circuitry for communicating with electronic devices and/or networks (e.g., the Internet, intranets, and/or a wireless network, such as cellular networks and wireless local area networks (LANs)). In some embodiments, RF circuitry(ies) 105c includes circuitry for communicating using near-field communication and/or short-range communication, such as Bluetooth® or Ultra-wideband.

In some embodiments, display(s) 121 includes one or more monitors, projectors, and/or screens. In some embodiments, display(s) 121 includes a first display for displaying images to a first eye of a user and a second display for displaying images to a second eye of the user. In such embodiments, corresponding images can be simultaneously displayed on the first display and the second display. Optionally, the corresponding images include the same virtual objects and/or representations of the same physical objects from different viewpoints, resulting in a parallax effect that provides the user with the illusion of depth of the objects on the displays. In some embodiments, display(s) 121 is a single display. In such embodiments, corresponding images are simultaneously displayed in a first area and a second area of the single display for each eye of the user. Optionally, the corresponding images include the same virtual objects and/or representations of the same physical objects from different viewpoints, resulting in a parallax effect that provides a user with the illusion of depth of the objects on the single display.

In some embodiments, system 100c includes touch-sensitive surface(s) 115 for receiving user inputs, such as tap inputs and swipe inputs. In some embodiments, display(s) 121 and touch-sensitive surface(s) 115 form touch-sensitive display(s).

In some embodiments, sensor(s) 156 includes sensors for detecting various conditions. In some embodiments, sensor(s) 156 includes orientation sensors (e.g., orientation sensor(s) 111) for detecting orientation and/or movement of platform. For example, system 100c uses orientation sensors to track changes in the location and/or orientation (sometimes collectively referred to as position) of system 100c, such as with respect to physical objects in the physical environment. In some embodiments, sensor(s) 156 includes one or more gyroscopes, one or more inertial measurement units, and/or one or more accelerometers. In some embodiments, sensor(s) 156 includes a global positioning sensor (GPS) for detecting a GPS location of platform. In some embodiments, sensor(s) 156 includes a radar system, LIDAR system, sonar system, image sensors (e.g., image sensor(s) 109, visible light image sensor(s), and/or infrared sensor(s)), depth sensor(s), rangefinder(s), and/or motion detector(s). In some embodiments, sensor(s) 156 includes sensors that are in an interior portion of system 100c and/or sensors that are on an exterior of system 100c. In some embodiments, system 100c uses sensor(s) 156 (e.g., interior sensors) to detect a presence and/or state (e.g., location and/or orientation) of a passenger in the interior portion of system 100c. In some embodiments, system 100c uses sensor(s) 156 (e.g., external sensors) to detect a presence and/or state of an object external to system 100c. In some embodiments, system 100c uses sensor(s) 156 to receive user inputs, such as hand gestures and/or other air gesture. In some embodiments, system 100c uses sensor(s) 156 to detect the location and/or orientation of system 100c in the physical environment. In some embodiments, system 100c uses sensor(s) 156 to navigate system 100c along a planned route, around obstacles, and/or to a destination location. In some embodiments, sensor(s) 156 include one or more sensors for identifying and/or authenticating a user of system 100c, such as a fingerprint sensor and/or facial recognition sensor.

In some embodiments, image sensor(s) includes one or more visible light image sensor, such as charged coupled device (CCD) sensors, and/or complementary metal-oxide-semiconductor (CMOS) sensors operable to obtain images of physical objects. In some embodiments, image sensor(s) includes one or more infrared (IR) sensor(s), such as a passive IR sensor or an active IR sensor, for detecting infrared light. For example, an active IR sensor can include an IR emitter, such as an IR dot emitter, for emitting infrared light. In some embodiments, image sensor(s) includes one or more camera(s) configured to capture movement of physical objects. In some embodiments, image sensor(s) includes one or more depth sensor(s) configured to detect the distance of physical objects from system 100c. In some embodiments, system 100c uses CCD sensors, cameras, and depth sensors in combination to detect the physical environment around system 100c. In some embodiments, image sensor(s) includes a first image sensor and a second image sensor different form the first image sensor. In some embodiments, system 100c uses image sensor(s) to receive user inputs, such as hand gestures and/or other air gestures. In some embodiments, system 100c uses image sensor(s) to detect the location and/or orientation of system 100c in the physical environment.

In some embodiments, system 100c uses orientation sensor(s) for detecting orientation and/or movement of system 100c. For example, system 100c can use orientation sensor(s) to track changes in the location and/or orientation of system 100c, such as with respect to physical objects in the physical environment. In some embodiments, orientation sensor(s) includes one or more gyroscopes, one or more inertial measurement units, and/or one or more accelerometers.

In some embodiments, system 100c uses microphone(s) to detect sound from one or more users and/or the physical environment of the one or more users. In some embodiments, microphone(s) includes an array of microphones (including a plurality of microphones) that optionally operate in tandem, such as to identify ambient noise or to locate the source of sound in space (e.g., inside system 100c and/or outside of system 100c) of the physical environment.

In some embodiments, input device(s) 158 includes one or more mechanical and/or electrical devices for detecting input, such as button(s), slider(s), knob(s), switch(es), remote control(s), joystick(s), touch-sensitive surface(s), keypad(s), microphone(s), and/or camera(s). In some embodiments, input device(s) 158 include one or more input devices inside system 100c. In some embodiments, input device(s) 158 include one or more input devices (e.g., a touch-sensitive surface and/or keypad) on an exterior of system 100c.

In some embodiments, output device(s) 160 include one or more devices, such as display(s), monitor(s), projector(s), speaker(s), light(s), and/or haptic output device(s). In some embodiments, output device(s) 160 includes one or more external output devices, such as external display screen(s), external light(s), and/or external speaker(s). In some embodiments, output device(s) 160 includes one or more internal output devices, such as internal display screen(s), internal light(s), and/or internal speaker(s).

In some embodiments, environment controls 162 includes mechanical and/or electrical systems for monitoring and/or controlling conditions of an internal portion (e.g., cabin) of system 100c. In some embodiments, environmental controls 162 includes fan(s), heater(s), air conditioner(s), and/or thermostat(s) for controlling the temperature and/or airflow within the interior portion of system 100c.

In some embodiments, mobility component(s) includes mechanical and/or electrical components that enable a platform to move and/or assist in the movement of the platform. In some embodiments, mobility system 164 includes powertrain(s), drivetrain(s), motor(s) (e.g., an electrical motor), engine(s), power source(s) (e.g., battery(ies)), transmission(s), suspension system(s), speed control system(s), and/or steering system(s). In some embodiments, one or more elements of mobility component(s) are configured to be controlled autonomously or manually (e.g., via system 100c and/or input device(s) 158).

In some embodiments, system 100c performs monetary transactions with or without another computer system. For example, system 100c, or another computer system associated with and/or in communication with system 100c (e.g., via a user account described below), is associated with a payment account of a user, such as a credit card account or a checking account. To complete a transaction, system 100c can transmit a key to an entity from which goods and/or services are being purchased that enables the entity to charge the payment account for the transaction. As another example, system 100c stores encrypted payment account information and transmits this information to entities from which goods and/or services are being purchased to complete transactions.

System 100c optionally conducts other transactions with other systems, computers, and/or devices. For example, system 100c conducts transactions to unlock another system, computer, and/or device and/or to be unlocked by another system, computer, and/or device. Unlocking transactions optionally include sending and/or receiving one or more secure cryptographic keys using, for example, RF circuitry(ies) 105c.

In some embodiments, system 100c is capable of communicating with other computer systems and/or electronic devices. For example, system 100c can use RF circuitry(ies) 105c to access a network connection that enables transmission of data between systems for the purpose of communication. Example communication sessions include phone calls, e-mails, SMS messages, and/or videoconferencing communication sessions.

In some embodiments, videoconferencing communication sessions include transmission and/or receipt of video and/or audio data between systems participating in the videoconferencing communication sessions, including system 100c. In some embodiments, system 100c captures video and/or audio content using sensor(s) 156 to be transmitted to the other system(s) in the videoconferencing communication sessions using RF circuitry(ies) 105c. In some embodiments, system 100c receives, using the RF circuitry(ies) 105c, video and/or audio from the other system(s) in the videoconferencing communication sessions, and presents the video and/or audio using output component(s) 160, such as display(s) 121 and/or speaker(s). In some embodiments, the transmission of audio and/or video between systems is near real-time, such as being presented to the other system(s) with a delay of less than 0.1, 0.5, 1, or 3 seconds from the time of capturing a respective portion of the audio and/or video.

In some embodiments, the system 100c generates tactile (e.g., haptic) outputs using output component(s) 160. In some embodiments, output component(s) 160 generates the tactile outputs by displacing a moveable mass relative to a neutral position. In some embodiments, tactile outputs are periodic in nature, optionally including frequency(ies) and/or amplitude(s) of movement in two or three dimensions. In some embodiments, system 100c generates a variety of different tactile outputs differing in frequency(ies), amplitude(s), and/or duration/number of cycle(s) of movement included. In some embodiments, tactile output pattern(s) includes a start buffer and/or an end buffer during which the movable mass gradually speeds up and/or slows down at the start and/or at the end of the tactile output, respectively.

In some embodiments, tactile outputs have a corresponding characteristic frequency that affects a “pitch” of a haptic sensation that a user feels. For example, higher frequency(ies) corresponds to faster movement(s) by the moveable mass whereas lower frequency(ies) corresponds to slower movement(s) by the moveable mass. In some embodiments, tactile outputs have a corresponding characteristic amplitude that affects a “strength” of the haptic sensation that the user feels. For example, higher amplitude(s) corresponds to movement over a greater distance by the moveable mass, whereas lower amplitude(s) corresponds to movement over a smaller distance by the moveable mass. In some embodiments, the “pitch” and/or “strength” of a tactile output varies over time.

In some embodiments, tactile outputs are distinct from movement of system 100c. For example, system 100c can includes tactile output device(s) that move a moveable mass to generate tactile output and can include other moving part(s), such as motor(s), wheel(s), axel(s), control arm(s), and/or brakes that control movement of system 100c. Although movement and/or cessation of movement of system 100c generates vibrations and/or other physical sensations in some situations, these vibrations and/or other physical sensations are distinct from tactile outputs. In some embodiments, system 100c generates tactile output independent from movement of system 100c For example, system 100c can generate a tactile output without accelerating, decelerating, and/or moving system 100c to a new position.

In some embodiments, system 100c detects gesture input(s) made by a user. In some embodiments, gesture input(s) includes touch gesture(s) and/or air gesture(s), as described herein. In some embodiments, touch-sensitive surface(s) 115 identify touch gestures based on contact patterns (e.g., different intensities, timings, and/or motions of objects touching or nearly touching touch-sensitive surface(s) 115). Thus, touch-sensitive surface(s) 115 detect a gesture by detecting a respective contact pattern. For example, detecting a finger-down event followed by detecting a finger-up (e.g., liftoff) event at (e.g., substantially) the same position as the finger-down event (e.g., at the position of a user interface element) can correspond to detecting a tap gesture on the user interface element. As another example, detecting a finger-down event followed by detecting movement of a contact, and subsequently followed by detecting a finger-up (e.g., liftoff) event can correspond to detecting a swipe gesture. Additional and/or alternative touch gestures are possible.

In some embodiments, an air gesture is a gesture that a user performs without touching input component(s) 158. In some embodiments, air gestures are based on detected motion of a portion (e.g., a hand, a finger, and/or a body) of a user through the air. In some embodiments, air gestures include motion of the portion of the user relative to a reference. Example references include a distance of a hand of a user relative to a physical object, such as the ground, an angle of an arm of the user relative to the physical object, and/or movement of a first portion (e.g., hand or finger) of the user relative to a second portion (e.g., shoulder, another hand, or another finger) of the user. In some embodiments, detecting an air gesture includes detecting absolute motion of the portion of the user, such as a tap gesture that includes movement of a hand in a predetermined pose by a predetermined amount and/or speed, or a shake gesture that includes a predetermined speed or amount of rotation of a portion of the user.

In some embodiments, detecting one or more inputs includes detecting speech of a user. In some embodiments, system 100c uses one or more microphones of input component(s) 158 to detect the user speaking one or more words. In some embodiments, system 100c parses and/or communicates information to one or more other systems to determine contents of the speech of the user, including identifying words and/or obtaining a semantic understanding of the words. For example, system processor(s) 103 can be configured to perform natural language processing to detect one or more words and/or determine a likely meaning of the one or more words in the sequence spoken by the user. Additionally or alternatively, in some embodiments, the system 100c determines the meaning of the one or more words in the sequence spoken based upon a context of the user determined by the system 100c.

In some embodiments, system 100c outputs spatial audio via output component(s) 160. In some embodiments, spatial audio is output in a particular position. For example, system 100c can play a notification chime having one or more characteristics that cause the notification chime to be generated as if emanating from a first position relative to a current viewpoint of a user (e.g., “spatializing” and/or “spatialization” including audio being modified in amplitude, filtered, and/or delayed to provide a perceived spatial quality to the user).

In some embodiments, system 100c presents visual and/or audio feedback indicating a position of a user relative to a current viewpoint of another user, thereby informing the other user about an updated position of the user. In some embodiments, playing audio corresponding to a user includes changing one or more characteristics of audio obtained from another computer system to mimic an effect of placing an audio source that generates the play back of audio within a position corresponding to the user, such as a position within a three-dimensional environment that the user moves to, spawns at, and/or is assigned to. In some embodiments, a relative magnitude of audio at one or more frequencies and/or groups of frequencies is changed, one or more filters are applied to audio (e.g., directional audio filters), and/or the magnitude of audio provided via one or more channels are changed (e.g., increased or decreased) to create the perceived effect of the physical audio source. In some embodiments, the simulated position of the simulated audio source relative to a floor of the three-dimensional environment matches an elevation of a head of a participant providing audio that is generated by the simulated audio source, or is a predetermined one or more elevations relative to the floor of the three-dimensional environment. In some embodiments, in accordance with a determination that the position of the user will correspond to a second position, different from the first position, and that one or more first criteria are satisfied, system 100c presents feedback including generating audio as if emanating from the second position.

In some embodiments, system 100c communicates with one or more accessory devices. In some embodiments, one or more accessory devices is integrated with system 100c. In some embodiments, one or more accessory devices is external to system 100c. In some embodiments, system 100c communicates with accessory device(s) using RF circuitry(ies) 105c and/or using a wired connection. In some embodiments, system 100c controls operation of accessory device(s), such as door(s), window(s), lock(s), speaker(s), light(s), and/or camera(s). For example, system 100c can control operation of a motorized door of system 100c. As another example, system 100c can control operation of a motorized window included in system 100c. In some embodiments, accessory device(s), such as remote control(s) and/or other computer systems (e.g., smartphones, media players, tablets, computers, and/or wearable devices) functioning as input devices control operations of system 100c. For example, a wearable device (e.g., a smart watch) functions as a key to initiate operation of an actuation system of system 100c. In some embodiments, system 100c acts as an input device to control operations of another system, device, and/or computer, such as a platform functioning as a key to initiate operation of an actuation system of a platform associated with another system, device, and/or computer.

In some embodiments, digital assistant(s) help a user perform various functions using system 100c. For example, a digital assistant can provide weather updates, set alarms, and perform searches locally and/or using a network connection (e.g., the Internet) via a natural-language interface. In some embodiments, a digital assistant accepts requests at least partially in the form of natural language commands, narratives, requests, statements, and/or inquiries. In some embodiments, a user requests an informational answer and/or performance of a task using the digital assistant. For example, in response to receiving the question “What is the current temperature?,” the digital assistant answers “It is 30 degrees.” As another example, in response to receiving a request to perform a task, such as “Please invite my family to dinner tomorrow,” the digital assistant can acknowledge the request by playing spoken words, such as “Yes, right away,” and then send the requested calendar invitation on behalf of the user to each family member of the user listed in a contacts list for the user. In some embodiments, during performance of a task requested by the user, the digital assistant engages with the user in a sustained conversation involving multiple exchanges of information over a period of time. Other ways of interacting with a digital assistant are possible to request performance of a task and/or request information. For example, the digital assistant can respond to the user in other forms, e.g., displayed alerts, text, videos, animations, music, etc. In some embodiments, the digital assistant includes a client-side portion executed on system 100c and a server-side portion executed on a server in communication with system 100c. The client-side portion can communicate with the server through a network connection using RF circuitry(ies) 105c. The client-side portion can provide client-side functionalities, input and/or output processing and/or communication with the server, for example. In some embodiments, the server-side portion provides server-side functionalities for any number client-side portions of multiple systems.

In some embodiments, system 100c is associated with one or more user accounts. In some embodiments, system 100c saves and/or encrypts user data, including files, settings, and/or preferences in association with particular user accounts. In some embodiments, user accounts are password-protected and system 100c requires user authentication before accessing user data associated with an account. In some embodiments, user accounts are associated with other system(s), device(s), and/or server(s). In some embodiments, associating one user account with multiple systems enables those systems to access, update, and/or synchronize user data associated with the user account. For example, the systems associated with a user account can have access to purchased media content, a contacts list, communication sessions, payment information, saved passwords, and other user data. Thus, in some embodiments, user accounts provide a secure mechanism for a customized user experience.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

Users interact with electronic devices in many different manners, such as for route planning and/or displaying map information. In some embodiments, an electronic device receives a gesture from a user of the electronic device corresponding to a request to generate a route and the electronic device generates a route that is i) independent from one or more attributes of a movement portion of the gesture and based on map data, ii) based on the one or more attributes of the movement portion of the gesture and map data, or iii) a refinement to an initial route that is based on the one or more attributes of the movement portion of the gesture and map data.

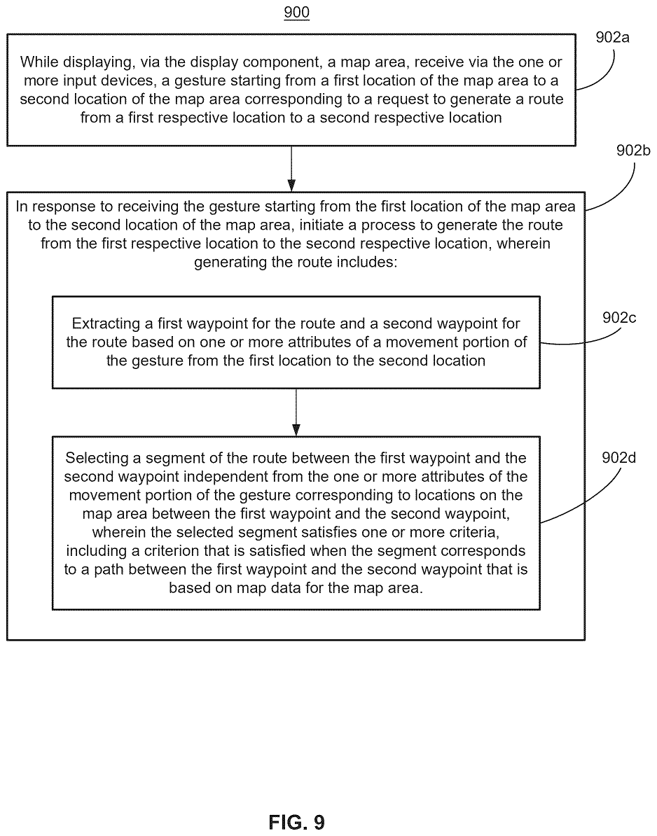

FIGS. 6A-6C illustrate exemplary ways in which an electronic device detects a gesture performed by a user of the electronic device and generates a route that is based, at least in part, on one or more attributes of a movement portion of the gesture and map data according to some embodiments of the disclosure. The embodiments in these figures are used to illustrate the processes described below, including the processes described with reference to FIGS. 9-11. Although FIGS. 6A-6C illustrate various examples of ways an electronic device is able to perform the processes described below with reference to FIGS. 9-11, it should be understood that these examples are not meant to be limiting, and the electronic device is able to perform one or more processes described below with reference to FIGS. 9-11 in ways not expressly described with reference to FIGS. 6A-6C.

FIG. 6A illustrates an electronic device 608. As described above with reference to FIG. 1, the electronic device 608 optionally includes a display component 610 (e.g., display(s) 121 of FIG. 1) and a plurality of image sensors 612 (e.g., sensors 156 of FIG. 1). The image sensors 612 optionally include one or more of a visible light camera, an infrared camera, a depth sensor, or any other sensor capable of capturing one or more images of a user or a part of the user (e.g., one or more hands and/or eyes of the user) while the user interacts with the electronic device 608. In some embodiments, the user interfaces illustrated and described below could also be implemented using a head-mounted display that includes a display component that presents the user interface and/or a three-dimensional environment to the user. Optionally, the head-mounted display further includes sensors that detect the physical environment and/or movements of the user's hands (e.g., external sensors facing outwards from the user) such as movements that are interpreted by the computer system as gestures such as air gestures, and/or gaze of the user (e.g., internal sensors facing inwards towards the face of the user).

FIG. 6A illustrates electronic device 608, displaying, via the display component 610, a map area 602a (optionally in a three-dimensional environment from a viewpoint of a user). Map area 602a includes transportation segments or roadways (e.g., roadway 642), transit routes (e.g., transit route 644), walking paths, biking paths, significant locations, and/or points of interest (e.g., lake 618). In some embodiments, the electronic device 608 detects, via one or more input devices (e.g., such as described with reference to method 500), a gesture corresponding to a request to generate a route from a first respective location to a second respective location. For example, the gesture includes movement from a first location of the map area 602a that corresponds to the first respective location to a second location of the map area 602a that corresponds to the second respective location. In some embodiments, the gesture is an input interacting with the map area 602a that is performed by one or more hands of the user, a movement of the one or more hands of the user, a gaze by the user at a respective location, a voice command, another input device (e.g., stylus input or mouse based input) and/or the like as will be described with reference to method 500 and/or FIGS. 7A-7M.

FIG. 6A, map area 602a illustrates an example of the electronic device 608 displaying a sketch 614a corresponding to the gesture. In FIG. 6A, map area 602a illustrates the sketch 614a as a hand drawn line or other shape overlaid on the map area 602a starting at a first location 622 of the map area 602a corresponding to the first location at which the gesture starts and ending at a second location 624 of the map area 602a corresponding to the second location at which the gesture ends.

In some embodiments, in response to receiving the gesture, the electronic device 608 initiates a process to generate the route from the first respective location to the second respective location in accordance with a first methodology as described in method 500 and/or FIG. 8A. Referring to FIG. 6A, map area 602b shows a result of the process to generate the route according to the first methodology. Generating the route includes displaying a representation of the generated route 634 via the display component 610.

For example, FIG. 6A illustrates the electronic device 608 displaying, via display component 610, the map area 602b including the representation of the generated route 634 concurrently with and/or overlaid on a representation of the sketch 614a. The representation of the sketch 614a shown in FIG. 6A, map area 602b is for illustrative purposes and is not necessarily displayed in the map area 602b. In some embodiments, after displaying the sketch 614a as shown in map area 602a of FIG. 6A, the electronic device 608 displays an animated transition from displaying the sketch 614a to displaying the representation of the generated route 634. In some embodiments, in FIG. 6A, the electronic device 608 displays the representation of the generated route 634 with one or more visual characteristics (e.g., solid, bolded line) different from the one or more visual characteristics associated with the sketch 614a (e.g., dashed, broken line).

In some embodiments, initiating the process to generate the route in response to receiving the gesture includes extracting a first waypoint for the route and a second waypoint for the route based on one or more attributes of a movement portion of the gesture from the first location to the second location. The movement portion of the gesture optionally refers to a speed, direction, and/or acceleration (e.g., change in speed and/or direction) of the gesture as described with reference to method 500. In some embodiments, the one or more attributes of the movement portion of the gesture include a change in direction of the movement portion of the gesture. For example, the electronic device 608 receives a gesture that starts by moving in a downwards direction. In this example, in response to receiving this part of the gesture, the electronic device 608 displays a first part (e.g., part 646) of the sketch 614a that covers more vertical distance than horizontal distance, corresponding to the downward movement of the portion of the gesture. In some embodiments, the electronic device 608 determines that the gesture includes a change in direction of the movement portion of the gesture. For example, the electronic device 608 determines the movement portion of the gesture includes movement in a leftwards direction. In this example, in response to receiving this part of the gesture, the electronic device 608 displays a second part of the sketch 614a that covers more leftwards distance than rightwards distance, corresponding to the leftwards direction movement of the portion of the gesture. In some embodiments, the electronic device 608 displays the sketch 614a including an angle or corner location 648 in response to this part of the gesture.

In some embodiments, the electronic device 608 determines that the corner location 648 is indicative of a request by the user to include a precise location corresponding to the corner location 648 of the sketch 614a. For example, in response to detecting the gesture including the corner, the electronic device 608 extracts a first waypoint 630 at a location of the map area 602b corresponding to the corner location 648 of the sketch 614a as shown in FIG. 6A. In some embodiments, the electronic device 608 identifies or marks the first waypoint 630 as a location for the generated route to move past without planning a stop at the location of the first waypoint 630. In some embodiments, the electronic device 608 identifies the first waypoint 630 as a stop along the generated route at the location of the first waypoint 630.

As mentioned above, the electronic device 608 extracts a second waypoint for the route based on the one or more attributes of a movement portion of the gesture from the first location to the second location. In some embodiments, the one or more attributes of the movement portion of the gesture include a speed of the movement portion of the gesture. For example, the electronic device 608 determines that the speed of the movement portion of the gesture is below a predetermined speed (e.g., 25, 50, 75, 100, 125, or 150 millimeters/second). In some embodiments, in response to the electronic device 608 determining that the speed of the movement portion of the gesture is below the predetermined speed as illustrated by the light colored (e.g., grey) part 616a of the sketch 614a, the electronic device 608 identifies one or more waypoints to be added to the route. In some embodiments, the electronic device 608 identifies the one or more waypoints to be added to the route as waypoints at respective locations corresponding to the slower speed of movement, such as illustrated with the identification of the second waypoint 632 of map area 602b in FIG. 6A. (The light colored part 616a of the sketch 614a shown in FIG. 6A, map area 602b is for illustrative purposes and is not necessarily displayed in a different color from the sketch 614a in the map area 602a.)

In some embodiments, when generating the route in accordance with the first methodology, the electronic device 608 generates a segment of the route between the first waypoint 630 and the second waypoint 632 independent from the one or more attributes of the movement portion of the gesture corresponding to locations on the map area between the first waypoint 630 and the second waypoint 632. For example, in FIG. 6A, map area 602b includes a first segment 636a between the first waypoint 630 and the second waypoint 632 and a second segment 636b between the first waypoint 630 and the second waypoint 632. In this example, the electronic device 608 compares the first segment 636a and the second segment 636b to determine which segment provides an optimal use of travel time, travel distance, fuel consumption, and/or energy consumption. In some embodiments, the electronic device 608 determines the optimal segment or path independent from a respective location corresponding to the movement portion of the gesture (e.g., the sketch 614a). For example, the electronic device 608 optionally determines the first segment 636a as the optimal segment based on map data despite the first segment 636a location beyond a predetermined distance (e.g., 0.3, 0.5, 1, 10, 20, 50, or 100 kilometers) from the sketch 614a. In some embodiments, the electronic device 608 determines that the cost for the second segment 636b is greater than the cost for the first segment 636a based on map data despite the second segment 636b located within the predetermined distance from the sketch 614a. In this case, and as illustrated in FIG. 6A, map area 602b, the electronic device 608 generates the route 634 that includes the first segment 636a instead of the second segment 636a.

FIG. 6B illustrates the electronic device 608 initiating a process to generate the route from the first respective location to the second respective location in accordance with a second methodology, different from the first methodology, and as described in method 1000 and/or FIG. 8B. Referring to FIG. 6B, map area 602c shows a result of the process to generate the route according to the second methodology. Generating the route optionally includes displaying a representation of the generated route 640 via display component 610.

For example, in response to receiving the gesture as described with reference to FIG. 6A, the electronic device 608 displays sketch 614a as shown in FIG. 6B which is the same sketch 614a illustrated in FIG. 6A. In some embodiments, initiating the process to generate the route in accordance with the second methodology includes the electronic device 608 selecting the route from the first respective location to the second respective location that satisfies one or more criteria, including a criterion that is satisfied based on a cost for the route. In some embodiments, the generated route is based on the one or more attributes of a movement portion of the gesture from the first location to the second location as described above and with reference to method(s) 900, 1000, and/or 1100. In some embodiments, the cost for the route is determined based on cost information associated with the one or more attributes of the movement portion of the gesture from the first location to the second location and map data for the map area.

For example, the electronic device 608 optionally considers both the sketch 614a of the gesture, such as the first location 622, the second location 624, and the one or more attributes of the movement portion of the gesture and map data for the map area 602a. FIG. 6B illustrates the electronic device generating the route 640 that includes the second segment 636b instead of the first segment 636a, as shown by map area 602c. In some embodiments, the electronic device 608 determines to include the second segment 636b based on cost information associated with the one or more attributes of the movement portion of the gesture and map data for the map area. For example, when determining the cost information associated with including the second segment 636a to the route 640, the electronic device 608 optionally uses map data-related cost information, such as traffic information, direction of travel, one or more road characteristics, such as road closures, or other map data related costs as described with reference to method(s) 1000 and/or 1100. Additionally or alternatively, in some embodiments, the electronic device 608 determines sketch-related cost information associated with the one or more attributes of the movement portion of the gesture. Sketch-related cost information optionally includes a determination whether the second segment 636b is within a predetermined distance (e.g., 0.3, 0.5, 1, 10, 20, 50, or 100 kilometers) from a respective location corresponding to the movement portion of the gesture (e.g., the sketch). In another example of sketch-related cost information, the electronic device 608 optionally determines whether the direction of travel along a pathway corresponding to second segment 636b aligns with the direction of travel of the movement portion of the gesture. In this case, the aggregated cost which includes the map data-related cost information and the sketch-related cost information associated with the second segment 636b is less than the aggregated cost associated with the first segment 636a, so the electronic device includes the second segment 636b in the route.

FIG. 6C illustrates the electronic device 608 initiating a process to generate the route from the first respective location to the second respective location in accordance with a third methodology, different from the first methodology and the second methodology, and as described in method 1100 and/or FIG. 8C. Referring to FIG. 6C, map area 602d shows a result of the process to generate the route according to the third methodology. Generating the route optionally includes displaying a representation of the generated route 650 via display component 610.

For example, in response to receiving the gesture as described with reference to FIG. 6A, the electronic device 608 displays sketch 614a as shown in FIG. 6B which is the same sketch 614a illustrated in FIG. 6A. In some embodiments, initiating the process to generate the route in accordance with the third methodology includes the electronic device 608 refining one or more waypoints until the route satisfies one or more criteria that are based on a cost for the route as described with reference to method 1100 and/or FIG. 8C. For example, FIG. 6C includes map area 602d that illustrates a result of the process to generate the route according to the third methodology.

In some embodiments, as described with reference to FIG. 6A, the electronic device 608 extracts/selects the first waypoint 630 and the second waypoint 632. In some embodiments, the electronic device 608 optionally refines the first waypoint 630 and/or the second waypoint 632. For example, the electronic device 608 optionally refines the first waypoint 630 and/or the second waypoint 632 by adding, removing, or changing the cost for the route, and/or the one or more constraints (e.g., waypoint constraint and/or cost constraint as described with reference to method(s) 1000 and/or 1100). In some embodiments, the electronic device 608 optionally refines the first waypoint 630 and/or the second waypoint 632 in response to the electronic device 608 receiving user input to add, remove, or change the cost for the route, and/or the one or more constraints. In some embodiments, the electronic device 608 continually refines the first waypoint 630 and/or the second waypoint 632 such that the cost for the route does not exceed a predetermined cost threshold as described in method(s) 1000 and/or 1100.

FIG. 6C illustrates the electronic device 608 changing a location of the second waypoint 632 from a first location as shown in FIG. 6B, map area 602c to a second location as shown in FIG. 6C, map area 602d. In some embodiments, the electronic device 608 determines that the second location of the second waypoint 632 is associated with a cost that is less than a cost associated with the first location of the second waypoint 632. For example, traveling to the second location of the second waypoint 632 optionally includes a parking lot, whereas traveling to the first location of the second waypoint 632 optionally does not include a parking lot and could therefore be inconvenient to the user of the electronic device. In another example, traveling to the second location of the second waypoint 632 optionally includes an electronic vehicle charging station, whereas traveling to the first location of the second waypoint 632 optionally does not include the electronic vehicle charging station. In this case, the electronic device refines route 650 to include a third segment 636c that includes the second location of the second waypoint 632.

In some embodiments, as a result of changing the location of the second waypoint 632, the electronic device 608 refines the segment of the route from the second location of the second waypoint 632 to the second location or second waypoint 628 as shown in FIG. 6C, map area 602d. For example, the electronic device 608 includes segment 638c which is different from segment 638b as shown in FIG. 6B, map area 602c that included the first location of the second waypoint 632. In some embodiments, including segment 638c does not exceed the predetermined cost threshold as described as described in method(s) 1000 and/or 1100. In some embodiments, the associated cost of the route 650 in FIG. 6C, map area 602d (e.g., including segments 636b, 636c, 638c, and waypoints 630 and 632 at their respective locations) is less that the cost of the route 640 in FIG. 6B, map area 602c (e.g., including segments 636b, 638a, and waypoints 630 and 632 at their respective locations).

FIGS. 7A-7M illustrate exemplary ways in which an electronic device generates a route that is based, at least in part, on one or more attributes of a movement portion of a received gesture and map data according to some embodiments of the disclosure. The embodiments in these figures are used to illustrate the processes described below, including the processes described with reference to FIGS. 6-7. Although FIGS. 7A-7M illustrate various examples of ways an electronic device is able to perform the processes described below with reference to FIGS. 6-7, it should be understood that these examples are not meant to be limiting, and the electronic device is able to perform one or more processes described below with reference to FIGS. 6-7 in ways not expressly described with reference to FIGS. 7A-7M.

FIG. 7A illustrates an electronic device 608 that has one or more of the characteristics of the electronic device 608 of FIGS. 6A-6C as described above. In FIG. 7A, the electronic device 608 displays, via display component 610, a map area 700 that has one or more of the characteristics of the map area 602a of FIG. 6A. As mentioned above with respect to FIGS. 6A-6C, the electronic device 608 generates a route that is based, at least in part, on one or more attributes of a movement portion of a received gesture and map data. For example, in FIG. 7A, the electronic device 608 detects pinch hand shape 704a (e.g., two or more fingers of a user's hand such as the thumb and index finger moving together and touching each other) followed by a pinch hand shape. In another example in FIG. 7A, the gesture is a tap input 706a (e.g., finger tap via display component 610) at a location of, on, or directed to a respective location of the map area 700. In yet another example, in FIG. 7A, the gesture includes a stylus input device 710a in communication with electronic device 608 and held by a hand 708a of the user of the electronic device 608. In some embodiments, the stylus input device 710a is in contact with the display component 610. In some embodiments, the stylus input device 710a is not directly in contact with the display component 610, such that the display component 610 is configured to detect the stylus input device 710a (e.g., via one or more motion vectors) which is mapped to the map area 700 for display via the display component 610 as will be discussed below. Although FIG. 7A illustrates various examples of gesture-based inputs the electronic device 608 is configured to receive, it should be understood that these examples are not meant to be limiting, and the electronic device is able to receive one or more other gesture-based inputs, attention-based inputs, and/or other user inputs for interaction with the map area 700 as described with reference to FIGS. 6A-6C, 7B-7M and 6-7 in ways not expressly described with reference to FIG. 7A.

In some embodiments, the electronic device 608 detects the gesture while attention (e.g., including gaze) of the user is optionally directed to the map area 700. Optionally, detecting the gesture includes detecting movement of a portion (e.g., a hand, arm, and/or finger) of the user from a first location to a second location while the user maintains a pinch hand shape. For example, in FIG. 7A, the electronic device 608 detects, via the one or more input devices (e.g., the plurality of image sensors 612), the attention 702 (e.g., including gaze) of the user of the electronic device 608 directed to the map area 700 while detecting the gesture that includes the pinch hand shape 704a. Thus, the pinch hand shape 704a is directed to the map area 700 based on the attention 702 of the user being directed to the map area 700. In some embodiments, the pinch hand shape 704a detected while detecting the attention 702 of the user directed to map area 700 corresponds to a request to generate a route starting from a first location of the map area 700. Optionally, the first location of the map area is a respective first location to which the attention 702 of the user is directed while the electronic device detects the pinch hand shape 704a. Thus, the electronic device 608 begins the route at the location at which the attention 702 of the user is directed at the start of the gesture. In some embodiments, in response to detecting the attention 702 of the user directed to the map area 700 while receiving the pinch hand shape 704a as described, the electronic device 608 initiates a process to generate a route from the first respective location. For example, in FIG. 7B, initiating the process to generate the route from the first respective location includes displaying, via the display component 610, a visual indication of the starting location 714 of the route determined based on the location of the attention 702 of the user when the electronic device detected the pinch hand shape 704a.

In some embodiments, the electronic device 608 detects the gesture including movement of the pinch hand shape 704a from a first location in the physical environment of the user, such as shown in FIG. 7A, to a second location in the physical environment, such as shown in FIG. 7B. In some embodiments, while detecting the gesture, the electronic device 608 displays a visual indication of the gesture. For example, in FIG. 7B, the electronic device 608 optionally displays a sketch 716 corresponding to the gesture. The sketch 716 starts at a first location 714 corresponding to the location of the attention 702 of the user when the electronic device detected the beginning of the pinch hand shape 704a as described above. The electronic device 608 continues to add to the sketch 716 in accordance with detecting continued movement of pinch hand shape 704a. Thus, the electronic device 608 displays the sketch 716 of the route with contours corresponding to contours of the movement of the pinch hand shape 704a.

In FIG. 7B, the electronic device 608 detects a speed at which the gesture moves from the first location to the second location in the physical space. The speed is shown by speed indicator 712b having a first speed. In some embodiments, while detecting the speed of the gesture, the electronic device 608 displays a visual indication of the speed. For example, in FIG. 7B, the electronic device 608 optionally displays sketch 716 with a first color, shading, and/or shape corresponding to the first speed of the movement portion of the gesture. Thus, the electronic device 608 displays the sketch 716 of the route with a coloring, shading, and/or shape corresponding to the speed of the movement of the pinch hand shape 704a.

In some embodiments, the electronic device 608 displays indications of one or more waypoints in response to (and/or while) receiving the movement portion of the gesture. In some embodiments, the electronic device 608 determines one or more waypoints significant to the area within the predetermined distance from the sketch 716 based on the detected movement portion of the gesture. For example, in FIG. 7C, the electronic device 608 displays, via display component 610, a visual indication of waypoint 720. In some embodiments, waypoint 720 is determined to be a significant waypoint because the user of the electronic device 608 was previously at the waypoint 720 for at least a threshold amount of time (e.g., 3 hours, 12 hours, 1 day, 1 week, or 3 weeks). In some embodiments, the electronic device 608 determines the waypoint 720 as significant based on satisfying one or more criteria as described with reference to method(s) 900, 1000, and/or 1100. Thus, the electronic device 608 displays indications of significant waypoints that are within a predetermined distance from the sketch 716.

In some embodiments, the electronic device 608 determines that the movement portion of the gesture includes a change in speed from the first speed as shown by speed indicator 712c to a second speed as shown by speed indicator 712d in FIG. 7D. The speed indicator 712d optionally indicates that the second speed is less than the first speed. In some embodiments, the electronic device 608 determines that the second speed is below a predetermined speed (e.g., 25, 50, 75, 100, 125, or 150 millimeters/second), and in response, the electronic device 608 infers that the slowed speed of the gesture indicates that the user would like to add one or more waypoints to the route at a respective location corresponding to the slower speed of movement. For example, the electronic device 608 optionally includes waypoint 720 corresponding to a location of the pinch hand shape 704a when the electronic device detected the slowed second speed of movement.

In some embodiments, the electronic device 608 determines that the movement portion of the gesture indicates selection of one or more waypoints of the map area. For example, in FIG. 7D, the electronic device 608 detects the gesture including movement of the pinch hand shape 704a in a circular movement 724. In some embodiments, while detecting the gesture, the electronic device 608 displays a visual indication of the gesture. For example, in FIG. 7D, the electronic device 608 optionally displays a sketch 722 corresponding to the circular movement of the pinch hand shape 704a. In some embodiments, the electronic device 608 infers that the circular movement of the gesture indicates that the user would like to add waypoint 720 to the route or another waypoint corresponding to a location of the pinch hand shape 704a when the electronic device detected the circular movement.

In some embodiments, the electronic device 608 continues to add to the sketch 716 in accordance with detecting continued movement of pinch hand shape 704a. For example, in FIG. 7E, the electronic device 608 detects the gesture including movement of the pinch hand shape 704a from a respective location of the pinch hand shape 704a when the electronic device detected the circular movement, such as shown in FIG. 7D, to a respective location in the physical environment, such as shown in FIG. 7E. In some embodiments, while detecting the gesture, the electronic device 608 displays a visual indication of the gesture. For example, in FIG. 7E, the electronic device 608 optionally displays a sketch 728 corresponding to the gesture.

In some embodiments, the electronic device 608 determines that the speed at which the gesture is performed by the user is below the predetermined speed as described above and as shown by speed indicator 712e. In some embodiments, in response to determining that the speed is below the predetermined speed, the electronic device 608 infers that the slowed speed of the gesture indicates that the user would like to add one or more waypoints to the route. For example, the electronic device 608 optionally includes a waypoint corresponding to a location of the pinch hand shape 704a when the electronic device 608 detected the slowed speed of movement.

In some embodiments, the electronic device 608 determines a cost associated with adding a particular waypoint and/or a route segment to the route. In some embodiments, and as described above, the electronic device 608 adds particular waypoints and/or route segments based on the movement portion of the gesture. In some embodiments, the electronic device 608 presents an indication of the cost associated with modifying a route. In some embodiments, the electronic device 608 presents the indication of the cost while detecting the gesture. For example, in FIG. 7F, the electronic device 608 presents a notification 732 that a respective cost for adding a respective waypoint and/or route segment corresponding to the movement portion of the pinch hand shape 704a exceeds a predetermined cost threshold as described in method(s) 1000 and/or 1100.

In some embodiments, the electronic device 608 determines that the gesture includes a hand shape, different from the pinch hand shape 704a. For example, in FIG. 7G, the electronic device 608 determines that a plurality of (e.g., all) the fingers of the hand 704g are pointed towards the map area 700. In some embodiments, in response to determining that the plurality of fingers of the hand 704g are pointed towards the map area, the electronic device 608 includes one or more waypoints corresponding to the location to which the electronic device 608 detects that the fingers of the hand 704g are pointing. In some embodiments, the electronic device 608 detects the gaze 734 of the user directed to the location of the map area 700 while detecting the fingers of the hand 704g pointed towards the map area. In some embodiments, in response to determining that the gaze 734 of the user is directed to the location for greater than a time threshold (e.g., 0.02, 0.05, 0.1, 0.2, 0.25, 0.3, 0.5, 1, 2, 3, or 5 seconds) while detecting the plurality of fingers of the hand 704g are pointed towards the map area 700, the electronic device 608 includes one or more waypoints from a respective location corresponding to the location at which the electronic device 608 detects the gaze 734.

In some embodiments, the electronic device 608 determines that the one or more waypoints to be added to the route in response to the input are not accessible via first mode of transportation (e.g., driving). For example, in FIG. 7H, the electronic device 608 determines adding waypoint 736 corresponding to the location at which the electronic device 608 detects the gaze 734 of the user is not traversable via a driving mode of transportation, and in response, the electronic device 608 presents a notification 740a. In FIG. 7H, the notification 740a includes content indicating to the user that no route segments are available via a driving mode of transportation to the waypoint 736, and presents an option to change the mode of transportation to walking. In some embodiments, the notification 740a includes an option 740b that, when selected, causes the electronic device 608 to include a segment of the route navigating to the waypoint 736 via the walking mode of transportation; or an option 740c that, when selected, causes the electronic device 608 to forego adding waypoint 736.

In some embodiments, the electronic device 608 determines that the gesture includes a hand position that is not directed to the map area 700 (e.g., hand is located below the user's waist, away from the map area 700) to indicate the end of the sketching process, such as shown by hand 704i. In response to the electronic device 608 determining that the gesture indicates the end of the sketching process, the electronic device 608 initiates the process to generate a route based on the sketch 744. In some embodiments, while generating the route, the electronic device 608 displays an indication 742 that the electronic device 608 is generating the route. In some embodiments, the electronic device 608 converts the sketch 744 into a computerized geometric-based shape. For example, converting the sketch 744 optionally includes displaying an animated transition between the sketch 744 and a representation of the generated route 746 shown in FIG. 7J. For example, the animated transition optionally includes ceasing display of the sketch 744 and/or displaying the sketch 744 that is being converted with a lesser degree of prominence relative to the sketch 716 displayed during the sketching process.

In FIG. 7J, the electronic device 608 displays a representation of the generated route 746 overlaid on the map area 700 starting at a first location 714 corresponding to the first location at which the sketch route starts and ending at waypoint 736 corresponding to the second location at which the sketch route ends. Route 746 is optionally generated according to the first, second, and/or third methodologies described herein. In FIG. 7J, route 746 is based on sketch 716 as described above. In some embodiments, the electronic device 608 displays, concurrently with and/or overlaid on route 746, user interface elements that, when selected cause the electronic device 608 to perform an action related to route 746 as described below. In some embodiments, the electronic device 608 displays content including information about the route 746 and/or one or more representations of waypoints included in the route 746. For example, in FIG. 7J, the electronic device 608 displays an indication 752b that route segment 786 is not traversable due to being temporarily or permanently closed. In another example, the electronic device 608 displays an indication 754a that route segment 788 is not traversable due to construction on the route segment 788. In some embodiments, indication 752b and indication 754a are based on real-time data retrieved by the electronic device 608 from a remote server as described with reference to method 500. Thus, the electronic device 608 displays notifications of routing events (e.g., road closures, delays, construction, traffic, and/or the like) based on real-time data affecting the generation of route 746.

In some embodiments, the electronic device 608 displays indications and/or representations of significant roadways, highways, and/or waypoints along route 746. For example, in FIG. 7J, the electronic device 608 displays an indication 758 of major “highway 101”. In another example, the electronic device 608 displays a representation of the significant waypoint 720 described above. In some embodiments, the electronic device 608 displays representations of waypoints to navigate past without stopping and waypoints that are stops along the generated route. For example, the electronic device 608 displays representation of a waypoint 748 to move past (e.g., not identified by the electronic device 608 as a stopping point along route 746). In another example, the electronic device 608 displays representation 750 of a waypoint that is a stopping point along route 746. In some embodiments, the respective waypoints associated with 748 and 750 are based on a user gesture as discussed with reference to FIGS. 7C-7D. Thus, the electronic device 608 displays representations of waypoints included in the route 746.

In some embodiments, a cost of travel, such as the amount of fuel or battery power available to travel along route 746 including particular route segments is considered when generating route 746. For example, in FIG. 7J, the electronic device 608 includes route segment 754b as an alternative route to route segment 788 because route segment 788 is not traversable due to construction on route segment 788. The electronic device 608 determines that inclusion of route segment 754b will drain the fuel available to travel the remaining portions of route 746. As such, the electronic device 608 adds a waypoint to refuel as shown by representation 756. Thus, the electronic device 608 identifies one or more waypoints to be added to route 746 based on traversal costs associated with taking particular route segments.

In some embodiments, the electronic device 608 determines that a particular route segment, such a route segment 760a, corresponding to a movement portion of the gesture as described above cannot be traversed via a current mode of transportation (e.g., driving). As such, the electronic device 608 displays an indication that route segment 760a is not traversable via the current mode of transportation, such as shown by indication 762 in FIG. 7J. In some embodiments, the electronic device 608 includes route segment 760b requiring a mode of transportation, different from the current mode of transportation as an alternative route to route segment 760a. For example, in FIG. 7J, the electronic device 608 displays an indication 764 of the change of the mode of transportation. As such, the electronic device 608 determines that the route segment 760b associated with a walking mode of transportation is more optimal to reach waypoint 736 than route segment 760a according to the driving mode of transportation.

In some embodiments, the electronic device 608 displays a user interface element 766 that, when selected, causes the electronic device to modify the generated route, such as to add, remove, and/or change a waypoint. For example, in FIG. 7J, the electronic device 608 detects a gesture while attention 768 of the user is optionally directed to the map area 700. Optionally, the gesture includes: a pinch hand shape 704j; a tap input 706j at a location of, on, or directed to user interface element 766; or a stylus input device 710j in communication with electronic device 608 and held by a hand 708j of the user of the electronic device 608. In some embodiments, the electronic device 608 determines that the gesture while attention 768 is directed to user interface element 766 is indicative of a request by the user to add a waypoint. For example, in FIG. 7K, the electronic device 608 determines that the gesture includes a movement portion (e.g., movement of the pinch hand shape 704k in a circular movement 770) indicative of adding a waypoint at a respective location of the map area 700 corresponding to the location of the attention 768 of the user as shown in FIG. 7K. Optionally, while detecting the gesture, the electronic device 608 receives a voice input 772 corresponding to a request to add a waypoint, and in response, the electronic device 608 displays waypoint 774 at a location of the map area 700 corresponding to the location of the attention 768 of the user when the electronic device 608 detected the pinch hand shape 704k and/or the voice input 772.

In some embodiments, after adding waypoint 774, the electronic device modifies the generated route 746 to include waypoint 774 as a stop. For example, in FIG. 7L, the electronic device 608 changes route 746 to include route segment 776b instead of route segment 776a because route segment 776b includes waypoint 774. In some embodiments, the electronic device 608 determines that inclusion of route segment 776b will drain the fuel available to travel the remaining portions of route 746. As such, the electronic device 608 adds route segment 778 which includes a waypoint to refuel as shown by representation 780. Thus, the electronic device 608 modifies route 746 in response to user input to modify the route.

In some embodiments, the electronic device 608 initiates a process to share route 746 to a second electronic device, different from the electronic device 608. For example, in FIG. 7M, the electronic device 608 detects a gesture including a pinch hand shape 704m while attention 784 of the user is directed to user interface element 766. In some embodiments, the electronic device 608 determines that the gesture (while attention 784 is directed to user interface element 766) is indicative of a request to share route 746 to a second electronic device, different from electronic device 608. For example, in response to the request, the electronic device 608 displays user interface element 782 including a listing of users and/or electronic devices (e.g., representations 782b, 782c, and 782d) selectable to transmit the route 746 to those selected users and/or electronic devices. In FIG. 7M, the electronic device 608 initiates a process to share the route 746 with users and/or electronic devices corresponding to representations 782b and 782c and forgoes initiating the process to share the route 746 to the respective user/electronic device corresponding to representation 782d. Thus, the electronic device 608 provides the ability to share the generated route 746 to users and/or electronic devices different from electronic device 608.

FIGS. 8A-8C illustrate schematic block diagrams of circuitry that can be included in the electronic device according to some embodiments of the disclosure. In some embodiments, the electronic device performs the functions of the circuitry described with reference to FIGS. 8A-8C. As used herein the circuitry includes hardware, software, and/or firmware configured to perform one or more particular functions.

In some embodiments, the electronic device supports multiple methodologies including the first, second, and third methodologies described above with reference to FIGS. 6A-6C. For example, FIG. 8A illustrates system 800a that performs the first methodology including the circuitry and modules that are included in the electronic device (e.g., electronic device 608 in FIG. 6A) and/or in communication with the electronic device. In some embodiments, system 800a includes hardware and/or software instructions to perform the one or more methods or processes, such as described with reference to FIGS. 9-11. In some embodiments, the system 800a includes processing circuitry (e.g., sketch processing circuitry 806, constraint processing circuitry 810, and route processing circuitry 816). In some embodiments, the processing circuitry can include one or more processors (e.g., processor 103 in FIG. 1). One or more of the processors optionally include a digital signal processor (DSP), a microprocessor, a central processing unit (CPU), a programmable logic device (PLD), a field programmable logic array (FPGA), a graphical processing unit (GPU), and/or the like. In some embodiments, the processing circuitry is configured to support a plurality of communication interfaces (e.g., graphical user interfaces and/or input interfaces) operating on the electronic device. In some embodiments, one processor, such as processor 103 in FIG. 1 includes the processing circuitry (e.g., sketch processing circuitry 806, constraint processing circuitry 810, and route processing circuitry 816) in FIG. 8A.

Alternatively, and in some embodiments, the processor 103 including the processing circuitry includes software configured to perform one or more particular functions as described with reference to method(s) 900, 1000, and/or 1100. In this regard, processing circuitry as described herein may be embodied as, for example, circuitry, hardware elements (e.g., a suitably programmed processor, combinational logic circuit, and/or the like), non-transitory computer readable storage medium (e.g., memory(ies) 107 in FIG. 1) that is executable by a suitably configured processing device (e.g., processor 103 in FIG. 1), or some combination thereof. In some embodiments, whether configured by hardware, firmware/software methods, or by a combination thereof, processor 103 may comprise an entity capable of performing operations according to embodiments of the present disclosure while configured accordingly. For example, when processor 103 is embodied as an executor of instructions, such as may be stored in memory(ies) 107, the instructions may specifically configure processor 103 to perform one or more methodologies, algorithms and operations described herein, such as those discussed in with reference to FIGS. 9-11.

In some embodiments, system 800a is an electronic device as described with reference to method 500 (e.g., electronic device 608 in FIG. 6A). In some embodiments, the electronic device includes and/or is in communication with input device 802. In some embodiments, the electronic device detects a gesture (as described above) using input device 802. In some embodiments, input device 802 is capable of receiving user input (e.g., capturing a user input and/or detecting a user input) and transmitting information associated with the user input to the electronic device. For example, the electronic device optionally detects a gesture from input device 802 and processes the one or more attributes of the movement portion of the gesture to produce a sketch 804 (e.g., 614a of FIG. 6A).

In some embodiments, the electronic device will determine one or more sketch attributes 808 based on the sketch 804 using sketch processing circuitry 806. The sketch attributes 808 optionally include a location of the sketch (or portion of the sketch) relative to a candidate route segment and/or a significant waypoint. Other sketch attributes are described with reference to method(s) 900, 1000, and/or 1100. In some embodiments, the sketch attributes 808 and map data 838 are input into constraint processing circuitry 810 to identify the waypoint constraints 814. The waypoints constraints 814 optionally indicate particular route segments and/or waypoints to be included in the route. In some embodiments, the waypoint constraints 814 indicate particular route segments and/or waypoints that should not be used for generating the route.

In some embodiments, map database 812 provides map data 838 including information related to route data traveled by a user account of the electronic device; favorite or preferred waypoints and/or route segments of the user account identified by the electronic device as a favorite by the user account or set via user route specification; and/or historical data, such as route segments, roadways, or waypoints the user account previously visited or viewed. In some embodiments, the constraint processing circuitry 810 requests map data 838 from a server (e.g., map engine) in communication with the electronic device. For example, map database 812 is optionally stored using a server and/or stored as a part of and/or in communication with the electronic device. In some embodiments, communication with map database 812 and/or any server or module executing outside of the electronic device is optionally provided via application programming interface (APIs) provided by the electronic device operating system. For example, the electronic device optionally receives a query for map data, and in response to the query, the electronic device locates related map data that match the query from map database 812. In some embodiments, the constraint processing circuitry 810 utilizes the map data 838 for identifying the waypoint constraints 814 including evaluating real-time map data, such as streets, highways, freeways, other roadways, waypoints, traffic conditions, weather conditions, subway or metro segments and/or the like of the map area corresponding to the sketch attributes 808.

In some embodiments, route processing circuitry 816 applies the waypoint constraints 814 to generate route 818. For example, a waypoint constraint optionally identifies a first waypoint and a second waypoint for the generated route as described and illustrated with reference to FIG. 6A and FIGS. 7A-7M. In some embodiments, the route processing circuitry 816 selects a route segment between the first waypoint and the second waypoint considered to be an optimal path between the first waypoint and the second waypoint based on map data 840. In some embodiments, map data 840 includes different information from map data 838. For example, map data 840 optionally includes a cost associated with traveling along the selected route segment.

FIG. 8B illustrates system 800b that performs the second methodology including the same circuitry and modules that are included with system 800a described with reference to FIG. 8A. In some embodiments, the electronic device includes cost function 822 component. In some embodiments, the cost function 822 component has one or more of the processors and/or characteristics of the processing circuitry described above. In some embodiments, the cost function 822 component includes hardware and/or software instructions (e.g., as described above) to perform the one or more methods or processes, such as described with reference to FIGS. 9-11. In some embodiments, the cost function 822 component resides on the electronic device or resides on a different computer system (e.g., server) in communication with the electronic device. In some embodiments, the cost function 822 component does not apply the waypoint constraints 814 in the manner described with reference to FIG. 8A. For example, the cost function 822 component applies the waypoint constraints 814 differently from the approach described in FIG. 8A. In some embodiments, the cost function 822 component identifies a number of candidate waypoints that are evaluated based on a cost analysis as described with reference to method 1000. In some embodiments, the cost function 822 component presents cost information for display by the electronic device as cost function layers 824 as described in more detail with reference to method 1100. For example, a first layer of the map area of the generated route 820 optionally includes roadways, parks, bodies of water, and/or points of interest, a second layer of the map area optionally includes the indication of the cost for the route, and a third layer of the map area optionally includes traffic information. In some embodiments, the third layer of the map area that includes traffic information optionally includes sub-layers for current, real-time traffic information and/or predicted traffic information.

FIG. 8C illustrates system 800c that performs the third methodology including the same circuitry and modules that are included with the system 800a described with reference to FIG. 8A and the system 800c described with reference to FIG. 8C. Similar to the function of the constraint processing circuitry 810 described above with reference to FIG. 8A, the constraint processing circuitry 810 of the third system 800c identifies waypoint constraints 832 based on sketch attributes 826a and map data 838. In some embodiments, the waypoint constraints 832 continuously evolve (e.g., based at least in part on route refinement processes 830a and 830b). In some embodiments, the route refinement processes 830a and 830b consider cost function layers 834 output by the cost function 822 module as described with reference to FIG. 8B. In some embodiments, the cost function 822 module includes one or more characteristics as the cost function 822 component in FIG. 8A. In some embodiments, the cost function 822 module also considers the sketch attributes 826b. For example, when the cost function 822 module determines that the waypoints and/or route segments are refined in such a way in which they deviate from the original, identified waypoint constraints 832, the cost function 822 module optionally sets a higher respective cost of the refined waypoints. In some embodiments, the higher respective cost of the refined waypoints is considered in addition to other respective costs of other candidate waypoints described with reference to method 1100 when generating the final route 836.

FIGS. 9-11 are flow diagrams illustrating methods for generating a route that is based on the gesture and map data in accordance with some embodiments.

In some embodiments, method 900 is performed at an electronic device (e.g., electronic device 608 in FIG. 6A) in communication with one or more input devices and a display component (e.g., display component 610 in FIG. 6A). For example, the electronic device is a mobile device (e.g., a tablet, a smartphone, a media player, or a wearable device), a computer (e.g., a desktop computer, a laptop computer), or a wearable device (e.g., a watch, a head-mounted device), optionally in communication with one or more of a mouse (e.g., external), trackpad (optionally integrated or external), remote control device (e.g., external), another mobile device (e.g., separate from the first electronic device), a handheld device (e.g., external), and/or a controller (e.g., external), a set-top box in communication with one or more input devices (e.g., a remote control), or an in-vehicle computer (e.g. vehicle on-board computer, vehicle information and entertainment system or infotainment system). In some embodiments, the display component is a display integrated with the electronic device (optionally a touch screen display), external display such as a monitor, projector, television, or a hardware component (optionally integrated or external) for projecting a user interface or causing a user interface to be visible to one or more users. In some embodiments, the display component is a display integrated with (optionally one or more exterior windows or windshields of) a vehicle (e.g., car, bus, truck, airplane, train, boat, or other vehicle configured for transportation of a user), a house, store, or other building for projecting a user interface or causing a user interface to be visible to one or more users. In some embodiments, the one or more input devices include a computer system or component capable of receiving a user input (e.g., capturing a user input and/or detecting a user input) and transmitting information associated with the user input to the electronic device. Examples of input devices include physical buttons, knobs, handles, and/or switches of the electronic device or a platform (as described herein), a touch screen, mouse (e.g., external), trackpad (optionally integrated or external), touchpad (optionally integrated or external), microphone for capturing voice commands or other audio input, remote control device (e.g., external), another electronic device (e.g., mobile device that is separate from the electronic device), a handheld device (e.g., external), a controller (e.g., external), a camera, a depth sensor, an eye tracking device, and/or a motion sensor (e.g., a hand tracking device, a hand motion sensor). In some embodiments, the electronic device is in communication with a platform. In some embodiments, the platform is a vehicle (e.g., car, bus, truck, airplane, train, boat, or other vehicle configured for transportation of a user), a house, store, or other building. In some embodiments, the electronic device is in communication with the platform using wired or wireless communication. In some embodiments, the electronic device is located in the platform. In some embodiments, method 900 is performed at or by a vehicle (e.g., at a multi-display system and/or an infotainment system of an automobile having or in communication with one or more display components and/or one or more input devices as described herein).

In some embodiments, while displaying, via the display component, a map area, the electronic device receives (902a) via the one or more input devices, a gesture (e.g., a gesture including pinch hand shape 704a in FIG. 7A) starting from a first location of the map area (e.g., a location of map area 700 corresponding to a respective location of attention 702) to a second location of the map area (e.g., a location of map area 700 corresponding to a respective location of attention 620 in FIG. 7G) corresponding to a request to generate a route from a first respective location to a second respective location. In some embodiments, the electronic device displays the map area in a three-dimensional environment. For example, the three-dimensional environment is optionally generated, displayed, or otherwise caused to be viewable by the electronic device. In some embodiments, the three-dimensional environment is an extended reality (XR) environment such as a virtual reality (VR) environment, a mixed reality (MR) environment, or an augmented reality (AR) environment. In some embodiments, a physical environment surrounding the display component is visible through a transparent portion of the display component (e.g., true or real passthrough). In some embodiments, a representation of the physical environment is displayed in the three-dimensional environment via the display component (e.g., virtual or video passthrough).

In some embodiments, the electronic device displays the map area at respective location in the three-dimensional environment that is in the field of view of a user of the electronic device from a viewpoint of the user of the three-dimensional environment. In some embodiments, the map area is a user interface element displayed in the three-dimensional environment including a plurality of content and/or other user interface elements as described herein. In some embodiments, the map area is a user interface element of an application, such as a mapping application or an application other than the mapping application, such as a platform control application. In some embodiments, the map area represents a geographic area or another type of area other than a geographic area, such as a topographic area or a nautical area. In some embodiments, the map area is a planar object, similar to a drawing board, and facing the user, such that a front-facing surface of the planar object faces toward the viewpoint of the user. In some embodiments, the map area is a three-dimensional object. In some embodiments, the three-dimensional object is similar to a topographical map of a geographic area including three-dimensional representations of buildings, streets, and other landmarks. In some embodiments, the map area displayed via the display component is presented for display on a touch screen of a display component of a vehicle to which the electronic device is connected (e.g., via a wired or wireless connection). In some embodiments, the electronic device displays the map area via the display component (e.g., touch screen) of the electronic device. In some embodiments, the gesture starting from a first location of the map area to a second location of the map area is an input interacting with the map area that is performed by one or more hands of the user, a movement of the one or more hands of the user, a gaze by the user at a respective location, a voice command, another input device (e.g., stylus input or mouse based input) and/or the like. For example, the electronic device optionally receives, via one or more sensors of the electronic device (e.g., image sensors, tracking sensors, depth sensors, orientation sensors, location sensors, and/or any of the sensors described above), an air pinch gesture (e.g., two or more fingers of a user's hand such as the thumb and index finger moving together and touching each other) to form a pinch hand shape while attention (e.g., including gaze) of the user is optionally directed to the map area, and while maintaining the pinch gesture, the electronic device receives movement of a portion (e.g., a hand, arm, and/or finger) of the user from a first location to a second location.

In some embodiments, the electronic device displays the map area including an indication of the starting location of the air pinch gesture (e.g., first location). In some embodiments, the electronic device receives the starting location of the air pinch gesture followed by movement of the air pinch gesture relative to the map area and while receiving movement of the air pinch gesture relative to the map area, the electronic device receives an end of the gesture (e.g., release of the air pinch gesture). In some embodiments, the electronic device displays the map area including an indication of a location (e.g., second location) at which the end of the gesture is received. In some embodiments, in response to receiving the air pinch gesture, the electronic device displays, via the display component, the map area including a sketch of a line (e.g., overlaid on the map area) corresponding to the first location and the second location at which the gesture is received and/or a trajectory of motion included in the gesture. In some embodiments, displaying the sketch of the line provides a visual indication of the requested route from the first location to the second location. It is understood that although the embodiments described herein are directed to an air pinch gesture, any number of user inputs are optionally applied, such as a gesture that corresponds to the request to generate a route from the first respective location to the second respective location, different from the air pinch gesture. In another example, the user inputs optionally include a click and drag input, (e.g., via a mouse, trackpad, or another electronic device or computer system in communication with the electronic device), actuation of a physical input device, and/or a voice input from the user corresponding to the request to generate a route starting from the first respective location of the map area to the second respective location of the map area.

In some embodiments, the electronic device receives a user input or gesture directed to the second location, and in response, the electronic device generates the route from the first respective location of the map area to the second location of the map area. In some embodiments, the first respective location is a current location of the electronic device. In some embodiments, the first respective location is a location other than the current location of the electronic device selected by the user of the electronic device. In some embodiments, the electronic device receives a predefined gesture for selecting the first location and/or the second location. For example, the predefined gesture optionally includes one or more fingers up gesture or pointing gesture. In some embodiments, while maintaining the one or more fingers up gesture or pointing gesture, the electronic device receives a circular movement corresponding to selection of the first location and/or second location. In some embodiments, the electronic device receives a tap input (e.g., finger tap via touch-sensitive display) at a location of, on, or directed to the second location and in response, the electronic device generates the route from the first respective location to the second respective location. In some embodiments, the electronic device receives a tap and drag input via the touch-sensitive display and in response to a lift-off the tap and drag input, the electronic device generates the route from the first respective location corresponding to the location of the tap input (e.g., the location of touchdown of the input) to the second respective location corresponding to the location of the lift-off the tap and drag input. In some embodiments, the electronic device considers one or more attributes of the received gesture in generating the route from the first respective location to the second respective location as will be described in more detail below.

In some embodiments, in response to receiving the gesture starting from the first location of the map area to the second location of the map area, the electronic device initiates (902b) a process to generate the route from the first respective location to the second respective location, such as the process to generate route 634 illustrated in FIG. 6A. In some embodiments, and as will be described below, the electronic device initiates a process to generate the route from the first respective location to the second respective location and displays the map area including a representation of the generated route. In some embodiments, the gesture is received at the electronic device. In some embodiments, the gesture is received at a second electronic device, different from the electronic device, and in communication with the electronic device. For example, the second electronic device is optionally any of the devices external to the electronic device described above with reference to method 900. In some embodiments, initiating the process to generate the route includes transmitting information about the gesture (e.g., the first location, the second location, a movement portion of the gesture, and/or the like) to a remote server in communication with the electronic device and/or a local processor (e.g., maintained by the electronic device optionally from a map application operating on the electronic device) for processing, computing, generating, and/or refining the route. In some embodiments, the electronic device ceases to display the sketch of the line and displays the representation of the generated route as described in more detail below. In some embodiments, the area between the first location and the second location defines the route such that a portion of the map area corresponding to the area between the first location and the second location is selected for consideration when generating the route from the first respective location to the second respective location (e.g., selected in response to detecting the termination of the pinch gesture, such as release of the pinch hand shape). In some embodiments, the portion of the map area that is selected includes an initial line (or curve, polylines, or one or more segments) between the first location and the second location. In some embodiments, the electronic device uses a midpoint of the line as a center of a circle to define a radius so that the circle encompasses the first location and second location. In some embodiments and as will be described in more detail below, the route generated by the electronic device is within the radius of a respective location corresponding to the center of the circle. In some embodiments, the starting location of the gesture is the same as (or corresponds to) the first respective location of the generated route. In some embodiments, the starting location of the gesture is different from (or does not correspond to) the first respective location of the generated route in accordance with one or more constraints as described herein and below. In some embodiments, the ending location of the gesture is the same as (or corresponds to) the second respective location of the generated route. In some embodiments, the ending location of the gesture is different from (or does not correspond to) the second respective location of the generated route in accordance with one or more constraints as described herein and below.

In some embodiments, generating the route includes extracting a first waypoint for the route (e.g., first waypoint 630 in FIG. 6A) and a second waypoint (e.g., second waypoint 632 in FIG. 6A) for the route based on one or more attributes of a movement portion of the gesture from the first location to the second location (902c), such as extracting the first waypoint 630 at a location of the map area 602b corresponding to the corner location 648 of the sketch 614a as shown in FIG. 6A. In some embodiments, the one or more attributes of the movement portion of the gesture include the first location and the second location as described above. For example, the movement portion of the gesture optionally includes determining speed, direction, and/or acceleration (e.g., change in speed and/or direction) of the gesture. In some embodiments, the first waypoint and the second waypoint are points on the route from the first location to the second location where a direction of travel, mode of transportation, roadway changes, and/or an intermediate location on the route or straightaway. In some embodiments, the electronic device extracts the first waypoint and the second waypoint within the circle that encompasses the first location and second location as described above. In some embodiments, the electronic device considers one or more additional attributes when extracting waypoints as described below. For example, the one or more attributes of the movement portion of the gesture optionally include a speed of the movement of the portion of the user input (e.g., air pinch gesture) from the first location to the second location as will be described in more detail below. In some embodiments, the one or more attributes of the movement portion of the gesture include characteristics of the sketch of the line described above. For example, the characteristics of the sketch of the line optionally include presence of sharp corners indicative of a request to include a precise location corresponding to the sharp corner. Other characteristics of the sketch of the line are described below. In another example, the one or more attributes of movement portion of the gesture correspond to locations on the map area between the first waypoint and the second waypoint.

In some embodiments, generating the route includes selecting a segment of the route between the first waypoint and the second waypoint independent from the one or more attributes of the movement portion of the gesture corresponding to locations on the map area between the first waypoint and the second waypoint (902d), such as the electronic device selecting a first segment 636a for inclusion in the route despite a second segment 636b located within a predetermined distance from the sketch 614a in FIG. 6A.

In some embodiments, the selected segment satisfies one or more criteria, including a criterion that is satisfied when the segment corresponds to a path between the first waypoint and the second waypoint (e.g., an optimal path between the first and second waypoints) that is based on map data for the map area, such as the electronic device determining that the first segment 636a as the optimal segment based on map data in FIG. 6A. For example, the electronic device optionally requests map data from a server (e.g., map engine) in communication with the electronic device and/or the local processor of the electronic device as described above. In some embodiments, the electronic device utilizes the map data for generating the route including evaluating data, such as streets, highways, freeways, other roadways, waypoints, and/or the like of the map area. In some embodiments, the map data includes information related to route data traveled by a user account of the electronic device; favorite or preferred roadways or locations of the user account identified by the electronic device as a favorite by the user account or set via user route specification; and/or historical data, such route segments, roadways, or waypoints the user account previously visited or viewed. In some embodiments, the first waypoint and the second waypoint are waypoint constraints. For example, the electronic device optionally constrains proposed segments to segments including (e.g., passing through or passing by) the first waypoint and the second waypoint. In some embodiments, a waypoint constraint indicates a particular roadway or type of roadway used for generating the route. In some embodiments, the waypoint constraint indicates that the particular roadway or the type of roadway should not be used for generating the route. In some embodiments, the electronic device selects the segment of the route between the first waypoint and the second waypoint by applying such waypoint constraints. In some embodiments, when the electronic device determines that a second segment, different from the segment described above, satisfies the one or more criteria, the electronic device selects the second segment instead of the first segment. In some embodiments, the electronic device utilizes an optimal path criterion for determining the selected route. The optimal path criterion is optionally expressed in terms of costs related to traveling from the first waypoint to the second waypoint. For example, the costs considered for selecting the segment of the route between the first waypoint and the second waypoint is optionally distance-based, time-based, a combination of distance and time, or multi-factor based as will be described in more detail below.

In some embodiments, the electronic device determines the optimal path between the first waypoint and the second waypoint independent from the one or more attributes of the movement portion of the gesture corresponding to locations on the map area between the first waypoint and the second waypoint and instead, is dependent on the first waypoint and the second waypoint. For example, the one or more attributes of the movement portion of the gesture corresponding to locations on the map area between the first waypoint and the second waypoint optionally include deviations or unexpected locations from the requested route from the first location to the second location. Deviations optionally include changes in travel direction and/or roadways or locations that are not reachable or do not follow rules. Generating a route from a first respective location to a second respective location in response to receiving a gesture starting from a first location of the map area to a second location of the map area enables a user a faster means for generating the route efficiently via a quick sketch, thereby reducing the need for subsequent inputs from a user to precisely select particular roadways and/or waypoints when immediate routing guidance is desired, which reduces power usage and improves battery life of the electronic device by enabling the user to use the electronic device more quickly and efficiently.

In some embodiments, in response to receiving the gesture starting from the first location of the map area to the second location of the map area (e.g., as described above with reference to method 900), the electronic device displays, via the display component, the map area including a sketch corresponding to the first location and the second location at which the gesture is received, such as sketch 716 in FIG. 7H. For example, the sketch optionally includes a drawing (e.g., hand drawn line or other shape) optionally overlaid on the map area starting at a third location of the map area corresponding to the first location at which the gesture starts and ending at a fourth location of the map area corresponding to the second location at which the gesture ends. In some embodiments, the sketch corresponds to a trajectory of motion included in the gesture (e.g., the movement portion of the gesture) as described above with reference to method 900. In some embodiments, the sketch includes one or more first visual characteristics, such as a first degree of transparency, a first size, a first brightness, and/or a first color.

In some embodiments, after displaying the sketch, the electronic device displays an animated transition from displaying the sketch to displaying a representation of the generated route, such as the animated transition described with reference to the sketch 744 in FIG. 7I. For example, the electronic device optionally replaces the sketch with the representation of the generated route (e.g., ceases display of the sketch). In some embodiments, the electronic device displays the representation of the generated route concurrently with and/or overlaid on the sketch. In some embodiments, the electronic device converts the sketch into a computerized geometric-based shape. In some embodiments, converting the sketch includes removing (e.g., ceasing display of) the sketch that is being converted. In some embodiments, the representation of the generated route includes one or more second visual characteristics, different from the one or more first visual characteristics associated with the sketch. For example, the representation of the generated route optionally includes a second degree of transparency optionally such that the representation of the generated route appears more (or less) opaque relative to the first degree of transparency associated with the sketch. In another example, the representation of the generated route includes a second color and/or brightness such that the representation of the generated route optionally appears more (or less) emphasized relative to the first color and/or brightness associated with the sketch. In another example, the representation of the generated route includes a second profile, second shape, second path that is different from the first profile, first shape, and/or first path of the sketch. In some embodiments, the electronic device displays the animated transition in which a visual characteristic of the sketch is gradually changed (e.g., morphing) to reveal or display the representation of the generated route. In some embodiments, the electronic device presents a user interface for modifying the sketch and/or the generated route as will be described in more detail below. Displaying an animated transition from displaying the sketch to displaying a representation of the generated route provides visual feedback indicative of generating the route, which simplifies the interaction between the user and the electronic device and enhances the operability of the electronic device, and indicates to the user an ability to enter a sketch that will be converted into a route quickly and efficiently.

In some embodiments, in response to receiving the gesture starting from the first location of the map area to the second location of the map area (e.g., as described above with reference to method 900), displaying, via the display component, a representation of the generated route (e.g., as described above with reference to displaying a representation of the generated route), such as the generated route 746 in FIG. 7J.

In some embodiments, the electronic device displays a user interface element that, when selected, causes the electronic device to change the first waypoint or the second waypoint, such as user interface element 766 in FIG. 7J. In some embodiments, the user interface element is a user interface element for receiving one or more user inputs as described above with reference to method 900, such as a tap input directed to the first waypoint or the second waypoint to remove the respective waypoint. In some embodiments, the electronic device receives a selection, drag, and release input (e.g., via a motion tracking device, a mouse, trackpad, stylus or another electronic device in communication with the electronic device) corresponding to a request to select the first waypoint and/or the second waypoint and move the first waypoint and the second waypoint to a different location of the map area. In another example, the electronic device receives one or more inputs corresponding to a request to reorder multiple waypoints relative to each other. For example, while the electronic device presents a route from the first waypoint to the second waypoint, the electronic device optionally receives a request to reorder the first waypoint or the second waypoint such that the route is from the second waypoint to the first waypoint. In some embodiments, the electronic device displays the user interface element after and/or while displaying the representation of the generated route. In some embodiments, the electronic device initiates display of the user interface element after initiating display of the representation of the generated route optionally while maintaining display of the representation of the generated route. In some embodiments, the electronic device displays the user interface element before displaying the representation of the generated route such that a user of the electronic device is presented with user interface element for changing the first waypoint or the second waypoint before the electronic device displays the representation of the generated route via the display component. In some embodiments, the user interface element is a user interface element of the mapping application or an application other than the mapping application. It is understood that although the embodiments described herein are directed to a tap input, any number of user inputs are optionally applied, such as actuation of a physical input device, a voice input from the user, attention-based (e.g., including gaze) input, or another input corresponding to a request to change the first waypoint or the second waypoint as described herein. In some embodiments, the electronic device displays the user interface element as a location pin user interface element. For example, the map area includes a first location pin user interface element corresponding to the first waypoint and a second location pin user interface element corresponding to the second waypoint. In some embodiments, the electronic device receives user input (e.g., gesture as described above) corresponding to a request to move the respective location of the first location pin user interface element and/or the respective location of the second location pin user interface element. In some embodiments, in response to receiving the user input, the electronic device changes the respective location of the first waypoint and/or the second waypoint (e.g., the electronic device displays the first location pin user interface element and/or the second location pin user interface element at the respective changed location identified by the user input). In some embodiments, the electronic device selects a segment of the route between the changed first waypoint and the second waypoint as described above with reference to method 900. In some embodiments, in response to receiving the user input, the electronic device displays an updated representation of the generated route and/or sketch (e.g., as described above) that includes the respective changed locations of the first location pin user interface element and/or the second location pin user interface element and their associated first waypoint and second waypoint. Displaying a user interface element that, when selected, causes the electronic device to change the first waypoint or the second waypoint provides the user of the electronic device control over the generated route, which simplifies the interaction between the user and the electronic device and enhances the operability of the electronic device, and indicates to the user an ability to change the first waypoint or the second waypoint quickly and efficiently.

In some embodiments, in response to receiving the gesture starting from the first location of the map area to the second location of the map area (e.g., as described above with reference to method 900), displaying, via the display component, a representation of the generated route (e.g., as described above with reference to displaying a representation of the generated route), such as generated route 746 in FIG. 7K.

In some embodiments, the electronic device displays a user interface element that, when selected, causes the electronic device to add a third waypoint, different from the first waypoint and the second waypoint, to the generated route, such as adding waypoint 774 in FIG. 7K. In some embodiments, the user interface element has one or more of the characteristics of the user interface element that, when selected causes the electronic device to change the first waypoint or the second waypoint as described above. In some embodiments, the electronic device receives one or more inputs corresponding to a request to add the third waypoint. In some embodiments, the third waypoint is selected from a list of waypoints. In some embodiments, the list of waypoints includes favorite or preferred waypoints and/or waypoints the user previously visited or viewed. In some embodiments, the list waypoints includes interesting and/or popular waypoints in the map area. In some embodiments, the list of waypoints is displayed in response to the electronic device receiving a request to add a waypoint (e.g., via a selectable user interface element that, when selected, causes the electronic device to display the list of waypoints).

In some embodiments, the list of waypoints is displayed optionally overlaid on the map area. In some embodiments, the one or more inputs include selection of a particular waypoint from the list of waypoints. In another example, the electronic device detects the user make a pinch hand shape (e.g., as described above in method 900), and detecting the user maintain the pinch hand shape, the electronic device receives movement of the hand of the user in a circular motion at a respective location of the map area corresponding to the third waypoint. In some embodiments, in response to receiving the input including the pinch hand shape and the circular motion, the electronic device revises the route with the third waypoint added. It is understood that although the embodiments described herein are directed to an input including the pinch hand shape, any number of user inputs are optionally applied, such as a touch and hold on a touch sensitive surface that lasts for longer than a threshold period of time (e.g., 0.1, 0.3, 0.5, 0.7, 1, 3, 5, 7, or 10 seconds), actuation of a physical input device, a voice input from the user, attention-based (e.g., including gaze) input, or another input corresponding to a request to add the third waypoint as described herein. For example, in response to receiving the touch and hold user input that corresponds to adding the third waypoint at a third location, the electronic device displays a corresponding location pin user interface element as described above. In some embodiments, when the electronic device determines that the third location is in between the respective locations of the first waypoint and the second waypoint, the electronic device selects a segment of the route from the first waypoint to the third waypoint, and a segment of the route from the third waypoint to the second waypoint. In some embodiments, in response to receiving the user input corresponding to the request to add the third waypoint, the electronic device displays an updated representation of the generated route and/or sketch (e.g., as described above) that includes the segment of the route from the first waypoint to the third waypoint, and the segment of the route from the third waypoint to the second waypoint. In some embodiments, the electronic device adds the third waypoint after the second waypoint such that the route includes a segment from the first waypoint to the second waypoint, and a segment from the second waypoint to the third waypoint. It is understood that although the embodiments described herein include adding the third waypoint and a particular ordering of the first waypoint, the second waypoint, and the third waypoint, any number of modifications and/or orders are optionally applied and executed by the electronic device. Displaying a user interface element that, when selected, causes the electronic device to add the third waypoint provides the user of the electronic device control over the generated route, which simplifies the interaction between the user and the electronic device and enhances the operability of the electronic device, and indicates to the user an ability to add a third waypoint quickly and efficiently.

In some embodiments, the one or more attributes of the movement portion of the gesture include a (sharp) corner location, such as illustrated by the corner location 648 of the sketch 614a in FIG. 6A. For example, when the electronic device determines that the movement portion of the gesture includes a sharp corner location, the electronic device identifies one or more waypoints to be added to the route at a respective location of the map area corresponding to the sharp corner location. In some embodiments, the electronic device identifies a sharp corner location as an area comprising a bend in the line of the sketch and/or a change in direction of the movement portion of the gesture causing portions of the line to form an angle. For example, in accordance with a determination that the movement portion of the gesture includes a change in direction over a distance of movement that is more than a threshold change in angle (e.g., 10 degrees or more), the electronic device optionally determines that the movement portion of the gesture includes a corner location. In some embodiments, in accordance with a determination that the movement portion of the gesture includes a change in direction over a distance of movement that is less than the threshold change in angle, the electronic device optionally determines that the movement portion of the gesture does not include a corner location. In some embodiments, the sharp corner location is rounded. In some embodiments, when the electronic device determines that the movement portion of the gesture does not include a sharp corner location, the electronic device does not identify one or more waypoints to be added. In some embodiments, the first waypoint and/or the second waypoint are defined by one or more characteristics (or attributes), such as the corner location. Other characteristics will be described below and with reference to method(s) 1000 and/or 1100. In some embodiments, as described with reference to method(s) 1000 and/or 1100, the one or more characteristics are weighted. For example, the first waypoint and/or the second waypoint is optionally defined by a corner location that is present in a respective segment of the route that includes the first waypoint and/or the second waypoint. In some embodiments, the electronic device determines that the respective waypoint or location of the map area corresponding to the sharp corner location is not suitable for navigation/routing (e.g., not traversable). For example, in accordance with a determination that the respective location is not suitable for navigation/routing, the electronic device optionally determines an alternative location that is within the predetermined distance (e.g., as described above) from the respective location corresponding to the corner location. In some embodiments, the electronic device determines that the corner location corresponds to more than one (e.g., at least two) waypoints or locations. For example, in accordance with a determination that the corner location corresponds to a third waypoint and a fourth waypoint, the electronic device optionally selects the waypoint that corresponds to the sharpest part of the corner location. In some embodiments, the electronic device includes the third waypoint and the fourth waypoint in the route. Identifying waypoints of a route based on a sharp corner location of the movement portion of the gesture enables a user a faster means for generating the route efficiently via a quick sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, the one or more attributes of the movement portion of the gesture include a speed of the movement portion of the gesture, such as illustrated by part 616a of the sketch 614a in FIG. 6A. For example, when the electronic device determines that the speed of the movement portion of the gesture is below a predetermined speed (e.g., 25, 50, 75, 100, 125, or 150 millimeters/second), the electronic device identifies one or more waypoints to be added to the route at a respective location corresponding to the slower speed of movement such that the electronic device optionally includes the one or more waypoints in the route. In some embodiments, when the electronic device determines that the speed of the movement portion of the gesture meets or is above the predetermined speed, the electronic device does not identify one or more waypoints to be added to the route. In some embodiments, the first waypoint and/or the second waypoint is optionally defined by a speed of travel (e.g., speed limit) along a respective road segment. For example, the electronic device determines a first road segment and a second road segment that includes an identified waypoint to be included in the route. In some embodiments, the electronic device selects the road segment having a higher speed limit. In some embodiments, the electronic device includes the first road segment that includes the identified waypoint in the route because the cost of traveling along the first road segment is less (e.g., because the first road segment is associated with a higher speed limit) than the cost of traveling along the second road segment (e.g., because the second road segment is associated with a lower speed limit). In some embodiments, the electronic device determines that the one or more waypoints corresponding to the slower speed of movement are not suitable for navigation/routing (e.g., not traversable). For example, in accordance with a determination that the one or more waypoints are not suitable for navigation, the electronic device optionally determines one or more alternative waypoints that are within the predetermined distance (e.g., as described above) from the one or more waypoints corresponding to the slower speed of movement. Identifying waypoints of a route based on the speed of the movement portion of the gesture enables a user a more precise means for generating the route efficiently via a sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, the one or more attributes of the movement portion of the gesture include selection of one or more locations of the map area, such as pinch hand shape 704a in a circular movement 724 in FIG. 7D. For example, the movement portion of the gesture optionally includes one or more fingers up gesture or pointing gesture and, while maintaining the pinch hand shape, the one or more fingers up hand shape or pointing hand shape, the electronic device receives a circular movement corresponding to selection of one or more locations of the map area. In some embodiments, in response to receiving selection of one or more locations of the map area, the electronic device identifies one or more waypoints corresponding to the one or more locations received via the selection such that the electronic device includes one or more waypoints at the one or more respective locations to the generated route. In some embodiments, the first waypoint and/or the second waypoint is optionally defined by being previously selected as obtained from activity history data associated with a user account of the electronic device as will described in more detail below. In some embodiments, the electronic device determines that the selected one or more locations are not suitable for navigation/routing. For example, in accordance with a determination that the one or more locations are not suitable for navigation, the electronic device optionally determines one or more alternative respective locations that are within the predetermined distance (e.g., as described above) from the one or more selected locations. In some embodiments, in accordance with a determination that a third waypoint and a fourth waypoint correspond to the selection input, the electronic device optionally selects the location that is at the center of the selection circle or the electronic device optionally selects the location based on the activity history data as will be described below. In some embodiments, the electronic device includes the third waypoint and the fourth waypoint in the route. Identifying waypoints of a route based on selection of one or more locations of the map area via the gesture enables a user a more precise means for generating the route efficiently via a sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, extracting the first waypoint and the second waypoint includes determining a match between the one or more attributes of the movement portion of the gesture to a corresponding location on the map area that satisfies location criteria (e.g., a location that is significant to the map area, such as described with reference to method(s) 900, 1000, and/or 1100), such as waypoint 720 determined to be a significant waypoint in FIG. 7D. For example, the electronic device optionally matches the one or more attributes of the movement portion of the gesture described above and below to corresponding locations on the map area that satisfy the location criteria, including a criterion that is satisfied when the locations correspond to significant locations, such as particular roadways, particular roadway characteristics such as intersections, turning ramps, exiting ramps, and/or the like as described with reference to method 1000. In some embodiments, the location on the map area corresponds to the one or more attributes of the movement portion of the gesture. For example, the location on the map area corresponds to a respective location at which the movement portion of the gesture includes a sharp corner location as described above or a particular speed or change in speed as described above.

In some embodiments, extracting the first waypoint and the second waypoint includes extracting, based on the match, the first waypoint and the second waypoint, such as extracting waypoint 720 in FIG. 7D. In some embodiments, the electronic device extracts the first waypoint and the second waypoint located within a predetermined distance (e.g., 0.7, 0.5, 1, 10, 20, 50, or 100 kilometers) from the corresponding locations on the map area. In some embodiments, the electronic device includes the extracted first waypoint and the extracted second waypoint in the generated route as described above with reference to method 900. In some embodiments, the first waypoint corresponds to a first portion of the movement portion of the gesture (e.g., corner location). In some embodiments, the second waypoint corresponds to a second portion of the movement portion of the gesture (e.g., slower speed of movement), different from the first portion of the movement portion of the gesture. In some embodiments, determining the match between the one or more attributes of the movement portion of the gesture to a corresponding location on the map area that satisfies location criteria includes weighing the one or more attributes of the movement portion of the gesture as described with reference to method(s) 1000, and/or 1100. For example, the first waypoint and the second waypoint that is extracted by the electronic device correspond to the one or more weighted attributes of the movement portion of the gesture as described with reference to method(s) 1000, and/or 1100. Extracting waypoints based on a match between one or more attributes of the movement portion of the gesture to corresponding locations on the map area enables a user a means for generating the route efficiently via a sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, the one or more attributes of the movement portion of the gesture include identifying at least a portion of a user of the electronic device that is directed to the map area, such as the plurality of fingers of the hand 704g pointed towards map area 700 in FIG. 7G. In some embodiments, the portion of the user is one or more hands of the user. In some embodiments, the electronic device determines that all the fingers of the one or more hands of the user are pointed towards the map area. In some embodiments, the electronic device determines that one or more fingers of the one or more hands of the user are pointed towards the map area. In some embodiments, in accordance with a determination that at least a portion of the user of the electronic device is directed to the map area, the electronic device extracts the first waypoint and/or the second waypoint from a respective location corresponding to a location to which the electronic device detects the at least the portion of the user of the electronic device pointing. In some embodiments, the first waypoint and/or the second waypoint is optionally defined by being previously identified via the gesture as obtained from activity history data associated with a user account of the electronic device as will described in more detail below.

In some embodiments, the electronic device determines that the waypoint is not suitable for navigation/routing (e.g., not traversable). For example, in accordance with a determination that the waypoint is not suitable for navigation, the electronic device optionally determines one or more alternative respective locations that are within the predetermined distance (e.g., as described above) from the location to which the electronic device detects the at least the portion of the user of the electronic device is pointing. In some embodiments, in accordance with a determination that a third waypoint and a fourth waypoint correspond to the location to which the electronic device detects the at least the portion of the user of the electronic device is pointing, the electronic device optionally selects the waypoint that is at the center of the pointing location or the electronic device optionally selects the location based on the activity history data as will be described below. In some embodiments, the electronic device includes the third waypoint and the fourth waypoint in the route. Identifying waypoints of a route by identifying that at least a portion of the user of the electronic device is directed to the map area enables a user a means for generating the route efficiently via a sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and avoids unintentional activation or deactivation of route generation due to unintentional user interaction.

In some embodiments, the one or more attributes of the movement portion of the gesture include a voice input from a user of the electronic device received, via the one or more input devices (e.g., as described above), while receiving the gesture directed to the map area, such the electronic device receiving voice input 772 while detecting the pinch hand shape 704k in FIG. 7K. In some embodiments, the electronic device is operating in a listening mode when the voice input is received. In some embodiments, receiving the gesture automatically initiates the listening mode of the electronic device. In some embodiments, the electronic device optionally interprets the voice input as including a destination, a location, a waypoint, a roadway, a route, a constraint and/or the like to be applied when generating the route. In some embodiments, in accordance with a determination that the voice input includes a particular location, the electronic device extracts the first waypoint or the second waypoint from a respective location corresponding to the particular location identified in the voice input. In some embodiments, the electronic device extracts the first waypoint or the second waypoint from a location corresponding to a respective location to which the electronic device receives the gesture directed to the map area in response to a voice input from the user. For example, while receiving the gesture as described above directed to the map area, and upon receipt of a voice input from the user as described herein, the electronic device triggers selection of a waypoint corresponding to the location to which the electronic device receives the gesture to the map area. In some embodiments, the waypoint is optionally defined by being previously identified via the voice input as obtained from activity history data associated with a user account of the electronic device as will described in more detail below. In some embodiments, the electronic device determines that the waypoint is not suitable for navigation/routing (e.g., not traversable). For example, in accordance with a determination that the waypoint is not suitable for navigation, the electronic device optionally determines one or more alternative respective locations that are within the predetermined distance (e.g., as described above) from the location to which the electronic device receives the gesture directed to the map area and voice input from the user. In some embodiments, in accordance with a determination that a third waypoint and a fourth waypoint correspond to the location to which the electronic device receives the gesture directed to the map area and voice input from the user, the electronic device optionally selects the waypoint that is at the center of the location to which the electronic device receives the gesture and voice input. In some embodiments, the electronic device includes the third waypoint and the fourth waypoint in the route. Identifying waypoints of a route based on a voice input received by the user of the electronic device while receiving the gesture enables a user a means for generating the route efficiently via a sketch and voice input, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, wherein the one or more attributes of the movement portion of the gesture include activity history data associated with a user account of the electronic device, such as activity history data derived from map data 438 in FIG. 8A. For example, the activity history data optionally includes historical data, such as route segments, roadways, or waypoints the user previously visited or viewed as derived by a calendar application operating on the electronic device or another application that includes mapping information other than the calendar application. In some embodiments, the activity history data is based on previous interactions with the mapping application. For example, the previous interactions with the mapping application optionally include browsing particular geographic areas, requesting the generation of navigation directions, and/or the like. In some embodiments, the activity history data is based on calendar information. For example, the calendar information optionally includes a location of an event. In some embodiments, in accordance with a determination that the activity history includes a particular location (e.g., derived from a calendar event and/or the user's map browsing history), the electronic device extracts the first waypoint or the second waypoint from a respective location corresponding to the particular location identified by the activity history data. In some embodiments, the activity history data optionally includes previously drawn sketches such that one or more waypoints of the previously drawn sketches are utilized in generation of the route. In some embodiments, the waypoint is optionally defined by being previously identified from the activity history data. In some embodiments, the electronic device determines that the one or more waypoints of the previously drawn sketches are not suitable for navigation/routing (e.g., not traversable). For example, in accordance with a determination that the one or more waypoints are not suitable for navigation, the electronic device optionally determines one or more alternative respective waypoints that are within the predetermined distance (e.g., as described above) from the waypoints identified based on activity history data. In some embodiments, in accordance with a determination that a third waypoint and a fourth waypoint are identified based on the activity history data as described herein, the electronic device optionally selects the most popular waypoint (e.g., according to most recently visited, most frequently visiting, most time spent, and/or the like). In some embodiments, the electronic device includes the third waypoint and the fourth waypoint in the route. Identifying waypoints of a route based on activity history data enables a user a means for generating the route efficiently, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, the one or more attributes of the movement portion of the gesture include receiving, via the one or more input devices, an attention-based input (e.g., gaze-based input) from a user of the electronic device while receiving the gesture directed to the map area, such as attention 768 of the user directed to map area 700 in FIG. 7K. In some embodiments, when user attention corresponds to gaze, a gaze tracking device optionally captures one or more images of the user's eyes and detects the pupils and glints in the one or more captured images to track the user's gaze, as described in more detail with reference to FIG. 6. In some embodiments, the electronic device detects the gaze of the user directed at a location (or region) of the map area for a period of time greater than a time threshold (e.g., 0.02, 0.05, 0.1, 0.2, 0.25, 0.3, 0.5, 1, 2, 3, or 5 seconds). In some embodiments, in accordance with a determination that the gaze of the user is directed at the location for greater than the time threshold, the electronic device identifies one or more waypoints from a respective location corresponding to the location at which the electronic device detects the gaze. In some embodiments, in accordance with a determination that the gaze of the user is directed at the location for less than the time threshold, the electronic device foregoes identifying one or more waypoints from a respective location corresponding to the location at which the electronic device detects the gaze that is determined to be directed to the location for less than the time threshold. In some embodiments, the waypoint is optionally defined by being previously identified via the attention-based input as obtained from activity history data associated with a user account of the electronic device as described above. In some embodiments, the electronic device determines that the waypoint is not suitable for navigation/routing (e.g., not traversable). For example, in accordance with a determination that the waypoint is not suitable for navigation, the electronic device optionally determines one or more alternative respective locations that are within the predetermined distance (e.g., as described above) from the location to which the electronic device receives the attention-based input directed to the map area. In some embodiments, in accordance with a determination that a third waypoint and a fourth waypoint correspond to the location to which the electronic device receives the attention-based input directed to the map area, the electronic device optionally selects the waypoint that is at the center of the location to which the electronic device receives the attention-based input. In some embodiments, the electronic device includes the third waypoint and the fourth waypoint in the route. Identifying waypoints of a route based on receiving an attention-based input while receiving the gesture enables a user a means for generating the route efficiently via a sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and avoids unintentional activation or deactivation of route generation due to unintentional user interaction.

In some embodiments, the electronic device generates a first segment of the route according to a first mode of transportation, such as a driving mode of transportation determined to be the first mode of transportation for a portion of the generated route 746 in FIG. 7K. For example, the first mode of transportation optionally refers to a motorized vehicle, such as an automobile (e.g., driving directions).

In some embodiments, the electronic device generates a second segment, different from the first segment, of the route according to a second mode of transportation, different from the first mode of transportation, such the electronic device including segment 760b according to a walking mode of transportation in FIG. 7K. In some embodiments, the second mode of transportation optionally includes generating the second segment of the route according to another mode of transportation (e.g., bicycle, walking, transit, or transportation other than the motorized vehicle) different from the first mode of transportation. In some embodiments, the mode of transportation causes a change to the route. For example, in accordance with a determination that the first mode of transportation includes a bicycle, the electronic device generates a route that includes bike lanes, bike parking, and/or the like. In another example, in accordance with a determination that the first mode of transportation includes public transit, the electronic device generates a route that includes transit lines for transit, transit maps, transit schedule, transit cost information and/or the like. In some embodiments, the electronic device identifies a waypoint at a respective location corresponding to the location at which the mode of transportation changes. In some embodiments, the electronic device determines the change in mode of transportation based on user input. For example, the electronic device optionally receives user input corresponding to a request to change the mode of transportation from the first mode of transportation to the second mode of transportation, optionally while the sketch is being received by the computer system. In some embodiments, the electronic device determines the change in mode of transportation without detecting user input corresponding to the request to change from the first mode of transportation to the second mode of transportation. In some embodiments, the change in mode of transportation is based on an optimal path between the first waypoint and the second waypoint (e.g., an optimal use of time, distance, and/or energy) as will be described below. For example, the electronic device optionally determines that the second segment of the route according to the second mode of transportation is more optimal than a second segment of the route according to the first mode of transportation (e.g., based on any of the considerations described herein for generating a given segment of a route). Generating a first segment of the route according to a first mode of transportation and generating a second segment of the route according to a second mode of transportation in response to receiving the gesture enables a user a means for generating the route efficiently via a sketch, thereby reducing the need for subsequent inputs from a user to precisely select particular roadways and/or waypoints and appropriate modes of transportation when immediate routing guidance and seamless transition between transportation modes is desired, which reduces power usage and improves battery life of the electronic device by enabling the user to use the electronic device more quickly, efficiently, and control the route generated.

In some embodiments, after generating the route from the first location to the second location (e.g., as described above with reference to method 900), the electronic device receives route information from a second electronic device, different from the first electronic device, such as the second electronic device being represented by representation 782b in FIG. 3M. For example, the electronic device receives a request from the second electronic device to collaborate on a route. In some embodiments, the request to collaborate on a route includes receiving route information from the second electronic device. In some embodiments, the second electronic device is associated with a user account different from the user account associated with the first electronic device. In some embodiments, the second electronic device is associated with a same user account associated with the first electronic device. In some embodiments, the electronic device and the second electronic device are part of a synchronized communication session. In some embodiments, the synchronized communication session is a session in which the route is synchronously presented at the electronic device and the second electronic devices. In some embodiments, the electronic device and the second electronic devices collaborate/communicate (e.g., talk, text, chat, message) with each other while participating in the synchronized communication session. In some embodiments, the first and second electronic devices communicate asynchronously, such as via a messaging application.

In some embodiments, in response to receiving the route information, the electronic device initiates a process to modify the generated route in accordance with the route information, such as for example, adding waypoint 774 to the generated route 746 in FIG. 7K. In some embodiments, the route information is received and/or obtained from a remote server in communication with the electronic device and/or a local processor (e.g., maintained by the electronic device optionally from a map application operating on the electronic device) for processing, computing, generating, and/or refining the route as described above. In some embodiments, initiating the process to modify the generated route includes displaying, via the display component, the modified route. In some embodiments, the route information includes a modification to the generated route, such as a removal of the first waypoint, the second waypoint, the first respective location, and/or the second respective location. In some embodiments, the route information includes the addition of a third waypoint, different from the first waypoint and the second waypoint. In some embodiments, the route information includes the addition of a third respective location, different from the first respective location and the second respective location. In some embodiments, prior to receiving the route information and initiating the process to modify the route includes the second electronic device initiating a process to share the route with the electronic device. In some embodiments, initiating the process to share the route includes displaying a user interface for selecting one or more electronic device(s) (e.g., contact(s) from a contact list) including the electronic device to share the route with. In some embodiments, initiating the process for sharing the route with the electronic device includes displaying options for sharing the modified route in its entirety or sharing one or more of the modified segments of the route (e.g., the added third waypoint or the removal of a waypoint described above). In this way, the electronic device and the second electronic device are participating in collaborative efforts to refine the route. Initiating a process for collaborating and sharing the route with the second electronic device simplifies the interaction between the user and the first electronic device and enhances the operability of the first electronic device (e.g., by providing a collaboration and sharing option without having to navigate to another application and/or user interface).

In some embodiments, the electronic device selects the segment of the route between the first waypoint and the second waypoint based on map data, such as map data 838, 840, and/or 842 in FIG. 8A (e.g., and not based on the movement portion of the gesture). For example, the electronic device optionally requests map data from a server (e.g., map engine) in communication with the electronic device and/or the local processor of the electronic device as described above. In some embodiments, the electronic device utilizes the map data for generating the route including evaluating data, such as streets, highways, freeways, other roadways, waypoints, and/or the like of the map area. In some embodiments, the map data includes information related to route data traveled by a user account of the electronic device; favorite or preferred roadways or locations of the user account identified by the electronic device as a favorite by the user account or set via user route specification; and/or historical data, such route segments, roadways, or waypoints the user account previously visited or viewed. In some embodiments, when the electronic device is operating in a power savings mode preventing map data updates to occur while generating the route and/or an offline mapping mode where the map data includes downloaded map data), the electronic device optionally utilizes map data downloaded on the electronic device. In some embodiments, the electronic device utilizes the map data for generating the route including evaluating data, such as streets, highways, freeways, other roadways, waypoints, and/or the like of the map area without receiving map data updates (optionally related to real-time traffic and/or weather). In some embodiments, the map data does not include information related to route data traveled by a user account of the electronic device described above; favorite or preferred roadways or locations of the user account identified by the electronic device as a favorite by the user account or set via user route specification described above; and/or historical data, such route segments, roadways, or waypoints the user account previously visited or viewed described above. Generating the route based on map data enables a user a means for generating the route efficiently via a sketch, thereby reducing the need for subsequent inputs from a user to precisely select particular roadways when immediate routing guidance and seamless transition between transportation modes is desired, which reduces power usage and improves battery life of the electronic device by enabling the user to use the electronic device more quickly, efficiently, and control the route generated.

In some embodiments, the path between the first waypoint and the second waypoint is an optimal path and includes an optimal use of time, distance, and/or energy (e.g., fuel or battery power), such as the electronic device determining an optimal path based on fuel considerations as illustrated and represented by representation 780 in FIG. 7L. In some embodiments, the electronic device utilizes an optimal path criterion for determining the selected path. The optimal path criterion is optionally expressed in terms of costs related to traveling from the first waypoint to the second waypoint. For example, the costs considered for selecting the path between the first waypoint and the second waypoint is based on travel time, travel distance, fuel consumption, and/or energy consumption. For example, the amount of fuel or battery power available is considered when selecting the path between the first waypoint and the second waypoint. In another example, the electronic device considers a length of time available for traversing the path between the first waypoint and the second waypoint. For example, the electronic device optionally determines a first cost for a first path between the first waypoint and the second waypoint and a second cost for a second path, different from the first path, between the first waypoint and the second waypoint. In some embodiments, for the same sketch between the two waypoints, if the first cost is less than the second cost, the electronic device selects the first path for inclusion in the generated route; and, if the second cost is less than the first cost, the electronic device selects the second path for inclusion in the generated route. Generating the route based on efficient use of time, distance, and/or energy enables a user a means for generating the route efficiently via a sketch, thereby reducing the need for subsequent inputs from a user to precisely select particular roadways and/or waypoints that include efficient use of time, distance, and/or energy when immediate routing guidance and seamless transition between transportation modes is desired, which reduces power usage and improves battery life of the electronic device by enabling the user to use the electronic device more quickly, efficiently, and control the route generated.

In some embodiments, the first waypoint and/or the second waypoint are intermediate locations between the first respective location and the second respective location on the generated route, such as waypoint 748 in FIG. 7J. In some embodiments, the intermediate locations include geographic areas, points of interest, landmarks, intersections, roadways, and/or the like. In some embodiments, the intermediate locations are locations to move past (e.g. not identified as stopping points along the route). In some embodiments, the intermediate locations are significant points of interest that serve as a guide to the user that the user is navigating along the route. In some embodiments, the intermediate locations include particular turns, maneuvers, or roads/paths to use in the route. In some embodiments, while navigating along the route that includes the first waypoint and the second waypoint, and in accordance with a determination that the electronic device has arrived at the first waypoint, the electronic device sets or marks the first waypoint as satisfied/completed and continues navigating along the generated route to the second waypoint without the need to stop at the first waypoint. Extracting the first waypoint and the second waypoint that are intermediate locations between the first respective location and the second respective location on the generated route enables a user a means for generating the route efficiently via a sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, extracting the first waypoint and the second waypoint includes in accordance with a determination that the movement portion of the gesture corresponding to a respective waypoint of the first waypoint or the second waypoint satisfies one or more first criteria, including the respective waypoint in the route without including a stop along the route at a location of the respective waypoint, such as continuing to add to the sketch 716 in accordance with detecting continued movement of pinch hand shape 704b in FIG. 7B. In some embodiments, the one or more first criteria include a criterion that is satisfied when the movement portion of the gesture is a continuation of the prior movement portion of the gesture leading up to the current portion (e.g., the movement portion of the gesture is not identified as separate from the movement portion of the gesture). In some embodiments, the electronic device identifies a movement portion of the gesture as separate when the electronic device detects a break in the sketch user input in between the gesture. For example, the break user input optionally includes one or more hands, arms, and/or fingers no longer being directed to the map area for longer than a threshold period of time (e.g., 1, 3, 5, 7, 10, 20, or 30 seconds). In another example, the break user input optionally includes the gaze of the user no longer directed to the map area for longer than the threshold period of time. In another example, the break user input optionally includes detecting the sketch pausing at a particular location on the map area for longer than the threshold period of time. In another example, the break user input optionally includes detecting the sketch having a particular profile/shape in the particular map area that corresponds to a stop instead of a waypoint without including a stop (e.g., a circular sketch at the location rather than a sketch that merely changes direction at the particular location). In yet another example, the break user input optionally includes voice input indicative a break in the movement portion of the gesture. In some embodiments, the movement portion of the gesture that is part of the gesture includes a corner location as described above with reference to sharp corner locations. In some embodiments, in response to detecting the gesture including the movement portion that satisfies the one or more first criteria, the electronic device adds the respective waypoint to the route as a location for the route to move past without planning a stop at the location of the respective waypoint, such as described previously.

In some embodiments, extracting the first waypoint and the second waypoint includes in accordance with a determination that the movement portion of the gesture corresponding to the respective waypoint satisfies one or more second criteria different from the one or more first criteria, including a stop along the route at the location of the respective waypoint, such as the electronic device the circular movement of the pinch hand shape 704a in FIG. 7D. In some embodiments, the one or more second criteria include a criterion that is satisfied when the movement portion of the gesture is a separate part of the gesture in that the movement portion of the gesture includes a circular movement portion of the gesture corresponding to selection of one or more locations of the map area as described above. In some embodiments, the movement portion of the gesture includes a different (or additional) hand shape corresponding to a request to include the stop along the route. In some embodiments, the electronic device receives a different (or additional) voice input corresponding to the request to include the stop along the route. In some embodiments, when the waypoint is a first type (e.g., a stop or destination), the electronic device pauses presenting navigation directions along the generated route (e.g., until further user input, such as a button press, is detected, even if the electronic device continues movement along the route). In some embodiments, when the waypoint is a second type (e.g., a location point at which the path changes), the electronic device marks the waypoint as satisfied/completed and optionally displays a notification that the waypoint is completed and continues to present navigation directions to the next waypoint along the generated route without pausing the directions at the waypoint. Generating the route that includes a stop along the route based on the movement portion of the gesture satisfying one or more first criteria and/or second criteria enables a user to generate the route efficiently via a sketch, thereby reducing the need for subsequent inputs from a user to precisely select particular roadways and/or waypoints as stops along the route when immediate routing guidance is desired, which reduces power usage and improves battery life of the electronic device by enabling the user to use the electronic device more quickly, efficiently, and control the route generated.

In some embodiments, the process to generate the route includes in accordance with a determination that the movement portion of the gesture defines a first candidate segment, and map data for the first candidate segment indicates that the first candidate segment can be provided via the movement portion of the gesture, selecting the first candidate segment as a respective segment for the route, such as selecting segment 752a for inclusion in the generated route in FIG. 7J. For example, the map data for the first candidate segment optionally indicates that the first candidate segment is appropriate (e.g., follows road rules). In some embodiments, the first candidate segment is defined by the movement portion of the gesture as described above with respect to the speed and/or direction of the movement portion of the gesture. In some embodiments, when the electronic device determines that the first candidate segment lies within the predetermined distance from a respective location at which the movement portion of the gesture is received, the electronic device will assess whether or not map data for the first candidate segment indicates the first candidate segment is appropriate and will add the first candidate segment to the route. In some embodiments, the electronic device will consider a respective cost associated with adding the first candidate segment to the route as discussed with reference to method(s) 1000 and/or 1100.

In some embodiments, the process to generate the route includes in accordance with a determination that the movement portion of the gesture defines the first candidate segment, and map data for the first candidate segment indicates that the first candidate segment cannot be provided via the movement portion of the gesture, forgoing selecting the first candidate segment as the respective segment for the route, such as foregoing selecting segment 786 as indicated by indication 752b in FIG. 7J. For example, the map data for the first candidate segment optionally indicates that the first candidate segment does not follow road rules. For example, the electronic device determines that the first candidate segment includes deviations as described above with reference to method 900, such as a direction of travel, roadways, or locations that are not reachable and/or cannot be traversed via a current mode of transportation. In some embodiments, although the first candidate segment lies with the predetermined distance from a respective location at which the movement portion of the gesture is received, the electronic device does not automatically add the first candidate segment to the route. For example the electronic device determines that the map data for the first candidate segment indicates the first candidate segment is not appropriate for the route. In some embodiments, although, the electronic device determines, based on the map data, that the first candidate segment cannot be provided via the movement portion of the gesture (e.g., the first candidate segment indicates changing the mode of transportation to a mode different from the current mode of transportation), the electronic device selects the first candidate segment to the route based on a determination that the first candidate segment is the optimal segment for the route as discussed with reference to method(s) 900, 1000, and/or 1100. In some embodiments, the allowing or disallowing of candidate segments to be provided via the sketch also applies analogously to the allowing or disallowing of waypoints defined by the sketch (e.g., disallowing a waypoint at a location that cannot actually be traversed and/or accessed based on map data, even if the sketch defines such a waypoint). Generating the route that includes appropriate route segments based on map data enables a user a means for generating the route efficiently via a sketch, thereby reducing the need for subsequent inputs from a user to precisely select particular roadways and/or waypoints along the route when immediate routing guidance is desired, which reduces power usage and improves battery life of the electronic device by enabling the user to use the electronic device more quickly, efficiently, and control the route generated.

In some embodiments, the first candidate segment that cannot be provided via the movement portion of the gesture is not traversable, such as indicated by indication 762 in FIG. 7J. In some embodiments, the first candidate segment is determined to be invalid by the electronic device. In some embodiments, the electronic device determines that the first candidate route segment is invalid because the first candidate route segment is not traversable in reality. For example, the electronic device optionally receives map data about the first candidate segment indicative of the first candidate segment being permanently or temporarily closed and/or the direction of travel is in the opposite direction of the direction of travel of the movement portion of the gesture. Generating the route that does not include candidate segments determined to be not traversable enables a user a means for generating the route efficiently via a sketch, thereby reducing the need for subsequent inputs from a user to precisely select particular roadways and/or waypoints along the route when immediate routing guidance is desired, which reduces power usage and improves battery life of the electronic device by enabling the user to use the electronic device more quickly, efficiently, and control the route generated.

In some embodiments, the first candidate segment that cannot be provided via the movement portion of the gesture is traversable (e.g., as described above), such as segment 760b in FIG. 7J. For example, the electronic device determines that this invalid segment (e.g., the first candidate segment) is traversable in reality. In some embodiments, the electronic device determines that the first candidate segment is invalid despite being traversable according to map data. For example, a respective traversal cost associated with the first candidate segment (e.g., as described with reference to method(s) 1000 and/or 1100) is optionally considered by the electronic device when determining that the first candidate segment is invalid despite being traversable. For example, the electronic device optionally considers a predefined threshold that is based on a length of time available for traversal of the generated route (e.g., 1 hour, 3 hours, 6 hours, 24 hours, or 1 week). In another example, the predefined threshold is optionally based on an amount of fuel available for traversal of the generated route (e.g., 1, 3, 5, 7, 10, 15, or 20 gallons). In another example, the predefined threshold is optionally based on an amount of energy available for traversal of the generated route (e.g., 1, 5, 10, 20, 30, 40, 50, 100, or 200 kWh). In another example, the predefined threshold is optionally based on distance for traversal of the generated route (e.g., 10, 20, 40, 60, 80, 100, 150, 200, 500, 1000, or 2000 kilometers). In some embodiments, the traversal cost is based on map data identifying permanently or temporarily closed roads, one-way roads, and/or the like. In some embodiments, the electronic device determines that the first candidate segment is invalid because the respective traversal cost of the first candidate route exceeds the predefined threshold despite being traversable according to map data. In some embodiments, the electronic device includes or does not include the first candidate segment in the route. In some embodiments, the candidate segment is of a type that cannot be provided via sketch (e.g., in some embodiments, road or freeway segments can be provided via sketch, but subway or metro segments cannot be provided via sketch, though they may be selected by the electronic device automatically for inclusion if they are the optimal segment for a given portion of the route). Generating the route that does include candidate segments determined to be traversable based on a respective traversal cost enables a user a means for generating the route efficiently via a sketch, thereby reducing the need for subsequent inputs from a user to precisely select particular roadways and/or waypoints along the route when immediate routing guidance is desired, which reduces power usage and improves battery life of the electronic device by enabling the user to use the electronic device more quickly, efficiently, and control the route generated.

In some embodiments, receiving the movement portion of the gesture directed to the map area includes detecting motion corresponding to a sequence of locations within the map area, such as movement of the pinch hand shape 704c in FIG. 7C. In some embodiments, the gesture is directed to the map area. In some embodiments, in response to receiving the motion corresponding to a sequence of locations within the map area, displaying, via the display component, a sketch as described above. In some embodiments, in accordance with a determination that the display component is a first type (e.g., touch screen display as described above with reference to method 900), the electronic device displays, on the map, a sketch corresponding to a respective location at which the movement portion of the gesture is received. For example, the electronic device receives the movement portion of the gesture from an input device, such as a stylus, via the display component, and the electronic device processes the movement potion of the gesture for display via the display component. In some embodiments, the stylus is in contact with the display component. In some embodiments, the stylus is not directly in touch contact with the display component. For example, the display component is configured to detect the position to which the stylus is pointing, which is mapped to the map area for display via the display component. In some embodiments, in accordance with a determination that the display component is a second type (e.g., a three-dimensional object as described above with reference to method 900), different from the first type, the electronic device displays the sketch corresponding to the respective location at which the movement portion of the gesture is received and extending out of the map area. For example, the electronic device optionally displays the sketch as if in front of the map area such that there is distance between the sketch and the map area. Displaying the sketch corresponding to the sequence of locations within the map area provides visual feedback, which simplifies the interaction between the user and the electronic device and enhances the operability of the electronic device, and indicates to the user an ability to enter a sketch that will be converted into a route quickly and efficiently.

In some embodiments, the motion corresponding to the sequence of locations within the map area is motion of a stylus providing the gesture to the map area, such as stylus input device 710a in FIG. 7A. For example, the motion corresponding to the sequence of locations within the map area is received from the stylus in contact (e.g., physical or virtual) with the map area, and includes one or more lines, strokes, curves and/or dots. In some embodiments, the stylus is in communication with the electronic device, and is configured to receive one or more inputs using sensors in communication with or included within the stylus. For example, the stylus optionally is configured with touch sensing circuitry (e.g., resistive, capacitive, piezoelectric, and/or acoustic sensors) to detect touch input and/or gestures from one or more fingers interacting with the stylus. The touch input and/or gestures optionally include a sequence of tapping of a finger on a housing of the stylus and/or motions (e.g., swipe movements of one or more fingers) along the housing of the stylus. In response to the stylus detecting the touch input and/or gestures, the electronic device optionally receives (from the stylus) an indication corresponding to the receipt of the touch input and/or gestures by the stylus or other devices in communication with the electronic device and/or the stylus. In some embodiments, the electronic device detects the sequence of tapping of the finger, and in response to the detecting the tapping of the finger, the electronic device initiates a process to change a respective waypoint or location as described above. In some embodiments, input from the stylus is an indirect input such that the user using the stylus is local or remote to the map area (e.g., relative to a physical scene/setting/environment that includes the map area). In another example, input from the stylus includes motions in the air, such as a movement patten or particular motion that is indicative of adding a waypoint or initiating a process to change the route as described above. In some embodiments, the electronic device detects the stylus in the air with a particular motion while attention (e.g., including gaze) of the user is optionally directed to the map area. In some embodiments, the electronic device detects the stylus in contact with a surface of trackpad or within a predetermined distance (e.g., 0.1, 0.3, 0.5, 1, 3, 5, 10, 30, 50 or 100 cm) from a virtual trackpad while attention (e.g., including gaze) of the user is optionally directed to the map area. Converting input from a stylus into a sketch enables a user a means for generating the route efficiently via a sketch, thereby reducing the need for subsequent inputs from a user to precisely select particular roadways and/or waypoints along the route when immediate routing guidance is desired, which reduces power usage and improves battery life of the electronic device by enabling the user to use the electronic device more quickly, efficiently, and control the route generated.

In some embodiments, the motion corresponding to the sequence of locations within the map area is motion of a portion of a user of the electronic device providing the gesture to the map area, such as tap input 706a in FIG. 7A. For example, the portion of the user of the electronic device is optionally a finger of a hand of the user interacting with the map area. In some embodiments, the motion corresponding to the sequence of locations within the map area includes finger touch inputs that are translated by the electronic device as one or more lines, strokes, curves and/or dots of the sketch as described above. Converting input from a portion of the user of the electronic device into a sketch enables a user a means for generating the route efficiently via a sketch, thereby reducing the need for subsequent inputs from a user to precisely select particular roadways and/or waypoints along the route when immediate routing guidance is desired, which reduces power usage and improves battery life of the electronic device by enabling the user to use the electronic device more quickly, efficiently, and control the route generated.

In some embodiments, method 1000 is performed at an electronic device (e.g., electronic device 608 in FIG. 6A) in communication with one or more input devices and a display component (e.g., display component 610 in FIG. 6A). In some embodiments, the electronic device has one or more of the characteristics of the electronic device of method 900. In some embodiments, the one or more input devices have one or more of the characteristics of the one or more input devices of method 900. In some embodiments, the display generation component has one or more of the characteristics of the display generation component of method 900.

In some embodiments, while displaying, via the display generation component, a map area, the electronic device receives (1002a) via the one or more input devices, a gesture (e.g., a gesture including pinch hand shape 704a in FIG. 7A) starting from a first location of the map area (e.g., a location of map area 700 corresponding to a respective location of attention 702) to a second location of the map area (e.g., a location of map area 700 corresponding to a respective location of attention 620 in FIG. 7G) corresponding to a request to generate a route from a first respective location to a second respective location (e.g., as described with reference to method 900 and/or herein), wherein the gesture includes one or more attributes of a movement portion of the gesture from the first location of the map area to the second location of the map area, such as pinch hand shape 704a in a circular movement 724 in FIG. 7D. In some embodiments, the one or more attributes of the gesture include the one or more attributes of the gesture described above with reference to method 900.

In some embodiments, in response to receiving the movement portion of the gesture from the first location of the map area to the second location of the map area, the electronic device initiates (1002b) a process to generate the route from the first respective location to the second respective location, such as the process to generate route 640 illustrated in FIG. 6B (e.g., such as described with reference to method 900). For example, the gesture is optionally received at the electronic device or at a second electronic device as described with reference to method 900. In some embodiments, initiating the process to generate the route has one or more processes as the processes included in initiating the process to generate the route at the remote server in communication with the electronic device and/or the local processor described above with reference to method 900.).

In some embodiments, initiating the process to generate the route includes selecting, based on the one or more attributes of a movement portion of the gesture from the first location to the second location, the route from the first respective location to the second respective location that satisfies one or more criteria, including a criterion that is satisfied based on a cost for the route, wherein the cost for the route is determined based on cost information associated with the one or more attributes of the movement portion of the gesture from the first location to the second location and map data for the map area (1002c), such as cost information output from the cost function 822 component in FIG. 8B. For example, the electronic device initiates the process to generate the route from the first respective location to the second respective location based on both the sketch of the gesture as described above with reference to method 900 (e.g., the first location, the second location, and the one or more attributes of the movement portion of the gesture) and map data for the map area as described above with reference to method 900. In some embodiments, the electronic device weighs the one or more attributes of the movement portion of the gesture to compare and select a route or route segment. As described herein and throughout (and with reference to method(s) 900, 1000, and/or 1100), a route or route segment is optionally a path between two waypoints. For example, and as will be described in more detail below, the selected route segment is based on a cost of the route segment that is a cost function of how well the route segment relates to the sketch of the gesture and how well the route segment relates to the map data. For example, when the electronic device determines a first possible route segment having a first distance from the sketch of the line (e.g., as described with reference to method 900), the electronic device weighs the first route segment greater (or more positively or favorably) than a second possible route segment having a second distance from the sketch of the line, wherein the second distance is greater than the first distance associated with the first route segment. In some embodiments, the electronic device considers other attributes of the movement portion of the gesture and/or determines that the other attributes of the movement portion of the gesture and/or attributes of the physical area represented by the map area outweigh a preference for route segments located closer to the sketch of the line. In some embodiments, the other attributes optionally include a direction of the sketch of the line compared to the actual direction of the road being compared to in the map area/data. For example, when the electronic device determines that the first possible route segment includes a direction of travel of a roadway that is different from the direction of the sketch of the line, the electronic device weighs the first route segment less (or more negatively or unfavorably) than the second route segment having a direction of travel of roadway(s) that is the same as the direction of the sketch of the line. In some embodiments, the direction of the sketch of the line corresponds to the direction of the movement portion of the gesture in generating that sketch line. Other examples of other attributes are described below in more detail. In some embodiments, the electronic device receives user input (optionally when requesting to generate the route from the first respective location to the second respective location) identifying a cost threshold. For example, the cost threshold is optionally based on a length of time, such that a starting and/or ending time for traversing the route and/or a distance of travel of the route. In another example, the cost threshold is optionally based on an amount of fuel and/or energy available for traversing the route. In some embodiments, the electronic device calculates the cost of the route based on cost information associated with the one or more attributes of the movement portion of the gesture as described above with reference to method 900. For example, the electronic device optionally obtains cost information associated with traversing segments of the route from the first respective location to the second respective location, and modifies the cost information such that particular segments of the route are excluded or included when generating the route. In some embodiments, when the electronic device determines that a second route, different from the route as described above, satisfies the one or more criteria, the electronic device selects the second route instead of the first route. Generating a route from a first respective location to a second respective location based on one or more attributes of a movement portion of a gesture in response to receiving the gesture starting from a first location of the map area to a second location of the map area enables a user a faster means for generating the route efficiently via a quick sketch and based on both map data and the gesture, thereby reducing the need for subsequent inputs from a user to precisely select particular roadways and/or waypoints according to cost information when immediate routing guidance is desired, which reduces power usage and improves battery life of the electronic device by enabling the user to use the electronic device more quickly, efficiently, and control the route generated.

In some embodiments, the cost for the route is based on a first cost of the route from the first respective location to the second respective location irrespective of the movement portion of the gesture, such as a first cost output by cost function 822 component based on map data 838 in FIG. 8B, (e.g., based on the map data and not based on the gesture) and a second cost of the route from the first respective location to the second respective location that corresponds to (and/or is based on) the movement portion of the gesture, such as a second cost output by cost function 822 component based on sketch attributes 808 in FIG. 8B. In some embodiments, the first cost is determined by the electronic device by determining a first set of candidate route segments from the first respective location to the second respective location irrespective of locations on the map area corresponding to the movement portion of the gesture. For example, the first cost is optionally based on map data for the first set of candidate route segments. In some embodiments, a cost for a respective candidate route segment includes and/or is based on traffic information, travel direction, road closure information, or any other route information and/or characteristics as described with reference to method(s) 900, 1000, and/or 1100. In some embodiments, the electronic device determines the first set of candidate route segments based on costs related to traveling from the first respective location to the second respective location. In some embodiments, the costs are based on travel time, travel distance, fuel consumption, and/or energy consumption as described herein (e.g., method 1000) and/or method(s) 900 and/or 1100. In some embodiments, in response to receiving a different movement portion of the gesture from the first location of the map area to the second location of the map area, the first cost and the route from the first respective location to the second respective location irrespective of the movement portion of the gesture are the same as those corresponding to the received movement portion of the gesture.

In some embodiments, the second cost is determined by the electronic device by determining a second set of candidate route segments from the first respective location to the second respective location including respective locations or waypoints corresponding to locations on the map area corresponding to the movement portion of the gesture. For example, the second cost is optionally based on whether a respective candidate route segment is within a predetermined distance (e.g., 0.3, 0.5, 1, 10, 20, 50, or 100 kilometers) from a respective location corresponding to the movement portion of the gesture (e.g., the sketch). In some embodiments, the second cost is optionally based on whether the respective candidate route segment's direction of travel aligns with the direction of travel (e.g., the direction of movement) of the movement portion of the gesture. In some embodiments, the second set of candidate route segments include the costs (e.g., as described herein) related to traveling to the respective locations or waypoints that correspond to the locations on the map area corresponding to the movement portion of the gesture. In some embodiments, in response to receiving a different movement portion of the gesture from the first location of the map area to the second location of the map area, the second cost and the route from the first respective location to the second respective location that corresponds to the movement portion of the gesture are different from those corresponding to the received movement portion of the gesture. In some embodiments, the electronic device determines whether to include the first set of candidate route segments or the second set of candidate route segments including the respective locations or waypoints to the route from the first respective location to the second respective location, in part, by a cost function for evaluating the first cost compared to the second cost. In some embodiments, the cost function is weighted in accordance with user preference or additional map data. For example, a user of the electronic device optionally interacts with a user interface to indicate a preference for locations, waypoints, roads, and/or route segments with particular characteristics as described below (e.g., traffic condition, type of road, road speed, or scenic route availability). In some embodiments, the additional map data includes traffic metrics, road conditions, and/or the like. In some embodiments, the electronic device does not apply the respective waypoints that correspond to the locations on the map area corresponding to the movement portion of the gesture. For example, the electronic device optionally does not automatically include the respective waypoints that correspond to the locations on the map area corresponding to the movement portion of the gesture to the generated route. In some embodiments, the waypoints are identified and/or evaluated based on a cost analysis as described herein and below, as opposed to being defined explicitly by features of the movement portion of the gesture as in method 900. Generating the route based on comparing costs associated with including respective locations or waypoints corresponding to locations on the map area corresponding to the movement portion of the gesture enables a user a means for generating a cost efficient route via a sketch, thereby reducing the need for subsequent inputs from a user to precisely select particular roadways and/or waypoints along the route when immediate routing guidance is desired, which reduces power usage and improves battery life of the electronic device by enabling the user to use the electronic device more quickly, efficiently, and control the route generated.

In some embodiments, in response to (and/or while) receiving the gesture starting from the first location of the map area to the second location of the map area (e.g., as described above with reference to method 1000), the electronic device displays, via the display generation component, the map area including an indication of the cost for the route, such as shown by representation 756 notifying the user of the fuel cost to travel the route 746 in FIG. 7J. In some embodiments, the indication of the cost for the route is a visual or audible indication of the cost of the route presented to the user of the electronic device. In some embodiments, the indication is displayed concurrently with and/or overlaid on the map area. In some embodiments, and as described above with reference to method 900, the map area includes a sketch corresponding to the first location and the second location at which the gesture is received. In some embodiments, the electronic device displays the indication of the cost concurrently with and/or overlaid on the sketch. In some embodiments, the electronic device ceases to display the indication of the cost after a predetermined period of time (e.g., 2, 4, 6, 8, 10, 30, or 60 seconds). In some embodiments, the indication of the cost includes a user interface element that, when selected, causes the electronic device to dismiss or cease display of the indication of the cost. In some embodiments, the map area includes a user interface element that, when selected, causes the electronic device to cease displaying the indication of the cost for the route. In some embodiments, and as described with reference to method 900, the electronic device displays a representation of the generated route and the indication of the cost concurrently with and/or overlaid on the representation of the generated route. In some embodiments, the indication of the cost is a numerical or absolute indication of cost, such as presenting an indication of an amount of cost. In some embodiments, the indication of the cost is a descriptive or relative indication of the cost, such as presenting an indication of high, low, or medium cost. In some embodiments, the electronic device displays (concurrently with the generated route) one or more alternative generated routes. In some embodiments, the alternative generated routes indicate and/or correspond to different costs, such as high, low, or medium costs, and the alternative generated routes are generated in an analogous manner as the route. Displaying an indication of the cost for the route provides feedback to the user and enables a user a faster means for generating the route efficiently via a quick sketch, thereby reducing the need for subsequent inputs from a user to obtain the cost for the route when immediate routing guidance is desired, which reduces power usage and improves battery life of the electronic device by enabling the user to use the electronic device more quickly, efficiently, and control the route generated.

In some embodiments, the cost for the route is based on traffic information (or road information, speed information, or any other information associated with routing), such as traffic information provided by the cost function layers 824 in FIG. 8B. In some embodiments, the traffic information is based on real-time map data. In some embodiments, the traffic information is based on an analysis of historical map data. In some embodiments, the traffic information is based on the observed historical map data, using one or more machine-learning algorithms to analyze historical map data including trends to generate predicted traffic information. In some embodiments, the traffic information includes traffic information on roadways, other map features/elements that correspond to the one or more attributes of the movement portion of the gesture. In some embodiments, the electronic device considers traffic information on roads that are within the predetermined distance from the sketch as described with reference to method 900. In some embodiments, the traffic information is displayed concurrently with and/or overlaid on the map area and optionally has one or more of the characteristics of the indication of the cost for the route as described above. In some embodiments, the cost and/or traffic information is provided via one or more layered presentation modes or map information layers. For example, a first layer of the map area optionally includes roadways, parks, bodies of water, and/or points of interest, a second layer of the map area optionally includes the indication of the cost for the route as described above, and a third layer of the map area optionally includes the traffic information. In some embodiments, the third layer of the map area that includes traffic information optionally includes sub-layers for current, real-time traffic information and/or predicted traffic information as described herein. In some embodiments, the electronic device determines that a first cost for a first route associated with first traffic information is greater than a second cost of a second route that includes second traffic information that is less than the first traffic information (e.g., the second traffic information corresponds to more traffic than the first traffic). In some embodiments, the electronic device determines that the first route is further than the predetermined distance from the sketch and in response, the electronic device sets a first cost. In some embodiments, the first cost is higher than a second cost of a second route that is within the predetermined distance from the sketch. In some embodiments, the cost for a given route segment is smaller the closer it is to the sketch, and higher the further it is from the sketch. Determining the cost for the route based on traffic information provides feedback to the user and enables a user a faster means for generating the route efficiently via a quick sketch, thereby reducing the need for subsequent inputs from a user to obtain traffic information for the route when immediate routing guidance is desired, which reduces power usage and improves battery life of the electronic device by enabling the user to use the electronic device more quickly, efficiently, and control the route generated.

In some embodiments, the cost for the route includes cost information associated with the one or more attributes of the movement portion of the gesture, such as shown by sketch attributes 808 input into cost function 822 component in FIG. 8B. As described above and with reference to method(s) 900, 1000, and/or 1100, the electronic device determines respective locations or waypoints that correspond to locations on the map area corresponding to the one or more attributes of the movement portion of the gesture. In some embodiments, the cost for the route includes costs (e.g., as described above) related to traveling to the respective locations or waypoints that correspond to the locations or waypoints on the map area corresponding to the one or more attributes of the movement portion of the gesture. In some embodiments, and as will be described below, particular one or more attributes of the movement portion of the gesture are weighted to identify and/or select the respective locations, waypoints, roads or any other map features for inclusion in the generated route. Determining the cost for the route based on cost information associated with the one or more attributes of the movement portion of the gesture provides feedback to the user and enables a user a faster means for generating the route efficiently via a quick sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, the one or more attributes of the movement portion of the gesture include a (sharp) corner area, such as corner location 648 of the sketch 614a as shown in FIG. 6A, (e.g., as described with reference to method 900). For example, a sharp corner area optionally indicates a user's intent to include a respective location or waypoint in the route. In some embodiments, the cost function calculations as described above are weighted based, at least in part, on the observed one or more attributes of the movement portion of the gesture (e.g., sharp corner area). For example, the electronic device calculates a respective cost of a waypoint that corresponds to the sharp corner area different than a respective cost of a waypoint that does not correspond to the sharp corner area. In some embodiments, the respective cost of the waypoint that does not correspond to the sharp corner area is weighted greater (or less) than the respective cost of the waypoint that corresponds to the sharp corner area, and in some embodiments, the electronic device selects the waypoint with the lowest respective cost for the route. In some embodiments, the electronic device selects the waypoint with the highest respective cost for the route. In some embodiments, the sharper the corner, the lower the cost of including a corresponding waypoint in the generated route, and vice versa, as described with reference to method 900. In some embodiments, the further the waypoint (or other map feature) is located from the corner area, the higher the cost of including the respective waypoint (or other map feature) in the generated route, and vice versa. Determining the cost for the route that takes into account a sharp corner area of the movement portion of the gesture enables a user a faster means for generating the route efficiently via a quick sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, the one or more attributes of the movement portion of the gesture include a speed of the movement portion of the gesture, such as illustrated by part 616a of the sketch 614a in FIG. 6A, (e.g., as described with reference to method 900). For example, the electronic device determines a speed of the movement portion of the gesture is below a predetermined speed (e.g., 25, 50, 75, 100, 125, or 150 millimeters/second), and in response, the electronic device optionally interprets the slower speed of movement as indicative of a user's intent to include a respective location or waypoint or segment in the route corresponding to the slower speed of movement. In some embodiments and as described with reference to method 900, the first waypoint and/or the second waypoint is defined by a speed of travel (e.g., speed limit) along a respective road segment. For example, the electronic device includes a road segment that includes the identified waypoint (corresponding to slower speed of movement of the gesture) in the route because a respective cost of traveling along the road segment is less (e.g., because the road segment is associated with a higher speed limit) than a respective cost of traveling along another road segment (e.g., because the another road segment is associated with a lower speed limit). Determining the cost for the route that takes into account a speed of the movement portion of the gesture enables a user a faster means for generating the route efficiently via a quick sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, the one or more attributes of the movement portion of the gesture include selection of one or more locations of the map area, such as pinch hand shape 704a in a circular movement 724 in FIG. 7D, (e.g., as described with reference to method 900). For example, the one or more waypoints corresponding to the one or more locations received via the selection optionally indicate a user preference to include the one or more waypoints in the route. In some embodiments, the electronic device calculates a respective cost of a waypoint that corresponds to the selected location received via the gesture different than a respective cost of a waypoint that does not correspond to the selected location received via the gesture. In some embodiments, the respective cost of the waypoint that does not correspond to the selected location is weighted greater (or less) than the respective cost of the waypoint that corresponds to the selected location, and in some embodiments, the electronic device selects the waypoint with the lowest respective cost for the route. In some embodiments, the electronic device selects the waypoint with the highest respective cost for the route. In some embodiments, the selected waypoint is associated with a lower cost compared to the cost of waypoints that are not selected by the sketch. In some embodiments, the further the waypoint (or other map feature) is located from the selection location of the sketch, the higher the cost of including the respective waypoint (or other map feature) in the generated route. Determining the cost for the route that takes into account selection of one or more locations of the map area via the gesture enables a user a faster means for generating the route efficiently via a quick sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, the one or more criteria include a second criterion that is satisfied when the one or more attributes of the movement portion of the gesture correspond to a location on the map area that satisfies location criteria, such as waypoint 720 determined to be a significant waypoint in FIG. 7D, (e.g., a location that is significant to the map area, such as described with reference to method 900). In some embodiments, the electronic device determines that a location is significant from map information provided by a remote server as discussed above. For example, significant locations include cities, parks, points of interest, particular roadways, particular roadway characteristics such as intersections, turning ramps, exiting ramps, and/or the like. In some embodiments, the electronic device determines that the location is significant based on a determination that the electronic device was previously at the respective location for at least a threshold amount of time (e.g., 3 hours, 12 hours, 1 day, 1 week, or 3 weeks). In some embodiments, the electronic device matches the one or more attributes of the movement portion of the gesture described above and below to corresponding significant locations on the map area. In some embodiments, a significant location on the map area corresponds to the one or more attributes of the movement portion of the gesture. For example, and as described above and with reference to method 900, the location on the map area corresponds to a significant location at which the movement portion of the gesture includes a sharp corner area or a particular speed or change in speed. In some embodiments, the more significant the waypoint (or other map feature) is determined to be, the lower the cost of including the waypoint (or other map feature) in the generated route. Selecting the route that is based on a location criteria enables a user a means for generating the route efficiently via a sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, the one or more attributes of the movement portion of the gesture include identifying at least a portion of a user of the electronic device that is directed to the map area, such as the plurality of fingers of the hand 704g pointed towards map area 700 in FIG. 7G, (e.g., as described with reference to method 900). In some embodiments, the selected waypoint (or other map feature) identified via the gesture is associated with a lower cost compared to the cost of waypoints (or other map feature) that are not identified via the gesture. In some embodiments, the further the waypoint (or other map feature) is located from the location at which the gesture was received, the higher the cost of including the respective waypoint (or other map feature) in the generated route. Selecting the route that is based on identifying that at least a portion of the user of the electronic device is directed to the map area enables a user a means for generating the route efficiently via a sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and avoids unintentional activation or deactivation of route generation due to unintentional user interaction.

In some embodiments, the one or more attributes of the movement portion of the gesture include a voice input from a user of the electronic device received, via the one or more input devices (e.g., as described above), while receiving the gesture directed to the map area, such the electronic device receiving voice input 772 while detecting the pinch hand shape 704k in FIG. 7K, (e.g., as described with reference to method 900). In some embodiments, the selected waypoint (or other map feature) identified via the voice input is associated with a lower cost compared to the cost of waypoints (or other map feature) that are not identified via the voice input. In some embodiments, the further the waypoint (or other map feature) is located from the location of the gesture at which the voice input was received, the higher the cost of including the respective waypoint (or other map feature) in the generated route. Selecting the route that is based on a voice input received by the user of the electronic device while receiving the gesture enables a user a means for generating the route efficiently via a sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and avoids unintentional activation or deactivation of route generation due to unintentional user interaction.

In some embodiments, the one or more attributes of the movement portion of the gesture include activity history data associated with a user account of the electronic device, such as activity history data derived from map data 838 in FIG. 8A, (e.g., as described with reference to method 900). In some embodiments, the identified waypoint (or other map feature) based on the activity history data is associated with a lower cost compared to the cost of waypoints (or other map feature) that are not identified via the activity history data. Selecting the route that is based on activity history data enables a user a means for generating the route efficiently, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, the one or more attributes of the movement portion of the gesture include receiving, via the one or more input devices, an attention-based input (e.g., gaze-based input) from a user of the electronic device while receiving the gesture directed to the map area, such as attention 768 of the user directed to map area 700 in FIG. 7K, (e.g., as described with reference to method 900). In some embodiments, the selected waypoint (or other map feature) identified via the attention-based input is associated with a lower cost compared to the cost of waypoints (or other map feature) that are not identified via the attention-based input. In some embodiments, the further the waypoint (or other map feature) is located from the location at which the attention-based input was received, the higher the cost of including the respective waypoint (or other map feature) in the generated route. Selecting the route that is based on receiving an attention-based input while receiving the gesture enables a user a means for generating the route efficiently via a sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and avoids unintentional activation or deactivation of route generation due to unintentional user interaction.

In some embodiments, the cost information includes one or more cost factors determined by a user-defined setting, such as shown by sketch attributes 808 input into cost function 822 component in FIG. 8B. The one or more cost factors are optionally based on travel time, travel distance, fuel consumption, energy consumption, and any of the other cost metrics described with reference to method(s) 900, 1000, and/or 1100. In some embodiments, the electronic device presents an option and/or displays a user interface element that, when selected, causes the electronic device to weigh and/or ignore the one or more cost factors in accordance with the user-defined settings. For example, the electronic device optionally receives user-defined settings via the user interface element including voice input or attention-based input, that includes a first set of the one or more cost factors such as energy consumption and travel distance. In some embodiments, the user-defined settings optionally include a second set of the one or more cost factors such as energy consumption without consideration of travel distance. In some embodiments, in accordance with a determination that the electronic device receives a first user input that defines the user defined setting (e.g., to a first value), the electronic device includes cost factors or cost information associated with a first set of elements. In some embodiments, in accordance with a determination that the electronic device receives a second user input that defines the user defined setting (e.g., to a second value), the electronic device includes cost factors or cost information associated with a second set of elements, different from the first set of elements. In some embodiments, the first set of elements and/or the second set of elements include any of the one or more cost factors described herein. Generating the route based on one or more cost factors determined by a user-defined setting enables a user a means for generating a cost efficient route via a sketch, thereby reducing the need for subsequent inputs from a user to precisely select particular roadways and/or waypoints along the route when immediate routing guidance is desired, which reduces power usage and improves battery life of the electronic device by enabling the user to use the electronic device more quickly, efficiently, and control the route generated.

In some embodiments, the cost for the route is based on first cost information of a map region (and/or feature that is optionally included in the generated route) irrespective of (and/or independent of) the movement portion of the gesture and based on second cost information associated with the movement portion of the gesture (that optionally corresponds to the map region), such as second cost information derived from map data 838 in FIG. 8B. In some embodiments, the first cost information of the map region is determined by the electronic device by analyzing map data for the map region as described above with reference to method 900. The map region is optionally a portion of the map area that includes a particular feature or waypoint. In some embodiments, the electronic device utilizes the map data for generating the route including evaluating data, such as streets, highways, freeways, other roadways, waypoints, and/or the like of the map area irrespective of the movement portion of the gesture (e.g., irrespective of locations on the map region corresponding to the movement portion of the gesture). In some embodiments, the electronic device determines a cost of including the feature or waypoint in the generated route that is based on the map data as described herein. In some embodiments, the electronic device considers the cost of including the feature or waypoint in the generated route based on the one or more attributes of the movement portion of the gesture as described above. In some embodiments, the electronic device determines a total cost based on map data and the movement portion of the gesture. In some embodiments, in response to receiving a different movement portion of the gesture from the first location of the map area to the second location of the map area, the first cost and the route from the first respective location to the second respective location irrespective of the movement portion of the gesture are the same as a respective cost and route corresponding to the received movement portion of the gesture. In some embodiments, the second cost information includes respective locations or waypoints corresponding to locations on the map region corresponding to the movement portion of the gesture.

In some embodiments, in response to receiving a different movement portion of the gesture from the first location of the map area to the second location of the map area, the second cost and the route from the first respective location to the second respective location that corresponds to the movement portion of the gesture are different from a respective cost and route corresponding to the received movement portion of the gesture. In some embodiments, the electronic device considers the cost for the route based on the first cost information and the second cost information. In some embodiments, the electronic device compares the first cost information to the second cost information as described above to generate a cost efficient route. Generating the route based on first cost information irrespective of the movement portion of the gesture and second cost information based on the movement portion of the gesture enables a user a means for generating a cost efficient route via a sketch, thereby reducing the need for subsequent inputs from a user to precisely select particular roadways and/or waypoints along the route when immediate routing guidance is desired, which reduces power usage and improves battery life of the electronic device by enabling the user to use the electronic device more quickly, efficiently, and control the route generated.

In some embodiments, the electronic device applies a first waypoint for the route based on the one or more attributes of the movement portion of the gesture from the first location to the second location, such as applying waypoint 632 corresponding to the slower speed of movement as indicated by 616a in FIG. 6B, (e.g., as described with reference to method(s) 900 and/or 1100). In some embodiments, the electronic device applies the first waypoint for the route in response to the movement portion of the gesture. In some embodiments, the electronic device assigns a zero (or minimum) cost to the first waypoint and includes the first waypoint in the generated route. Identifying waypoints of a route based on one or more attributes of the movement portion of the gesture as described with reference to method(s) 900, 1000, and/or 1100 enables a user a faster means for generating the route efficiently via a quick sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, selecting the route from the first respective location to the second respective location is performed without defining (optionally any) waypoints for the route that are defined by the one or more attributes of the movement portion of the gesture, such as for example, selecting the route based on map data 838 in FIG. 8B. For example, the electronic device optionally determines to include a route segment, such as an interstate, that does not include a waypoint based on map data even though the movement portion of the gesture indicates the inclusion of a waypoint. In some embodiments, the electronic device assigns a high (or maximum) cost to a waypoint defined by the one or more attributes of the movement portion of the gesture and does not include the waypoint in the generated route. It is understood that although the embodiments described herein include locations of waypoints corresponding to the one or more attributes of the movement portion of the gesture, any number of other characteristics are optionally included, such as direction of the sketch compared to the direction of travel associated with respective route segments that include the waypoints and/or the like. In some embodiments, the respective weights of the route segments are based on a cost analysis as described above that is independent from the one or more attributes of the movement portion of the gesture. In some embodiments, the electronic device includes waypoints in the generated route independent of (e.g., without consideration of) any waypoints indicated in the sketch (e.g., as described with reference to methods 900, 1000 and/or 1100), and instead includes waypoints based on cost considerations as described herein with reference to method 1000. Generating the route irrespective of the one or more attributes of the movement portion of the gesture enables a user a means for generating a cost efficient route via a sketch, thereby reducing the need for subsequent inputs from a user to precisely select particular roadways and/or waypoints along the route when immediate routing guidance is desired, which reduces power usage and improves battery life of the electronic device by enabling the user to use the electronic device more quickly, efficiently, and control the route generated.

In some embodiments, in response to (and/or while) receiving the gesture starting from the first location of the map area to the second location of the map area (e.g., as described with reference to method(s) 900, 1000, and/or 1100), the electronic device displays, via the display generation component, the map area including a visual representation of the gesture corresponding to the first location and the second location at which the gesture is received, such as shown by sketch 614a in FIG. 6B. In some embodiments, the visual representation of the gesture has one or more characteristics of the sketch described with reference to method 900.

In some embodiments, in accordance with a determination that the visual representation does not satisfy one or more second criteria, the electronic device displays the visual representation with one or more modifications, such as for example, sketch 614b more closely resembling generated route 640 than the sketch 614b resembling sketch 614a in FIG. 6B. In some embodiments, the one or more second criteria includes a criterion that is satisfied when the visual representation of the gesture corresponds to roadways and/or intersections that are appropriate (e.g., follow road rules) for the generated route. For example, the visual representation of the gesture does not include deviations such as changes in travel direction and/or includes corresponding roadways or locations that are not reachable or do not follow road rules. In this example, the electronic device replaces portions of the visual representation of the gesture with such deviations with portions that do not have the deviations, such as using an adjacent road that permits the correct direction of travel in place of a road that does not permit the correct direction of travel. In some embodiments, the modifications include audio and/or visual indications that the visual representation of the gesture does not satisfy the one or more second criteria. For example, the electronic device optionally displays a modification of the visual representation of the gesture, different from the initial visual representation of the gesture. In some embodiments, the displayed visual representation of the gesture with modifications includes one or more corrections to the visual representation of the gesture that satisfy the one or more second criteria. In some embodiments, the electronic device displays the visual representation of the gesture with the modifications concurrently with the initial visual representation of the gesture (e.g., without the modifications). In some embodiments, the visual representation of the gesture differs from the initial visual representation of the gesture in one or more sections. In some embodiments, the electronic device optionally displays a prompt to accept or decline the visual representation of the gesture with modifications. For example, the electronic device displays a first option that, when selected, causes the electronic device to display the visual representation of the gesture with modifications. In another example, the electronic device displays a second option that, when selected, causes the electronic device to display the visual representation of the gesture without the modifications. In some embodiments, and as described herein, the electronic device automatically displays the visual representation of the gesture with modifications in accordance with a determination that the visual representation of the gesture does not satisfy the one or more second criteria. In some embodiments, the electronic device is continuously updating the visual representation of the gesture with modifications to satisfy the one or more second criteria (and/or to minimize the cost of the generated route). For example, while or in response to receiving additional user input, such as a new movement portion of the gesture, the electronic device displays a new, additional portion of the visual representation of the gesture and/or a modification of the already displayed portion of the visual representation of the gesture (e.g., because the generated route is optionally updated based on further user input in the sketch in accordance with the various factors described herein).

In some embodiments, in accordance with a determination that the visual representation of the gesture does satisfy the one or more second criteria, the electronic device displays the visual representation without the one or more modifications, such as for example, sketch 614b more closely resembling sketch 614a than the sketch 614b resembling generated route 640 in FIG. 6B. For example, the visual representation of the gesture does not correspond to roadways or locations that are not reachable or do not follow road rules. In some embodiments, the electronic device does not display the visual representation of the gesture with modifications in accordance with a determination that the one or more second criteria are satisfied. Displaying the sketch with or without modifications provides visual feedback, which simplifies the interaction between the user and the electronic device and enhances the operability of the electronic device, and indicates to the user an ability to enter a sketch that will be converted into a route quickly and efficiently.

In some embodiments, the one or more modifications to the visual representation are based on inferred user intent, such as intent inferred from voice input 726 in FIG. 7D. In some embodiments, the electronic device interprets the user's intent from voice input, attention-based input as described with reference to method 900, and/or the one or more attributes of the movement portion of the gesture as described herein and with reference to method 900. For example, when the electronic device detects the gaze of the user directed at a particular location of the map area for a period of time greater than a time threshold (e.g., 0.02, 0.05, 0.1, 0.2, 0.25, 0.3, 0.5, 1, 2, 3, or 5 seconds), the electronic device optionally infers from the gaze directed to the particular location that the user wants to include the particular location in the route rather than requesting further input from the user to select the particular location. In another example, when the electronic device receives voice input that includes keywords (e.g., “scenic route”, “avoid traffic”, “avoid highways”, “use XYZ street” and/or the like), the electronic device optionally infers from the voice input to generate a scenic route or a route that avoids highways rather than requesting further input from the user to select particular roadways and/or locations that satisfy the user's voice input. Generating the route based on inferred user intent enables a user a means for generating a route via a sketch, thereby reducing the need for subsequent inputs from a user to precisely select particular roadways and/or waypoints along the route when immediate routing guidance is desired, which reduces power usage and improves battery life of the electronic device by enabling the user to use the electronic device more quickly, efficiently, and control the route generated.

In some embodiments, the one or more modifications to the visual representation are based on road rules from map database 812 in FIG. 8B. In some embodiments, the electronic device receives or obtains road rules for the map area from a remote server as discussed above. For example, road rules optionally include laws of the road (e.g., right of way laws, roundabouts, sharing the road with pedestrians, bicyclists, and/or the like, and/or direction of travel rules) and regulatory signs (e.g., traffic direction signs, lane usage signs, turning control signs, speed limit signs, and/or other signs or rules that regulate movement). Generating the route based on road rules enables a user a means for generating a route via a sketch, thereby reducing the need for subsequent inputs from a user to precisely select particular roadways and/or waypoints along the route when immediate routing guidance is desired, which reduces power usage and improves battery life of the electronic device by enabling the user to use the electronic device more quickly, efficiently, and control the route generated.

In some embodiments, the generated route is based on a direction of the movement portion of the gesture, such as shown by sketch 728 corresponding to the gesture 706f in FIG. 7F. For example, when the electronic device determines the direction of the movement potion of the gesture, the electronic device generates a portion of the route including travel in a direction corresponding to the direction of the movement portion of the gesture. In some embodiments, when the electronic device determines that the direction of the movement portion of the gesture is from left to right (or right to left, or top to bottom, or bottom to top), the electronic device generates a route in a direction from left to right (e.g., corresponding to the direction of the movement portion of the gesture). In some embodiments, the electronic device determines that the visual representation of the gesture travels along and/or is parallel to a candidate road segment's direction of travel. In some embodiments, in accordance with a determination that the gesture includes a first direction, the electronic device generates the route including the candidate route segment traveling in the first direction corresponding to the first direction of the gesture. In some embodiments, in accordance with a determination that the gesture includes a second direction, different from the first direction, the electronic device generates the route including the candidate route segment traveling the second direction corresponding to the second direction of the gesture.

In some embodiments, the electronic device considers the cost for including the candidate route segment in the route. For example, if the first candidate route segment includes traveling in a direction that is the same as the direction of the gesture, the electronic device optionally assigns or sets a lower cost for that segment than a second candidate route segment (optionally along the same route segment) that includes traveling in a direction opposite from the direction of the gesture, which optionally means in some embodiments the generated candidate route direction of travel is opposite the direction of the gesture if, given other cost components, the cost of such a route segment is lower than the cost of such a route traveling along that segment in the opposite direction. Although, costs related to direction of travel is evaluated herein, the electronic device may evaluate other candidate route segment characteristics as described with reference to method(s) 900, 1000, and/or 1100 such that, for example, a second candidate route segment is included in the route despite being associated with a direction related cost that is greater than the direction related cost associated with the first candidate route segment as described herein. Generating a route based on a direction of the movement portion of the gesture enables a user a faster means for generating the route efficiently via a quick sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, the process to generate the route from the first respective location to the second respective location includes generating the route from the first respective location to the second respective location based on every portion of the gesture from the first location to the second location, such as shown by sketch 804 corresponding to the gesture being input into sketch processing circuitry 806 in FIG. 8B, (e.g., and without ignoring any portion of the gesture). For example, the electronic device optionally considers every attribute of the movement portion of the gesture when generating the route (e.g., and considers them in the ways described herein with reference to method 1000). The one or more attributes of the movement portion of the gesture are described with reference to method(s) 900, 1000, and/or 1100. In some embodiments, the electronic device identifies a plurality of candidate route segments including waypoints that may be added to the route. In some embodiments, the identified plurality of candidate route segments including waypoints are within the predetermined distance (e.g., as described above) from a respective location corresponding to any portion of the gesture. In some embodiments, after the plurality of candidate route segments including waypoints are identified, the electronic device evaluates the respective costs associated with including particular candidate route segments to the route.

In some embodiments, the segment cost and/or the predetermined cost threshold for the route is based on travel time, travel distance, fuel consumption, and/or energy consumption as described herein (e.g., method 1000) and/or method(s) 900 and/or 1100. For example, when determining the one or more candidate route segments to select for the route, the electronic device determines whether the one or more candidate route segments is below the predetermined cost threshold for the route. Generating a route based on every portion of the gesture from the first location to the second location enables a user a faster means for generating the route efficiently via a quick sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, generating the route is based on one or more directions of travel of one or more candidate route segments derived from map data 838 in FIG. 8B. For example, when considering whether to include a candidate route segment to the route, the electronic device evaluates the direction of travel of the candidate route segment. In some embodiments, the electronic device obtains a road parameter that includes a direction of the respective candidate route segment and determines a respective segment cost based on the direction. For example, a first respective candidate route segment that includes a direction that corresponds to the direction of the movement portion of the gesture optionally includes a first respective segment cost that is less than a respective segment cost of a second respective candidate route segment that includes a direction opposite from the direction of the movement portion of the gesture. In some embodiments, the electronic device includes the first respective candidate route segment in the route. In some embodiments, the electronic device includes the second respective route segment in the route. In some embodiments, the road parameters include a direction of the respective candidate route segment relative to a position of the electronic device. For example, the first respective candidate route segment optionally indicates a particular direction of travel, such as included with one-way roads, divided highways, and/or the like. In some embodiments, the electronic device considers the position of the electronic device when determining a respective segment cost. For example, a first respective candidate route segment that includes a maneuver in which the electronic device needs to change their direction of travel includes a first respective segment cost that is greater than a respective segment cost of a second respective candidate route segment that includes a maneuver in which the electronic device does not need to change their direction of travel. In this example, the electronic optionally includes the second respective segment in the route. In another example, the electronic device optionally includes the first respective segment in the route. Generating a route based on a direction of travel of a respective candidate route segment enables a user a faster means for generating the route efficiently via a quick sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, generating the route is based on one or more respective road parameters of one or more candidate route segments derived from map data 838 in FIG. 8B. In some embodiments, the electronic device obtains a road parameter that includes a road class of the respective candidate route segment and determines a respective segment cost based on the road class. In some embodiments, the road class of a respective candidate route segment indicates the type of road (e.g., dirt road, highways, toll roads, suburban roads, metropolitan roads, rural roads, and/or the like). For example, a first respective candidate route segment that includes a toll road optionally includes a first respective segment cost that is greater than a respective segment cost of a second respective candidate route segment that includes a highway. In some embodiments, the electronic device includes the first respective candidate route segment in the route. In some embodiments, the electronic device includes the second respective route segment in the route. Generating a route based on road class of a respective candidate route segment enables a user a faster means for generating the route efficiently via a quick sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, generating the route is based on one or more speed limits of one or more candidate route segments derived from map data 838 in FIG. 8B. In some embodiments, the electronic device obtains a road parameter that includes a speed limit of the respective candidate route segment and determines a respective segment cost based on the speed limit relative to the speed of the movement portion of the gesture. For example, a first respective candidate route segment that includes a speed limit that corresponds to the speed of the movement portion of the gesture optionally includes a first respective segment cost that is less than a respective segment cost of a second respective candidate route segment that includes a speed limit that does not correspond to the speed of the movement portion of the gesture. For example, the electronic device uses the speed of the movement portion to determine which of multiple possible roadways the portion of the gesture is meant to correspond to. In some embodiments, when the electronic device determines that the speed of the movement portion of the gesture is greater than a first speed threshold, the electronic device optionally infers from the speed to select a route segment that includes higher speed limits. For example, a first respective candidate route segment that includes a first speed limit that that is greater than a respective speed limit of a second respective candidate route includes a lower respective segment cost than the respective segment cost associated with the second respective candidate route segment. In some embodiments, the electronic device includes the first respective candidate route segment in the route. In some embodiments, the electronic device includes the second respective route segment in the route. Generating a route based on a speed limit of a respective candidate route segment relative to a speed of the movement portion of the gesture enables a user a faster means for generating the route efficiently via a quick sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, generating the route is based on one or more road surface types of one or more candidate route segments derived from map data 838 in FIG. 8B. In some embodiments, the electronic device obtains a road parameter that includes a road surface type of the respective candidate route segment and determines a respective segment cost based on the road surface type. In some embodiments, the road surface type of a respective candidate route segment indicates that the road includes gravel, pavement, sand, and/or the like. For example, a first respective candidate route segment that includes a paved road optionally includes a first respective segment cost that is less than a respective segment cost of a second respective candidate route segment that is unpaved. In some embodiments, the electronic device includes the first respective candidate route segment in the route. In some embodiments, the electronic device includes the second respective route segment in the route. Generating a route based on road surface type of a respective candidate route segment enables a user a faster means for generating the route efficiently via a quick sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, generating the route is based on one or more road widths of one or more candidate route segments derived from map data 838 in FIG. 8B. In some embodiments, the electronic device obtains a road parameter that includes a width of the road included in the respective candidate route segment and determines a respective segment cost based on the road width. For example, a first respective candidate route segment that includes a road width greater than a respective road width included in a second respective candidate route segment has a respective segment cost that is less than the respective segment cost associated with the second respective candidate route. In some embodiments, the electronic device includes the first respective candidate route segment in the route. In some embodiments, the electronic device includes the second respective route segment in the route. It is understood that although the embodiments described herein are directed to a width of the road included in the respective candidate route segment, any number of other road features or characteristics are optionally included, such relation of roadbed to lane surfaces, presence or absence of shoulders, and/or the like. Generating a route based on a width of the road included in the respective candidate route segment enables a user a faster means for generating the route efficiently via a quick sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, generating the route is based on one or more road lane counts (e.g., single lane, double lanes, multi-lane, and/or the like) or road topologies (e.g., lane lines, presence or absence of carpool lanes, special use lanes, and/or the like) of one or more candidate route segments derived from map data 838 in FIG. 8B. In some embodiments, the electronic device obtains a road parameter that includes a road lane count or topology of a road included in the respective candidate route segment and determines a respective segment cost based on the road lane count or topology of the road. For example, a first respective candidate route segment that includes at least two lanes optionally has a respective segment cost that is less than the respective segment cost associated with a second respective candidate route that includes one lane. In some embodiments, the electronic device includes the first respective candidate route segment in the route. In some embodiments, the electronic device includes the second respective route segment in the route. In another example, a first respective candidate route segment that includes a high occupancy vehicle (HOV) or carpool lane optionally has a respective segment cost that is less than the respective segment cost associated with a second respective candidate route that does not include a HOV lane. In this example, the electronic device optionally includes the first respective candidate route segment in the route. Generating a route based on a road lane count or topology of a road included in the respective candidate route segment enables a user a faster means for generating the route efficiently via a quick sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, generating the route is based on a time-based restriction of one or more candidate route segments derived from map data 838 in FIG. 8B. In some embodiments, the electronic device obtains a road parameter that includes a time-based restriction of a road included in the respective candidate route segment and determines a respective segment cost based on the time-based restriction. Examples of time-based restriction of the road optionally include “no left turns at intersection between 7-10 am”, “no right turns on weekdays”, “bus only lane on weekdays”, and/or the like. For example, a first respective candidate route segment that includes a time-based restriction includes a first respective segment cost that is greater than a respective segment cost of a second respective candidate route segment that does not include a time-based restriction. In some embodiments, the electronic device includes the first respective candidate route segment in the route. In some embodiments, the electronic device includes the second respective route segment in the route. In another example, the time-based restriction is enforced on the first respective candidate route segment at a time corresponding to a planned time of use of the first respective candidate route segment. In this example, the electronic device weighs the first respective segment cost of the first respective candidate route segment that includes the enforced time-based restriction that corresponds to the planned time of use of the first respective candidate route segment greater than a respective segment cost of a third respective candidate route segment that does not include a time-based restriction corresponding to a planned time of use of the third respective candidate route segment. Generating a route based on a time-based restriction of a road included in the respective candidate route segment enables a user a faster means for generating the route efficiently via a quick sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, generating the route is based on a transition from navigating along a candidate route segment according to a first mode to navigating along the candidate route segment according to a second mode, different from the first mode, such as shown by navigating along segment 730 via a driving mode of transportation and navigating along segment 738 via a walking mode of transportation in FIG. 7H. In some embodiments, the first mode has one or more of the characteristics of the first mode of transportation of method 900. In some embodiments, the second mode has one or more of the characteristics of the second mode of transportation of method 900. In some embodiments, the electronic device obtains a road parameter that includes a transition from navigating along the candidate route segment according to a first mode to navigating along the candidate route segment according to a second mode and the electronic device determines a respective segment cost based on the transition. Examples of such transitions include transitioning from driving to walking, walking to driving, driving to using public transportation, using public transportation to driving, and/or the like. For example, a first respective candidate route segment that includes any of the example transitions optionally includes a first respective segment cost that is greater than a respective segment cost of a second respective candidate route segment that does not include a transition. In some embodiments, the electronic device includes the first respective candidate route segment in the route. In some embodiments, the electronic device includes the second respective route segment in the route. Generating a route based on a transition from navigating along the candidate route segment according to a first mode to navigating along the candidate route segment according to a second mode enables a user a faster means for generating the route efficiently via a quick sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, the process to generate the route includes generating a first candidate route based on the first respective location, such as first location 714 in FIG. 7L, the second respective location, such as the waypoint 736 in FIG. 7L, and map data for the map area, such as map data 838 in FIG. 8B, (and not based on characteristics of the gesture other than identifying the first respective location and the second respective location, such as the movement portion of the gesture between the first respective location and the second respective location); In some embodiments, the map data has one or more of the characteristics of the map data of method(s) 900, 1000, and/or 1100.

In some embodiments, in accordance with a determination that the gesture has a first set of characteristics (e.g., one or more attributes of the movement portion of the gesture as described with reference to method(s) 900, 1000, and/or 1100), modifying the first candidate route in a first manner to generate the route, such as shown by the inclusion of first segment 636a in FIG. 6B. In some embodiments, the first manner includes cost information associated with the one or more attributes of the movement portion of the gesture as described with reference to method(s) 900, 1000, and/or 1100. For example, modifying the route in the first manner includes changing one or more first roadways and/or maneuvers included in the first candidate route, as described in more detail below. In some embodiments, modifying the first candidate route in the first manner to generate the route provides a lower cost than modifying the first candidate route in the second manner.

In some embodiments, in accordance with a determination that the gesture has a second set of characteristics different from the first set of characteristics, modifying the first candidate route in a second manner, different from the first manner, to generate the route, such as shown by the inclusion of segment 638c in FIG. 6B. For example, the first set of characteristics include a speed of movement of the gesture while the second set of characteristics include a direction of movement of the gesture. In some embodiments, modifying the second candidate route in the second manner provides a lower cost than modifying the first candidate route in the first manner. In some embodiments, the second manner includes cost information associated with the one or more respective road parameters obtained from the map data as described with reference to method(s) 900, 1000, and/or 1100. For example, modifying the route in the second manner includes changing one or more second roadways and/or maneuvers included in the second candidate route, as described in more detail below. Generating a route in a first manner or a second manner in accordance with determined gesture characteristics enables a user a faster means for generating the route efficiently via a quick sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, the first candidate route includes a first maneuver (e.g., turns, lane changes, merging, exiting, and/or the like), such as segment 636a in FIG. 6B. In some embodiments, in accordance with the determination that the gesture has the first set of characteristics (e.g., one or more attributes of the movement portion of the gesture as described with reference to method(s) 900, 1000, and/or 1100), the modification includes modifying the first maneuver, such as shown by part 646 of the sketch 614a corresponding to the gesture and modifying the first maneuver such that segment 636b is included in the generated route. For example, the electronic device optionally increases, decreases, or does not change a respective cost of the first maneuver such that the electronic device includes or excludes the respective candidate route segment that includes the first maneuver in the route. In some embodiments, the electronic device optionally increases, decreases, or does not change a respective cost of the first maneuver based on the first set of characteristics. In some embodiments, in accordance with a determination that the modification of the first maneuver results in a lower cost than a respective cost of the maneuver without the modification (e.g., the original first maneuver), the electronic device optionally elects to modify the first maneuver.

In some embodiments, in accordance with the determination that the gesture has the second set of characteristics, the modification does not include modifying the first maneuver, such as for example including segment 636a in FIG. 6B. In some embodiments, the second set of characteristics does not include the one or more attributes of the movement portion of the gesture. In some embodiments, the second manner includes cost information associated with the one or more respective road parameters obtained from the map data as described with reference to method(s) 900, 1000, and/or 1100. In some embodiments, in accordance with a determination that the modification of the first maneuver results in a greater cost than the respective cost of the maneuver without the modification (e.g., the original first maneuver), the electronic device foregoes modifying the first maneuver. Generating a route that includes a modified maneuver or does not include a modified maneuver in accordance with determined gesture characteristics enables a user a faster means for generating the route efficiently via a quick sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, determining the cost for the route includes weighing the map data for the map area against a respective route segment on the route corresponding to one or more weighted attributes of the movement portion of the gesture, such as for example weighing segment 636a against segment 636n in FIG. 6B. In some embodiments, the cost is determined by the electronic device by determining a respective route segment irrespective of a location on the map area corresponding to the movement portion of the gesture. In some embodiments, the cost is based on map data for the map area including consideration of the one or more respective road parameters obtained from the map data as described with reference to method(s) 900, 1000, and/or 1100. In some embodiments, the electronic device compares a respective cost that is based on map data to a respective cost of a route segment that corresponds to a location on the map area corresponding to the movement portion of the gesture as described with reference to method(s) 900, 1000, and/or 1100. In some embodiments, in accordance with a determination that adding a first respective route segment including its respective cost results in a lower cost for the route than the addition of a second respective route segment, the electronic device optionally elects to include the first respective route segment. In some embodiments, in accordance with a determination that adding the first respective route segment including its respective cost results in a greater cost for the route than the addition of a second respective route segment (and/or optionally compared to not adding the first respective route segment), the electronic device optionally forgoes adding the first respective route segment and optionally adds the second respective route segment. Generating the route based on comparing costs associated with including respective locations that correspond to locations on the map area corresponding to the movement portion of the gesture enables a user a means for generating a cost efficient route via a sketch, thereby reducing the need for subsequent inputs from a user to precisely select particular roadways and/or waypoints along the route when immediate routing guidance is desired, which reduces power usage and improves battery life of the electronic device by enabling the user to use the electronic device more quickly, efficiently, and control the route generated.

In some embodiments, determining the cost for the route includes weighing the map data for the map area against a respective waypoint on the route corresponding to one or more weighted attributes of the movement portion of the gesture, such as for example, the fuel cost to navigate the remainder of the route as indicated by representation 756 in FIG. 7J. In some embodiments, the cost is determined by the electronic device by determining a respective waypoint irrespective of a location on the map area corresponding to one or more weighted attributes of the movement portion of the gesture. In some embodiments, the cost is based on map data for the map area including consideration of respective waypoint corresponding to the one or more respective road parameters obtained from the map data as described with reference to method(s) 900, 1000, and/or 1100. In some embodiments, the electronic device determines a respective cost of traveling to the respective waypoint that is based on map data and the one or more weighted attributes of the movement portion of the gesture as described with reference to method(s) 900, 1000, and/or 1100.

In some embodiments, the electronic device determines that including a first respective waypoint to the route (that is based on map data and not the gesture) results in a lower cost for the route than the addition of a second respective waypoint (and/or than not including the first waypoint) that is based on the gesture. In response, the electronic device optionally elects to include the first respective waypoint. In some embodiments, in accordance with a determination that adding the first respective waypoint results in a greater cost for the route than the addition of the second respective waypoint (and/or than not including the first waypoint), the electronic device optionally forgoes adding the first respective waypoint and optionally adds the second respective waypoint. Generating the route based on comparing costs associated with including respective locations that correspond to one or more weighted attributes of the movement portion of the gesture enables a user a means for generating a cost efficient route via a sketch, thereby reducing the need for subsequent inputs from a user to precisely select particular roadways and/or waypoints along the route when immediate routing guidance is desired, which reduces power usage and improves battery life of the electronic device by enabling the user to use the electronic device more quickly, efficiently, and control the route generated.

In some embodiments, receiving the movement portion of the gesture directed to the map area includes detecting motion corresponding to a sequence of locations within the map area (e.g., as described with reference to method 900), such as movement of the pinch hand shape 704c in FIG. 7C. Displaying the sketch corresponding to the sequence of locations within the map area provides visual feedback, which simplifies the interaction between the user and the electronic device and enhances the operability of the electronic device, and indicates to the user an ability to enter a sketch that will be converted into a route quickly and efficiently.

In some embodiments, the motion corresponding to the sequence of locations within the map area is motion of a stylus providing the gesture to the map area (e.g., as described with reference to method 900), such as stylus input device 710a in FIG. 7A. Converting input from a stylus into a sketch enables a user a means for generating the route efficiently via a sketch, thereby reducing the need for subsequent inputs from a user to precisely select particular roadways and/or waypoints along the route when immediate routing guidance is desired, which reduces power usage and improves battery life of the electronic device by enabling the user to use the electronic device more quickly, efficiently, and control the route generated.

In some embodiments, the motion corresponding to the sequence of locations within the map area is motion of a portion of a user of the electronic device providing the gesture to the map area (e.g., as described with reference to method 900), such as tap input 706a in FIG. 7A. Converting input from a portion of the user of the electronic device into a sketch enables a user a means for generating the route efficiently via a sketch, thereby reducing the need for subsequent inputs from a user to precisely select particular roadways and/or waypoints along the route when immediate routing guidance is desired, which reduces power usage and improves battery life of the electronic device by enabling the user to use the electronic device more quickly, efficiently, and control the route generated.

In some embodiments, method 1100 is performed at an electronic device (e.g., electronic device 608 in FIG. 6A) in communication with one or more input devices and a display component (e.g., display component 610 in FIG. 6A). In some embodiments, the electronic device has one or more of the characteristics of the electronic device of method(s) 900 and/or 1000. In some embodiments, the one or more input devices have one or more of the characteristics of the one or more input devices of method(s) 900 and/or 1000. In some embodiments, the display generation component has one or more of the characteristics of the display generation component of method(s) 900 and/or 1000.

In some embodiments, while displaying, via the display generation component, a map area, the electronic device receives (1102a) via the one or more input devices, a gesture (e.g., a gesture including pinch hand shape 704a in FIG. 7A) starting from a first location of the map area (e.g., a location of map area 700 corresponding to a respective location of attention 702) to a second location of the map area (e.g., a location of map area 700 corresponding to a respective location of attention 620 in FIG. 7G) corresponding to a request to generate a route from a first respective location to a second respective location (e.g., such as described with reference to method 900). For example, the gesture is optionally received at the electronic device or at a second electronic device as described with reference to method 900. In some embodiments, initiating the process to generate the route has one or more processes as the processes included in initiating the process to generate the route at the remote server in communication with the electronic device and/or the local processor described above with reference to method 900. In some embodiments, the gesture starting from the first location of the map area to the second location of the map area corresponding to the request to generate the route from the first respective location to the second respective location has one or more of the characteristics of the gesture starting from the first location of the map area to the second location of the map area corresponding to the request to generate the route from the first respective location to the second respective location of method 900.

In some embodiments, in response to receiving the gesture starting from the first location of the map area to the second location of the map area, the electronic device initiates (1102b) a process to generate the route from the first respective location to the second respective location, such as the process to generate route 650 illustrated in FIG. 6C. In some embodiments, generating the route includes selecting a first waypoint for the route and a second waypoint for the route based on one or more parameters of a movement portion of the gesture (1102c), such as waypoint 630 and waypoint 632 in FIG. 6C. In some embodiments, the first waypoint and the second waypoint have one or more of the characteristics of the first waypoint and the second waypoint of method(s) 900 and/or 1000. For example, the route optionally goes from the first waypoint to the second waypoint. In some embodiments, the one or more parameters of the movement portion of the gesture is a measure of the one or more attributes of the movement portion of the gesture as described above with reference to method(s) 900 and 1000. For example, and as described in more detail below an attribute of the movement portion of the gesture optionally includes presence of sharp corners or other characteristics described above with reference to method 900 indicative of a request to include a respective waypoint in the route. In some embodiments, the electronic device matches the location of a sharp corner or other characteristic against map data at a respective location corresponding to the location of the sharp corner or other characteristic. For example, the map data optionally identifies a plurality of waypoints including the first waypoint and the second waypoint of the route (e.g., roadways, intersections, turn/exit ramps, and/or the like) at the respective location. In some embodiments, the electronic device selects the first waypoint and the second waypoint of the route based on the one or more parameters of the movement portion of the gesture (e.g., definition of the one or more attributes of the movement portion of the gesture). For example, the one or more parameters optionally define or influence map data utilized for generating route, such as the road class (e.g., highway, major road, or residential road), road surface type (e.g., gravel, paved, or sand), and/or speed limit of the road. Other parameters are included and are described in more detail below. In some embodiments, the electronic device selects the first waypoint and the second waypoint by weighting the one or more parameters and/or applying one or more waypoint constraints or cost criteria as described below and above with reference to method(s) 900 and/or 1000.

In some embodiments, generating the route includes refining the first waypoint or the second waypoint until the route satisfies one or more criteria, including a criterion that is satisfied based on a cost for the route (1102d), such as cost information output from the cost function 822 component in FIG. 8C, (e.g., as described above with reference to method 1000). In some embodiments, the electronic device optionally refines the one or more constraints and/or criteria described above. For example, the electronic device optionally refines the first waypoint or the second waypoint by adding, removing, or changing the cost for the route, the one or more waypoint constraints, and/or the one or more cost constraints. In some embodiments, the electronic device optionally refines the first waypoint or the second waypoint in response to the electronic device receiving user input to add, remove, or change the cost for the route, the one or more waypoint constraints, and/or the one or more cost constraints. In some embodiments, the electronic device continues to refine the first waypoint or the second waypoint such that the cost for the route does not exceed a predetermined cost threshold as described in method(s) 900 and/or 1000. Generating a route from a first respective location to a second respective location that includes refined waypoints based on one or more parameters of a movement portion of a gesture in response to receiving the gesture starting from a first location of the map area to a second location of the map area enables a user a faster means for generating the route efficiently via a quick sketch and based on cost for the route, thereby reducing the need for subsequent inputs from a user to precisely select particular roadways and/or waypoints according to cost information when immediate routing guidance is desired, which reduces power usage and improves battery life of the electronic device by enabling the user to use the electronic device more quickly, efficiently, and control the route generated.

In some embodiments, refining the first waypoint or the second waypoint until the route satisfies the one or more criteria includes in accordance with a determination that a constraint is provided by a user of the electronic device, applying the constraint provided by the user of the electronic device to the route (optionally independent of a cost of including the constraint in the route), such as adding waypoint 720 in response to detecting a gesture including a circular movement of a pinch hand shape 704a in FIG. 7D. In some embodiments, the constraint has one or more characteristics of a waypoint constraint as described with reference to method 900. In some embodiments, a constraint includes a user preference for a particular location, waypoint, road, and/or route segment with particular characteristics (e.g., traffic condition, type of road, road speed, or scenic route availability) as described with reference to method 1000. In some embodiments, the electronic device receives the constraint via voice input provided by the user of the electronic device. In some embodiments, the electronic device presents a user interface element that, when selected, causes the electronic device to obtain the constraint provided by the user of the electronic device. In some embodiments, the electronic device receives user input corresponding to a request to add, remove, or change a constraint as described with reference to method(s) 900 and/or 1000. In some embodiments, when the electronic device determines that the cost for adding the constraint provided by the user of the electronic device exceeds the predetermined cost threshold as described in method(s) 900 and/or 1000, the electronic device applies the constraint provided by the user. In some embodiments, when the electronic device determines that the cost for adding the constraint provided by the user of the electronic device exceeds the predetermined cost threshold, the electronic device presents (via audio or via a user interface display notification) that the adding the constraint provided by the user of the electronic device exceeds the predetermined cost threshold and optionally an option that, when selected, confirms that the user wants to add the constraint to which the electronic device applies the constraint.

In some embodiments, refining the first waypoint or the second waypoint until the route satisfies the one or more criteria includes in accordance with a determination that the constraint is provided by an entity other than the user of the electronic device (e.g., computer generated constraint or a constraint derived from map data) and the constraint satisfies one or more respective criteria, including a criterion that is satisfied based on a cost for adding the constraint to the route, applying the constraint provided by the entity other than the user of the electronic device to the route, such as shown by the inclusion of segment 638c in FIG. 6C instead of segment 638b in FIG. 6B. For example, when the electronic device determines that the cost for adding the constraint to the route does not exceed the predetermined cost threshold as described in method(s) 900 and/or 1000, the electronic device optionally applies the constraint provided by the entity.

In some embodiments, refining the first waypoint or the second waypoint until the route satisfies the one or more criteria includes in accordance with a determination that the constraint is provided by an entity other than the user of the electronic device and the constraint does not satisfy the one or more respective criteria, forgoing applying the constraint provided by the entity other than the user of the electronic device to the route, such as, for example, including segment 638b in FIG. 6B instead of segment 638c in FIG. 6C. For example, when the electronic device determines that the cost for adding the constraint to the route does exceed the predetermined cost threshold as described in method(s) 900 and/or 1000, the electronic device optionally foregoes applying the constraint provided by the entity. Applying a constraint in accordance with a determination that the constraint is provided by the user or by an entity other than the user; and in accordance with a determination that adding the constraint satisfies one or more criteria enables a user a means for generating the route efficiently via a sketch, thereby reducing the need for subsequent inputs from a user to precisely select particular roadways and/or waypoints along the route when immediate routing guidance is desired, which reduces power usage and improves battery life of the electronic device by enabling the user to use the electronic device more quickly, efficiently, and control the route generated.

In some embodiments, refining the first waypoint or the second waypoint is based on a direction of a segment of the route, such as shown by segment 638c having a direction north to south in FIG. 6C, or a direction of the segment of the route relative to a position of the electronic device, such as for example as shown in FIG. 6C where the proposed next segment of route 650 of the route from first location or first waypoint 626 optionally has the electronic device taking a right turn onto a segment of route 650 based on the position of the electronic device, (e.g., as described with reference to method(s) 900 and/or 1000). Generating a route based on a direction of a respective candidate route segment enables a user a faster means for generating the route efficiently via a quick sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, refining the first waypoint or the second waypoint is based on a road class of a segment of the route, such as map data 838 obtained from map database 812 in FIG. 8C, (e.g., as described with reference to method(s) 900 and/or 1000). Generating a route based on road class of a respective candidate route segment enables a user a faster means for generating the route efficiently via a quick sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, refining the first waypoint or the second waypoint is based on a speed limit of a segment of the route relative to a speed of the movement portion of the gesture, such as shown by the slower speed of movement as indicated by 616a in FIG. 6C, (e.g., as described with reference to method(s) 900 and/or 1000). Generating a route based on a speed limit of a respective candidate route segment relative to a speed of the movement portion of the gesture enables a user a faster means for generating the route efficiently via a quick sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, refining the first waypoint or the second waypoint is based on a road surface type of a segment of the route, such as map data 838 obtained from map database 812 in FIG. 8C, (e.g., as described with reference to method(s) 900 and/or 1000). Generating a route based on road surface type of a respective candidate route segment enables a user a faster means for generating the route efficiently via a quick sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, wherein refining the first waypoint or the second waypoint is based on a road specification of a segment of the route, such as map data 838 obtained from map database 812 in FIG. 8C, (e.g., as described with reference to method(s) 900 and/or 1000). In some embodiments, the road specification includes a width of a road included in the respective candidate route segment or relation of roadbed to lane surfaces, presence or absence of shoulders, and/or other road specifications as described with reference to method 900. Generating a route based on a road specification of a segment of the route enables a user a faster means for generating the route efficiently via a quick sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, refining the first waypoint or the second waypoint is based on a road lane count or topology of a segment of the route, such as map data 838 obtained from map database 812 in FIG. 8C, (e.g., as described with reference to method(s) 900 and/or 1000). Generating a route based on a road lane count or topology of a road included in the respective candidate route segment enables a user a faster means for generating the route efficiently via a quick sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, refining the first waypoint or the second waypoint is based on a road time-based restriction of a segment of the route, such as map data 838 obtained from map database 812 in FIG. 8C, (e.g., as described with reference to method(s) 900 and/or 1000). Generating a route based on a time-based restriction of a road included in the respective candidate route segment enables a user a faster means for generating the route efficiently via a quick sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, refining the first waypoint or the second waypoint is based on a transition from navigating along a segment of the route according to a first mode to navigating along the segment of the route according to a second mode, different from the first mode, such as shown by navigating along segment 730 via a driving mode of transportation and navigating along segment 738 via a walking mode of transportation in FIG. 7H. (e.g., as described with reference to method(s) 900 and/or 1000). Generating a route based on a transition from navigating along the candidate route segment according to a first mode to navigating along the candidate route segment according to a second mode enables a user a faster means for generating the route efficiently via a quick sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, generating the route includes generating a first segment of the route between the first respective location and the first waypoint according to a first mode of transportation, such as navigating along segment 730 via a driving mode of transportation. In some embodiments, the first mode has one or more of the characteristics of the first mode of transportation of method 900.

In some embodiments, in accordance with a determination that the first waypoint satisfies one or more second criteria, including a criterion that is satisfied when a characteristic of the first waypoint indicates a start of a second mode of transportation, different from the first mode of transportation, the electronic device generates a second segment of the route between the first waypoint and the second waypoint (and/or a next location in the generated route) according to the second mode of transportation, such as segment 738 using a walking mode of transportation in FIG. 7H. In some embodiments, the second mode has one or more of the characteristics of the second mode of transportation of method 900. In some embodiments, the characteristic of the first waypoint includes a particular road class and/or road surface type, such as a railway or railroad tracks on which trains run indicative of a particular mode of transportation. In some embodiments, in response to a determination that first waypoint includes railroad tracks or another characteristic indicative of a particular mode of transportation, the electronic device generates the second segment of the route according to the second mode of transportation. For example, the electronic device optionally presents navigation information corresponding to the second mode of transportation. In another example, the electronic device optionally presents information related to the mode of transportation, such as a train schedule, train ticket costs, parking information, and/or the like. In another example, the second segment of the route optionally includes a waypoint corresponding to a parking lot of a train station and in response to a determination that the second segment of the route optionally includes a parking lot of a train station, the electronic device generates the second segment using the train. In some embodiments, a particular type of waypoint, such as train stations, airports, marinas, bike hubs, taxi stands, and/or the like indicate a respective mode of transportation and/or a switch to a different mode of transportation, while other types of waypoints (e.g., restaurants, stores, sports arenas or hotels) do not. In some embodiments, adding a waypoint includes a determination that the waypoint includes a respective segment connected to the waypoint indicative of a particular mode of transportation based on map data. For example, the electronic device optionally includes a first segment that includes travel from a first waypoint to the airport waypoint via a driving mode of transportation; a second segment that includes travel from the airport waypoint to the airport terminal via a tram; and a third segment that includes travel from the airport terminal to the destination waypoint via airplane. It is understood that although the embodiments described herein are directed to trains (e.g., land and rail) or airplanes, any number of other modes for transportation are optionally included, such as water, cable, and/or the like.

In some embodiments, in accordance with a determination that the first waypoint does not satisfy the one or more second criteria, the electronic device generates the second segment of the route between the first waypoint and the second waypoint according to the first mode of transportation, such as segment 738 using a driving mode of transportation instead of a walking mode of transportation as shown in FIG. 7H. For example, the electronic device optionally determines that the second segment of the route does not include a characteristic (e.g., railroad tracks) or a waypoint (e.g., train station) indicative of a mode of transportation, different from the first mode of transportation. Generating a route based on a mode of transportation enables a user a faster means for generating the route efficiently via a quick sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, generating the route includes displaying, via the display generation component, the map area including a user interface element that, when selected, causes the electronic device to confirm user intent to generate the route that includes the first waypoint and the second waypoint based on the one or more parameters of the movement portion of the gesture, such as a user interface element similar to notification 740a in FIG. 7H. For example, in response to selecting the first waypoint for the route and the second waypoint for the route based on the one or more parameters of the movement portion of the gesture as described with reference to method(s) 900, 1000, and/or 1100, the electronic device optionally displays the user interface element. In some embodiments, the user interface element includes a first option that, when selected, confirms generating the route that includes the selected first waypoint and the second waypoint. In some embodiments, the user interface element includes a second option that, when selected, declines or forgoes including the selected the first waypoint and the second waypoint in the route. In some embodiments, the user interface element includes a third option that, when selected, causes the electronic device to add or decline including either or both the first waypoint and the second waypoint. In some embodiments, the user interface element includes a fourth option that, when selected, causes the electronic device to receive a user selected waypoint, different from the first waypoint and the second waypoint as described with reference to method(s) 900, 1000, and/or 1100. Displaying a user interface element confirming user intent to generate the route that includes the first waypoint and the second waypoint based on the one or more parameters of the movement portion of the gesture enables a user a means for generating a route via a sketch, thereby reducing the need for subsequent inputs from a user to precisely select particular roadways and/or waypoints along the route when immediate routing guidance is desired, which reduces power usage and improves battery life of the electronic device by enabling the user to use the electronic device more quickly, efficiently, and control the route generated.

In some embodiments, selecting the first waypoint and the second waypoint for the route, such as first waypoint 626 and second waypoint 628 in FIG. 6C, based on the one or more parameters of the movement portion of the gesture, such as shown by sketch 804 from input device 802 in FIG. 8C, and refining the first waypoint or the second waypoint until the route satisfies the one or more criteria (e.g., as described with reference to method 1000) is in accordance with a determination that the electronic device is associated with a first connection type (e.g., Wi-Fi connection).

In some embodiments, generating the route includes in accordance with a determination that the electronic device is associated with a second connection type (e.g., cellular data connection, such as 7G) different from the first connection type, selecting a segment of the route between the first waypoint and the second waypoint independent from the one or more attributes of the movement portion of the gesture corresponding to locations on the map area between the first waypoint and the second waypoint, such as selected the segment based on map data 838 from map database 812 in FIG. 8C, (e.g., as described with reference to method 900).

In some embodiments, generating the route includes in accordance with a determination that the electronic device is associated with a third connection type (e.g., cellular data connection, such as EDGE), different from the first connection type and the second connection type, selecting the first waypoint for the route and the second waypoint for the route based on the one or more parameters of the movement portion of the gesture without refining the first waypoint of the second waypoint until the route satisfies the one or more criteria, such as without processes 830a and 830b to refine the route in FIG. 8C, (e.g., as described with reference to method 1000). In some embodiments, when the electronic device determines a change from connection type A (e.g., second connection type or any of the other connection types) to connection type B (e.g., first connection type or any of the other connection types other than the connection type A), the electronic device generates the route in accordance with the changed connection type (e.g., connection type B) as described herein. In some embodiments, the electronic device presents an option that, when selected, causes the electronic device to generate a route in accordance with the described method of selecting the first waypoint and the second waypoint for the route based on the one or more parameters of the movement portion of the gesture and refining the first waypoint or the second waypoint until the route satisfies the one or more criteria as described with reference to method 1000 irrespective of the connection type. For example, the electronic device provides an option to perform said method of generating the route when the connection type is a connection type other than the first connection type (e.g., the second connection type or the third connection type). In some embodiments, the electronic device changes the method of generating the route in response to a determined performance level (e.g., connection reliability, bandwidth, power consumption, and/or the like). Generating a route based on a connection type enables a user a faster means for generating the route efficiently via a quick sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, after initiating the process to generate the route from the first respective location to the second respective location (e.g., as described with reference to method 1000), the electronic device displays, via the display generation component, the map area including a user interface element that, when selected, causes the electronic device to share the route with a second electronic device, different from the electronic device, such as user interface element 782a in FIG. 7M. In some embodiments, the second electronic device has one or more of the characteristics of the electronic device of method 900. In some embodiments, the second electronic device and the electronic device are associated with a same user account. In some embodiments, the second electronic device and the electronic device area associated with different user accounts. In some embodiments, the generated route is shared with other electronic devices, for example, using a maps application, messaging application, an email application, and/or a wireless ad hoc service. In some embodiments, sharing with the route with the second electronic device includes a preview image of the route that, when selected, causes the second electronic device to display the route via the display generation component of the second electronic device. In some embodiments, causing the electronic device to share the route with the second electronic device includes a request from the electronic device to the second electronic device to enter a shared communication session (e.g., live conversation) between the electronic device and the second electronic device during which changes or modifications (e.g., as described with reference to method(s) 900, 1000, and/or 1100) made to the route are shared and/or displayed by the electronic device and the second electronic device in real-time (or near real-time or dynamically). Providing means for sharing the route between electronic devices simplifies the interaction between the user and the electronic device and enhances the operability of the electronic device (e.g., by providing a sharing option without having to navigate to another application and/or user interface), thereby improving the interaction between the user and the electronic device and ensuring consistency of information displayed across different devices.

In some embodiments, generating the route includes in accordance with a determination that the movement portion of the gesture indicates a third waypoint for the route and not a fourth waypoint for the route, generating a route from the first respective location to the second respective location including the third waypoint and not the fourth waypoint, wherein the route from the first respective location to the second respective location including the third waypoint has a first cost, such as for example, including segment 636b and its associated cost in FIG. 6C is less than a respective cost associated with segment 636a in FIG. 6A. In some embodiments, the third waypoint is different from the fourth waypoint. In some embodiments, the third waypoint and the fourth waypoint have one or more of the characteristics of the first waypoint and/or the second waypoint of method 1000. In some embodiments, the electronic device determines that the movement portion of the gesture indicates the third waypoint for the route when the third waypoint corresponds to the one or more attributes of the movement portion of the gesture as described with reference to method(s) 900, 1000, and/or 1100. In some embodiments, the electronic device determines that the fourth waypoint does not correspond to the one or more attributes of the movement portion of the gesture. In some embodiments, the electronic device determines that both the third waypoint and the fourth waypoint correspond to the one or more attributes of the gesture and further determines to include the third waypoint and not the fourth waypoint for the route based on respective costs associated with the third waypoint and the fourth waypoint as described herein. In some embodiments, the third waypoint is selected by the electronic device and not the fourth waypoint as described with reference to method(s) 900, 1000, and/or 1100. In some embodiments, the third waypoint is selected by the user and not the fourth waypoint as described with reference to method(s) 900, 1000, and/or 1100. In some embodiments, the electronic device determines a first cost associated with the third waypoint as described with reference to method(s) 900, 1000, and/or 1100. In some embodiments, the first cost associated with the third waypoint does not satisfy the one or more criteria related to the cost for the route described above with reference to method 1000. For example, the electronic device includes the third waypoint irrespective of the first cost associated with the third waypoint (e.g., inclusion of the first cost associated with the third waypoint is determined to exceed the predetermined cost threshold as described in method 1000). In some embodiments, the first cost associated with the third waypoint does satisfy the one or more criteria related to the cost for the route described above with reference to method 1000. In some embodiments, the third waypoint replaces one or more of the first waypoint and/or the second waypoint (e.g., removal of the first waypoint and/or the second waypoint as described with reference to method 900). In some embodiments, the route that is generated by the electronic device includes the third waypoint and one or more of the first waypoint and/or the second waypoint.

In some embodiments, generating the route includes in accordance with a determination that the movement portion of the gesture indicates the fourth waypoint different from the third waypoint for the route and does not indicate the third waypoint for the route, generating a route from the first respective location to the second respective location including the fourth waypoint and not the third waypoint, wherein the route from the first respective location to the second respective location including the fourth waypoint has a second cost different from the first cost, such as for example, including segment 636a in FIG. 6A instead of segment 636b in FIG. 6C. It is understood that although the embodiments described herein are directed to the third waypoint, such functions and/or characteristics optionally apply to other waypoints including the fourth waypoint. In some embodiments, the second cost is greater than (or less than or equal to) the first cost. In some embodiments, the fourth waypoint replaces one or more of the first waypoint, the second waypoint, and/or the third waypoint. In some embodiments, the route that is generated by the electronic device includes the fourth waypoint and one or more of the first waypoint, the second waypoint, and/or the third waypoint. Generating a route based on a determination that the movement portion of the gesture indicates a particular waypoint (optionally, irrespective of a respective cost) enables a user a faster means for generating the route efficiently via a quick sketch, thereby reducing the need for subsequent inputs from a user to precisely select particular roadways and/or waypoints when immediate routing guidance is desired, which reduces power usage and improves battery life of the electronic device by enabling the user to use the electronic device more quickly, efficiently, and control the route generated.

In some embodiments, generating the route includes generating a portion of the route between the first waypoint and the second waypoint based on cost irrespective of the movement portion of the gesture corresponding to the portion of the route between the first waypoint and the second waypoint, such as for example including segment 636b in FIG. 6B, (e.g., as described with reference to method 1000). Generating the route based on costs irrespective of locations or waypoints that correspond to locations on the map area corresponding to the movement portion of the gesture enables a user a means for generating a cost efficient route via a sketch, thereby reducing the need for subsequent inputs from a user to precisely select particular roadways and/or waypoints along the route when immediate routing guidance is desired, which reduces power usage and improves battery life of the electronic device by enabling the user to use the electronic device more quickly, efficiently, and control the route generated.

In some embodiments, generating the portion of the route between the first waypoint and the second waypoint includes determining a first cost of a first candidate portion of the route between the first waypoint, such as segment 638b in FIG. 6B, and the second waypoint and a second cost of a second candidate portion of the route between the first waypoint and the second waypoint, such as segment 638c in FIG. 6C. In some embodiments, the first candidate portion of the route and/or the second candidate portion of the route has one or more characteristics as the candidate route segments described with reference to method 1000. For example, the first candidate portion of the route and/or the second candidate portion of the route optionally include one or more respective locations or waypoints corresponding to the locations at which the gesture is received as described with reference to method(s) 900, 1000, and/or 1100. In some embodiments, the first cost and/or second cost is associated with time, distance, and/or energy to traverse the respective candidate portion of the route. In some embodiments, the first cost and/or the second cost has one or more of the characteristics of costs associated with the candidate route segments and/or waypoints and/or is determined by the electronic device as described with reference to method 1000.

In some embodiments, in accordance with a determination that the first cost is less than the second cost, the electronic device uses the first candidate portion of the route between the first waypoint and the second waypoint as the portion of the route between the first waypoint and the second waypoint, such as using segment 638c in FIG. 6C.

In some embodiments, in accordance with a determination that the second cost is less than the first cost, the electronic device uses the second candidate portion of the route between the first waypoint and the second waypoint as the portion of the route between the first waypoint and the second waypoint, such as using segment 638b in FIG. 6B. For example, the electronic device optionally determines the portion of the route between the first waypoint and the second waypoint that is an optimal path and includes an efficient use of time, distance, and/or energy as described with reference to method(s) 900, 1000, and/or 1100. Generating the route based on efficient use of time, distance, and/or energy enables a user a means for generating the route efficiently via a sketch, thereby reducing the need for subsequent inputs from a user to precisely select particular roadways and/or waypoints that include efficient use of time, distance, and/or energy when immediate routing guidance is desired, which reduces power usage and improves battery life of the electronic device by enabling the user to use the electronic device more quickly, efficiently, and control the route generated.

In some embodiments, the selected first waypoint and the selected second waypoint are different from the refined first waypoint and the refined second waypoint, such as waypoint 632 in FIG. 6B is different from waypoint 632 in FIG. 6C. For example, the selected first waypoint and the selected second waypoint are optionally associated with a cost that is greater than the cost associated with the refined first waypoint and the refined second waypoint (e.g., the cost of the route between the selected first waypoint and the selected second waypoint is greater than (or less than) the cost of the route between the refined first waypoint and the refined second waypoint). In some embodiments, the selected first waypoint and the selected second waypoint are the same as the refined first waypoint and the refined second waypoint. In some embodiments, the refined first waypoint and the refined second waypoint are associated with a route that includes one or more respective road parameters different from the respective road parameters associated with the route of the selected first waypoint and the selected second waypoint as described below and with reference to method 1000. In some embodiments, the electronic device adds the refined first waypoint and the second waypoint to the route, and does not add the first waypoint and the refined second waypoint to the route (optionally based on case, as described with reference to method 1000). In some embodiments, the electronic device adds the refined first waypoint and the second waypoint to the route based on cost, as described with reference to method 1000. For example, the electronic device optionally determines that a respective cost for adding the refined first waypoint and the second waypoint to the route is less than a respective cost for adding the first waypoint and the refined second waypoint. Generating the route based a variety of selected and/or refined waypoints enables a user a means for generating the route efficiently via a sketch, thereby reducing the need for subsequent inputs from a user to precisely select particular roadways and/or waypoints that include efficient use of time, distance, and/or energy when immediate routing guidance is desired, which reduces power usage and improves battery life of the electronic device by enabling the user to use the electronic device more quickly, efficiently, and control the route generated.

In some embodiments, the refined first waypoint and the refined second waypoint are based on the one or more parameters of the movement portion of the gesture, such as shown by sketch attributes 826a input into constraint processing circuitry 810 and map data for the map area, such as map data 838 input into constraint processing circuitry 810 in FIG. 8C. In some embodiments, the electronic device determines that the one or more attributes of the movement portion of the gesture indicate the first waypoint and/or the second waypoint as described above. In some embodiments, the electronic device optionally refines the first waypoint or the second waypoint in response to the electronic device receiving user input to add, remove, or change the cost for the route, the one or more waypoint constraints, and/or the one or more cost constraints as described above. In some embodiments, as the electronic device refines the first waypoint and/or the second waypoint, a respective cost associated with the first waypoint and/or the second waypoint optionally increases or decreases as the refined first waypoint and/or the second waypoint changes from the original first waypoint and the second waypoint. In some embodiments, although the respective cost optionally increases, the electronic device elects to add the refined first waypoint and/or second waypoint as other cost factors are considered as described with above. For example, the electronic device selects the first waypoint and the second waypoint based on both the one or more parameters of the movement portion of the gesture as described above with reference to method(s) 900 and/or 1000 (e.g., the first location, the second location, and the one or more attributes of the movement portion of the gesture) and map data for the map area as described above with reference to method(s) 900 and/or 1000. Generating a route based on the one or more parameters of the movement portion of a gesture in response to receiving the gesture starting from a first location of the map area to a second location of the map area enables a user a faster means for generating the route efficiently via a quick sketch and based on both map data and the gesture, thereby reducing the need for subsequent inputs from a user to precisely select particular roadways and/or waypoints according to cost information when immediate routing guidance is desired, which reduces power usage and improves battery life of the electronic device by enabling the user to use the electronic device more quickly, efficiently, and control the route generated.

In some embodiments, after refining the first waypoint and the second waypoint until the route satisfies the one or more criteria, the electronic device displays, via the display generation component, the refined first waypoint and the refined second waypoint, such as shown by waypoint 632 in FIG. 6C.

In some embodiments, while displaying, the refined first waypoint and the refined second waypoint, the electronic device receives, via the one or more input devices, user input corresponding to a request to change the refined first waypoint or the refined second waypoint, such as for example, similar to user input to add waypoint 774 in FIG. 7K.

In some embodiments, in response to receiving the user input, the electronic device initiates a process to generate the route that includes the request to change the refined first waypoint or the refined second waypoint, such as shown with the addition of segment 776b and 778 in FIG. 7L. In some embodiments, the electronic device determines that the user input corresponding to the request to change the refined first waypoint or the refined second waypoint includes a request to remove, add, or change the refined first waypoint and/or the refined second waypoint as described with reference to method(s) 900 and/or 1000. In some embodiments, the electronic device determines that the request to change the refined first waypoint or the refined second waypoint satisfies the one or more criteria, including a second criterion that is satisfied based on road rules for the route (e.g., as described with reference to method(s) 900 and/or 1000). In some embodiments, in accordance with a determination the request to change the refined first waypoint or the refined second waypoint satisfies the one or more criteria, the electronic device includes the change request provided by the user of the electronic device to the route. In some embodiments, the electronic device receives user selected waypoints as described with reference to method(s) 900 and/or 1000. In some embodiments, the electronic device includes the change request provided by the user irrespective of the cost(s) associated with the change request, that is the cost(s) associated with the removal of the refined first waypoint or the refined second waypoint; or the addition of a different waypoint from the first refined waypoint and the second refined waypoint; or a change to the refined first waypoint or the refined second waypoint. In some embodiments, in response to receiving the user request to remove, add, or change the waypoint is identified and/or set by the electronic device as a hard constraint (e.g., waypoint constraint that cannot be changed moving forward despite an associated cost of including said waypoint constraint). In some embodiments, a changed waypoint that is not caused by the user of the electronic device (e.g., caused by a cost constraint and/or based on map data) is identified and/or set by the electronic device as a soft constraint (e.g., waypoint constraint that can be changed by the electronic device in an instance when the electronic device determines that changing the waypoint lowers the total cost for the route). In some embodiments, the electronic device presents an audible or visual notification that the electronic device will apply the change request. In some embodiments, the change request optionally causes changes to other segments and/or waypoints of the route (e.g., based on cost determinations described with reference to methods 1000 and/or 1100). In some embodiments, after receiving and committing the change request, the electronic device does not initiate further changes, such as to remove the change request without receipt from the user to remove the change request. Generating the route that includes user-provided waypoints enables a user a means for generating the route efficiently via a sketch, thereby reducing the need for subsequent inputs from a user to precisely select particular roadways and/or waypoints that include efficient use of time, distance, and/or energy when immediate routing guidance is desired, which reduces power usage and improves battery life of the electronic device by enabling the user to use the electronic device more quickly, efficiently, and control the route generated.

In some embodiments, refining the first waypoint or the second waypoint until the route satisfies the one or more criteria, including the criterion that is satisfied based on the cost for the route, includes minimizing a cost function to determine the refined first waypoint and/or the refined second waypoint to minimize a total cost for the route that is based on: (i) cost information associated with the one or more attributes of the movement portion of the gesture and (ii) cost information associated with the map data for the map area, such as shown by sketch attributes 808 input into cost function 822 module and map data 838 input into cost function 822 module in FIG. 8B, (e.g., as described with reference to method 1000). Generating the route based on minimizing a cost function associated with waypoints enables a user a means for generating a cost efficient route via a sketch, thereby reducing the need for subsequent inputs from a user to precisely select particular roadways and/or waypoints along the route when immediate routing guidance is desired, which reduces power usage and improves battery life of the electronic device by enabling the user to use the electronic device more quickly, efficiently, and control the route generated.

In some embodiments, receiving the movement portion of the gesture directed to the map area includes detecting motion corresponding to a sequence of locations within the map area, such as movement of the pinch hand shape 704c in FIG. 7C, (e.g., as described with reference to method(s) 900 and/or 1000). Displaying the sketch corresponding to the sequence of locations within the map area provides visual feedback, which simplifies the interaction between the user and the electronic device and enhances the operability of the electronic device, and indicates to the user an ability to enter a sketch that will be converted into a route quickly and efficiently.

In some embodiments, the motion corresponding to the sequence of locations within the map area is motion of a stylus, such as stylus input device 710a in FIG. 7A, (e.g., as described with reference to method(s) 900 and/or 1000). Converting input from a stylus into a sketch enables a user a means for generating the route efficiently via a sketch, thereby reducing the need for subsequent inputs from a user to precisely select particular roadways and/or waypoints along the route when immediate routing guidance is desired, which reduces power usage and improves battery life of the electronic device by enabling the user to use the electronic device more quickly, efficiently, and control the route generated.

In some embodiments, the motion corresponding to the sequence of locations within the map area is motion of a portion of a user of the electronic device, such as tap input 706a in FIG. 7A, (e.g., as described with reference to method(s) 900 and/or 1000). Converting input from a portion of the user of the electronic device into a sketch enables a user a means for generating the route efficiently via a sketch, thereby reducing the need for subsequent inputs from a user to precisely select particular roadways and/or waypoints along the route when immediate routing guidance is desired, which reduces power usage and improves battery life of the electronic device by enabling the user to use the electronic device more quickly, efficiently, and control the route generated.

It should be understood that the particular order in which the operations in FIGS. 9-11 have been described is merely exemplary and is not intended to indicate that the described order is the only order in which the operations could be performed. One of ordinary skill in the art would recognize various ways to reorder the operations described herein. One of ordinary skill would also recognize various ways to optionally combine aspects of method(s) 900, 1000, and/or 1100.

The operations in the methods described above are, optionally, include running one or more functional modules in an apparatus such as general purpose processors (e.g., a as described with FIG. 1) and/or application-specific circuitry. Further, the operations described above with reference to FIGS. 9-11 are, optionally, implemented by components depicted in FIG. 1. When a respective predefined event or sub-event is detected, an event recognizer activates an event handler associated with the detection of the event or sub-event. Event handler optionally uses or calls a data updater or an object updater to update an internal state of an application. In some embodiments, an event handler accesses a respective GUI updater to update a user interface displayed in association with the application. Similarly, it would be clear to a person having ordinary skill in the art how other processes can be implemented based on the components depicted in FIG. 1.

This disclosure, for purpose of explanation, has been described with reference to specific embodiments. The discussions above are not intended to be exhaustive or to limit the disclosure and/or the claims to the specific embodiments. Modifications and/or variations are possible in view of the disclosure. Some embodiments were chosen and described in order to explain principles of techniques and their practical applications. Others skilled in the art are thereby enabled to utilize the techniques and various embodiments with modifications and/or variations as are suited to a particular use contemplated.

Although the disclosure and embodiments have been fully described with reference to the accompanying drawings, it is to be noted that various changes and/or modifications will become apparent to those skilled in the art. Such changes and/or modifications are to be understood as being included within the scope of this disclosure and embodiments as defined by the claims.

It is the intent of this disclosure that any personal information of users should be gathered, managed, and handled in a way to minimize risks of unintentional and/or unauthorized access and/or use.

Therefore, although this disclosure broadly covers use of personal information to implement one or more embodiments, this disclosure also contemplates that embodiments can be implemented without the need for accessing such personal information.

What is claimed is:

1. A method comprising:
at an electronic device in communication with one or more input devices and a display generation component:
while displaying, via the display generation component, a map area, receiving via the one or more input devices, a gesture starting from a first location of the map area to a second location of the map area corresponding to a request to generate a route from a first respective location to a second respective location; and
in response to receiving the gesture starting from the first location of the map area to the second location of the map area, initiating a process to generate the route from the first respective location to the second respective location, wherein generating the route includes:
extracting a first waypoint for the route and a second waypoint for the route based on one or more attributes of a movement portion of the gesture from the first location to the second location; and
selecting a segment of the route between the first waypoint and the second waypoint independent from the one or more attributes of the movement portion of the gesture corresponding to locations on the map area between the first waypoint and the second waypoint, wherein the selected segment satisfies one or more criteria, including a criterion that is satisfied when the segment corresponds to a path between the first waypoint and the second waypoint that is based on map data for the map area.

2. The method of claim 1, further comprising:
in response to receiving the gesture starting from the first location of the map area to the second location of the map area:
displaying, via the display generation component, the map area including a sketch corresponding to the first location and the second location at which the gesture is received; and after displaying the sketch, displaying an animated transition from displaying the sketch to displaying a representation of the generated route.

3. The method of claim 1, further comprising:
in response to receiving the gesture starting from the first location of the map area to the second location of the map area, displaying, via the display generation component:
a representation of the generated route; and
a user interface element that, when selected, causes the electronic device to change the first waypoint or the second waypoint.

4. The method of claim 1, further comprising:
in response to receiving the gesture starting from the first location of the map area to the second location of the map area, displaying, via the display generation component:
a representation of the generated route; and
a user interface element that, when selected, causes the electronic device to add a third waypoint, different from the first waypoint and the second waypoint, to the generated route.

5. The method of claim 1, wherein the one or more attributes of the movement portion of the gesture include a corner location.

6. The method of claim 1, wherein the one or more attributes of the movement portion of the gesture include a speed of the movement portion of the gesture.

7. The method of claim 1, wherein the one or more attributes of the movement portion of the gesture include selection of one or more locations of the map area.

8. The method of claim 1, wherein extracting the first waypoint and the second waypoint includes:
determining a match between the one or more attributes of the movement portion of the gesture to a corresponding location on the map area that satisfies location criteria; and
extracting, based on the match, the first waypoint and the second waypoint.

9. The method of claim 1, wherein the one or more attributes of the movement portion of the gesture include identifying at least a portion of a user of the electronic device that is directed to the map area.

10. The method of claim 1, wherein the one or more attributes of the movement portion of the gesture include a voice input from a user of the electronic device received, via the one or more input devices, while receiving the gesture directed to the map area.

11. The method of claim 1, wherein the one or more attributes of the movement portion of the gesture include activity history data associated with a user account of the electronic device.

12. The method of claim 1, wherein the one or more attributes of the movement portion of the gesture include receiving, via the one or more input devices, an attention-based input from a user of the electronic device while receiving the gesture directed to the map area.

13. The method of claim 1, wherein generating the route includes:
generating a first segment of the route according to a first mode of transportation; and
generating a second segment, different from the first segment, of the route according to a second mode of transportation, different from the first mode of transportation.

14. The method of claim 1, further comprising:
after generating the route from the first location to the second location:
receiving route information from a second electronic device, different from the electronic device; and
in response to receiving the route information:
initiating a process to modify the generated route in accordance with the route information.

15. The method of claim 1, wherein selecting the segment of the route between the first waypoint and the second waypoint is based on map data.

16. The method of claim 1, wherein the path between the first waypoint and the second waypoint is an optimal path and includes an optimal use of time, distance, and/or energy.

17. The method of claim 1, wherein the first waypoint and/or the second waypoint are intermediate locations between the first respective location and the second respective location on the generated route.

18. The method of claim 1, wherein extracting the first waypoint and the second waypoint includes:
in accordance with a determination that the movement portion of the gesture corresponding to a respective waypoint of the first waypoint or the second waypoint satisfies one or more first criteria, including the respective waypoint in the route without including a stop along the route at a location of the respective waypoint; and
in accordance with a determination that the movement portion of the gesture corresponding to the respective waypoint satisfies one or more second criteria different from the one or more first criteria, including a stop along the route at the location of the respective waypoint.

19. The method of claim 1, wherein the process to generate the route includes:
in accordance with a determination that the movement portion of the gesture defines a first candidate segment, and map data for the first candidate segment indicates that the first candidate segment can be provided via the movement portion of the gesture, selecting the first candidate segment as a respective segment for the route; and
in accordance with a determination that the movement portion of the gesture defines the first candidate segment, and map data for the first candidate segment indicates that the first candidate segment cannot be provided via the movement portion of the gesture, forgoing selecting the first candidate segment as the respective segment for the route.

20. The method of claim 19, wherein the first candidate segment that cannot be provided via the movement portion of the gesture is not traversable.

21. The method of claim 19, wherein the first candidate segment that cannot be provided via the movement portion of the gesture is traversable.

22. The method of claim 1, wherein receiving the movement portion of the gesture directed to the map area includes detecting motion corresponding to a sequence of locations within the map area.

23. The method of claim 22, wherein the motion corresponding to the sequence of locations within the map area is motion of a stylus providing the gesture to the map area.

24. The method of claim 22, wherein the motion corresponding to the sequence of locations within the map area is motion of a portion of a user of the electronic device providing the gesture to the map area.

25. An electronic device comprising:
one or more processors;
memory; and
one or more programs, wherein the one or more programs are stored in the memory and are configured to be executed by the one or more processors, the one or more programs including instructions for:
while displaying, via a display generation component, a map area, receiving via one or more input devices, a gesture starting from a first location of the map area to a second location of the map area corresponding to a request to generate a route from a first respective location to a second respective location; and
in response to receiving the gesture starting from the first location of the map area to the second location of the map area, initiating a process to generate the route from the first respective location to the second respective location, wherein generating the route includes:
extracting a first waypoint for the route and a second waypoint for the route based on one or more attributes of a movement portion of the gesture from the first location to the second location; and
selecting a segment of the route between the first waypoint and the second waypoint independent from the one or more attributes of the movement portion of the gesture corresponding to locations on the map area between the first waypoint and the second waypoint, wherein the selected segment satisfies one or more criteria, including a criterion that is satisfied when the segment corresponds to a path between the first waypoint and the second waypoint that is based on map data for the map area.

26. A non-transitory computer readable storage medium storing one or more programs, the one or more programs comprising instructions, which when executed by one or more processors of an electronic device, cause the electronic device to perform a method comprising:
while displaying, via a display generation component, a map area, receiving via one or more input devices, a gesture starting from a first location of the map area to a second location of the map area corresponding to a request to generate a route from a first respective location to a second respective location; and
in response to receiving the gesture starting from the first location of the map area to the second location of the map area, initiating a process to generate the route from the first respective location to the second respective location, wherein generating the route includes:
extracting a first waypoint for the route and a second waypoint for the route based on one or more attributes of a movement portion of the gesture from the first location to the second location; and
selecting a segment of the route between the first waypoint and the second waypoint independent from the one or more attributes of the movement portion of the gesture corresponding to locations on the map area between the first waypoint and the second waypoint, wherein the selected segment satisfies one or more criteria, including a criterion that is satisfied when the segment corresponds to a path between the first waypoint and the second waypoint that is based on map data for the map area.
